(19) United States
(12) Patent Application Publication
(10) Pub. No.: US 2024/0153475 A1
(43) Pub. Date: May 9, 2024

(54) MUSIC MANAGEMENT SERVICES

(71) Applicant: Ricky Jameson Valadez, St. George, UT (US)

(72) Inventor: Ricky Jameson Valadez, St. George, UT (US)

(21) Appl. No.: 18/386,605

(22) Filed: Nov. 3, 2023

Related U.S. Application Data
(60) Provisional application No. 63/422,051, filed on Nov. 3, 2022.

(51) Int. Cl. G10H 1/00; G10H 1/14

(52) U.S. Cl. CPC G10H 1/0008; G10H 1/14; G10H 2210/061; G10H 2210/071; G10H 2210/076; G10H 2210/576

(57) ABSTRACT

Systems, methods, and computer-readable media for a music management service are provided. A music management service may enable different users to produce instrumentation, styles based on such instrumentation, songs based on such styles, and/or modifications to such songs via various online and/or other suitable user interfaces with different levels of control based on the type of user interfacing with the service.

### CROSS-REFERENCE TO OTHER APPLICATION(S)

This application claims the benefit of prior filed U.S. Provisional Patent Application No. 63/422,051, filed Nov. 3, 2022, which is hereby incorporated by reference herein in its entirety.

### COPYRIGHT NOTICE

At least a portion of the disclosure of this patent document contains material that may be subject to copyright protection. The copyright owner has no objection to the facsimile reproduction by anyone of the patent document or patent disclosure as it appears in the Patent and Trademark Office patent file or records, but otherwise reserves all copyright rights whatsoever.

### FIELD

This disclosure relates to music management services and, more particularly, to music management services for creating and modifying songs with various levels of control.

### BACKGROUND

Music applications are often used to create songs. However, there is a need to provide personalized levels of control to music management processes.

### SUMMARY

Systems, methods, and computer-readable media for personalizing music management services are provided.

For example, a system is provided for providing a music management service.

As another example, a method is provided for providing a music management service.

As yet another example, a product is provided that may include a non-transitory computer-readable medium and computer-readable instructions, stored on the computer-readable medium, that, when executed, are effective to cause a computer to provide a music management service.

As yet another example, a computer-implemented method is provided for processing a song object using an electronic device, wherein the song object includes at least a first phrase object, wherein the first phrase object includes a first plurality of phrase data objects, wherein one of the first plurality of phrase data objects includes a chord progression object, wherein the chord progression object includes at least a first chord object, wherein another one of the first plurality of phrase data objects includes a style object, wherein the style object includes at least a first track object, wherein the first track object includes a first plurality of track data objects, wherein one of the first plurality of track data objects includes an instrument object, and wherein the instrument object includes a plurality of instrument data objects and at least a first sample set that includes at least a first audio sample, the method including: receiving, with the electronic device, an instruction to play the song object; in response to the receiving, automatically calculating, with the electronic device, chord audio for the first chord object, wherein the calculating the chord audio for the first chord object includes: calculating, with the electronic device, chord duration data for the first chord object based on a first subset of the first plurality of phrase data objects; calculating, with the electronic device, composition data for the first chord object based on: the calculated chord duration data for the first chord object; and a second subset of the first plurality of phrase data objects, wherein the calculated composition data for the first chord object includes: track update data; harmony data; and note event data; and calculating, with the electronic device, at least one scheduled audio source for the first chord object based on: the calculated chord duration data for the first chord object; the harmony data of the calculated composition data for the first chord object; the note event data of the calculated composition data for the first chord object; and a third subset of the first plurality of phrase data objects; and, after the calculating the at least one scheduled audio source for the first chord object, automatically emitting, with the electronic device, an audio output for the first chord object based on the at least one scheduled audio source for the first chord object.

As yet another example, a non-transitory computer-readable storage medium storing at least one program including instructions is provided, which, when executed in an electronic device, causes the electronic device to perform a method for processing a song object, wherein the song object includes at least a first phrase object, wherein the first phrase object includes a first plurality of phrase data objects, wherein one of the first plurality of phrase data objects includes a chord progression object, wherein the chord progression object includes at least a first chord object, wherein another one of the first plurality of phrase data objects includes a style object, wherein the style object includes at least a first track object, wherein the first track object includes a first plurality of track data objects, wherein one of the first plurality of track data objects includes an instrument object, and wherein the instrument object includes a plurality of instrument data objects and at least a first sample set that includes at least a first audio sample, the method including: receiving an instruction to play the song object; in response to the receiving, automatically calculating chord audio for the first chord object, wherein the calculating the chord audio for the first chord object includes: calculating chord duration data for the first chord object based on a first subset of the first plurality of phrase data objects; calculating composition data for the first chord object based on: the calculated chord duration data for the first chord object; and a second subset of the first plurality of phrase data objects, wherein the calculated composition data for the first chord object includes: track update data; harmony data; and note event data; and calculating at least one scheduled audio source for the first chord object based on: the calculated chord duration data for the first chord object; the harmony data of the calculated composition data for the first chord object; the note event data of the calculated composition data for the first chord object; and a third subset of the first plurality of phrase data objects; and, after the calculating the at least one scheduled audio source for the first chord object, automatically emitting an audio output for the first chord object based on the at least one scheduled audio source for the first chord object.

As yet another example, an electronic device is provided that includes an input component; an output component; and a processor coupled to the input component and the output component, wherein the processor is operative to: receive, via the input component, an instruction to play a song object, wherein: the song object includes at least a first phrase object; the first phrase object includes a first plurality of phrase data objects; one of the first plurality of phrase data objects includes a chord progression object; the chord progression object includes at least a first chord object; another one of the first plurality of phrase data objects includes a style object; the style object includes at least a first track object; the first track object includes a first plurality of track data objects; one of the first plurality of track data objects includes an instrument object; and the instrument object includes: a plurality of instrument data objects; and at least a first sample set that includes at least a first audio sample; automatically calculate, in response to receipt of the instruction to play the song object, chord audio for the first chord object by: calculating chord duration data for the first chord object based on a first subset of the first plurality of phrase data objects; calculating composition data for the first chord object based on: the calculated chord duration data for the first chord object; and a second subset of the first plurality of phrase data objects, wherein the calculated composition data for the first chord object includes: track update data; harmony data; and note event data; and calculating at least one scheduled audio source for the first chord object based on: the calculated chord duration data for the first chord object; the harmony data of the calculated composition data for the first chord object; the note event data of the calculated composition data for the first chord object; and a third subset of the first plurality of phrase data objects; and automatically emit, via the output component, an audio output for the first chord object based on the at least one scheduled audio source for the first chord object.

This Summary is provided only to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters refer to like parts throughout, and in which:

FIG. 1 is a schematic view of an illustrative system for music management services of the disclosure, according to some embodiments;

FIG. 2 is a more detailed schematic view of a subsystem of the system of FIG. 1, according to some embodiments;

FIGS. 3-116 and 133 are various illustrations of various concepts of the system of FIG. 1; and

FIGS. 117-132 are front views of screens of graphical user interfaces of subsystems of the system of FIG. 1, according to some embodiments.

### DETAILED DESCRIPTION

In the following detailed description, for purposes of explanation, numerous specific details are set forth to provide a thorough understanding of the various embodiments described herein. Those of ordinary skill in the art will realize that these various embodiments are illustrative only and are not intended to be limiting in any way. Other embodiments will readily suggest themselves to such skilled persons having the benefit of this disclosure.

In addition, for clarity purposes, not all of the routine features of the embodiments described herein are shown or described. One of ordinary skill in the art will readily appreciate that in the development of any such actual embodiment, numerous embodiment-specific decisions may be required to achieve specific design objectives. These design objectives will vary from one embodiment to another and from one developer to another. Moreover, it will be appreciated that such a development effort might be complex and time-consuming, but would nevertheless be a routine engineering undertaking for those of ordinary skill in the art having the benefit of this disclosure.

Music management services are provided for creating and modifying songs with various levels of control (e.g., modifiable song technology with data structures and algorithms, instrument production, style production, song production, and/or consumer modification). A music management service may enable different users to produce instrumentation, styles based on such instrumentation, songs based on such styles, and/or modifications to such songs via various online and/or other suitable user interfaces (e.g., graphical user interfaces (“GUI”)) of a user electronic device with different levels of control based on the type of user interfacing with the service. This may spread out the musical choices according to the capabilities of the user. The controls made available may be constrained to those that may produce the greatest perceptible difference in the music, while at the same ensuring musically desirable results. Various controls may be provided to different user types based on different skill sets and/or different use cases. Constraints for available controls may be hardcoded into different embodiments of the application based on its intent (e.g., a consumer modification song library may be limited to controls that may be most useful to video creators and their editing preferences, a digital audio workstation (“DAW”)-like embodiment for music producers may provide access to more controls, an audio sampler embodiment may provide limited controls, such as uploading capabilities and access to input instrument data and select song controls to test and hear playback of their uploaded samples, a real-time game music application programming interface (“API”) may expose controls related to states of the game, etc.).

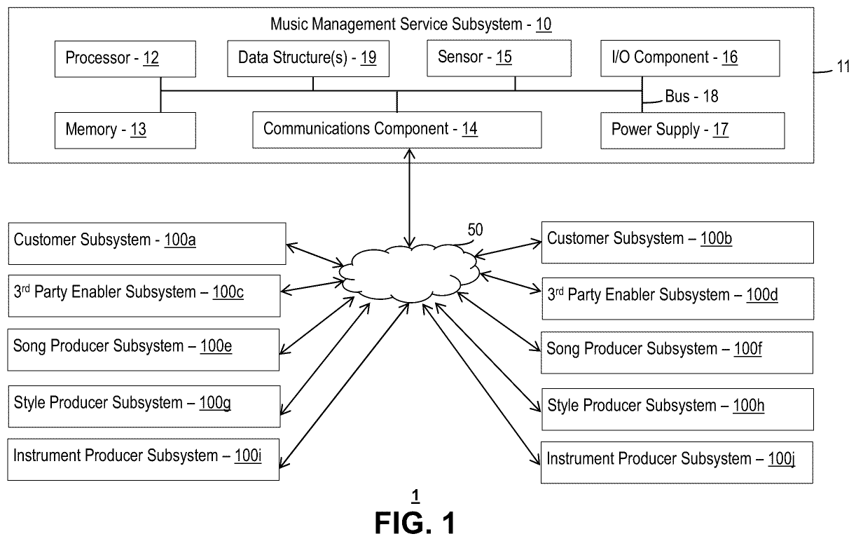

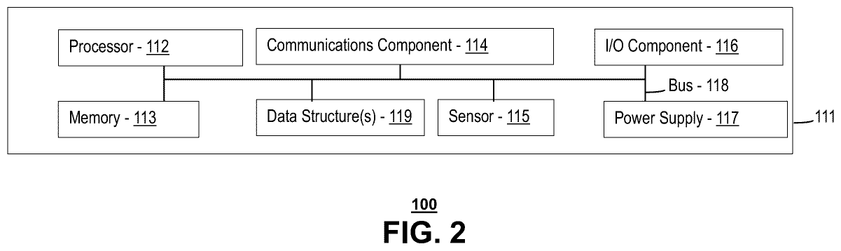

### FIGS. 1 and 2—System for Music Management Service

FIG. 1 is a schematic view of an illustrative system 1 in which a music management service may be facilitated amongst various entities. For example, as shown in FIG. 1, system 1 may include a music management service (“MMS”) subsystem 10 (e.g., for creators of the MMS service (e.g., data structure and algorithm designers, creators, managers, administrators, stake-holders, and/or custodians)), various subsystems 100 (e.g., one or more consumer or customer subsystems (e.g., customer subsystems 100a and 100b), one or more third party enabler (“TPE”) subsystems (e.g., TPE subsystems 100c and 100d), one or more song producer subsystems (e.g., song producer subsystems 100e and 100f), one or more style producer subsystems (e.g., style producer subsystems 100g and 100h), and one or more instrument producer subsystems (e.g., instrument producer subsystems 100i and 100j), and/or the like), and at least one communications network 50 through which any two or more of the subsystems 10 and 100 may communicate. MMS subsystem 10 may be operative to interact with any of the various subsystems 100 to provide an application or music management service platform (“MMSP”) of system 1 that may facilitate various music management services, including, but not limited to, a modifiable song technology with data structures and algorithms, instrument production, style production, song production, and/or consumer modification.

As shown in FIG. 2, and as described in more detail below, a subsystem 100 (e.g., one, some, or each of subsystems 100a-100j) may include a processor component 112, a memory component 113, a communications component 114, a sensor component 115, an input/output (“I/O”) component 116, a power supply component 117, and/or a bus 118 that may provide one or more wired or wireless communication links or paths for transferring data and/or power to, from, or between various other components of subsystem 100. I/O component 116 may include at least one input component (e.g., a button, mouse, trackpad, keyboard, microphone, musical instrument, etc.) to receive information from a user of subsystem 100 and/or at least one output component (e.g., an audio speaker, visual display, haptic component, smell output component, etc.) to provide information to a user of subsystem 100, such as a touch screen that may receive input information through a user's touch on a touch sensitive portion of a display screen and that may also provide visual information to a user via that same display screen. Memory 113 may include one or more storage mediums, including for example, a hard-drive, flash memory, permanent memory such as read-only memory (“ROM”), semi-permanent memory such as random access memory (“RAM”), any other suitable type of storage component, or any combination thereof. Communications component 114 may be provided to allow one subsystem 100 to communicate (e.g., any suitable data) with a communications component of one or more other subsystems 100 or subsystem 10 or servers using any suitable communications protocol (e.g., via communications network 50). Communications component 114 can be operative to create or connect to a communications network for enabling such communication. Communications component 114 can provide wireless communications using any suitable short-range or long-range communications protocol, such as Wi-Fi (e.g., an 802.11 protocol), Bluetooth, radio frequency systems (e.g., 1200 MHz, 2.4 GHz, and 5.6 GHz communication systems), infrared, protocols used by wireless and cellular telephones and personal e-mail devices, or any other protocol supporting wireless communications. Communications component 114 can also be operative to connect or otherwise couple to a wired communications network or directly to another data source wirelessly or via one or more wired connections or couplings or a combination thereof (e.g., any suitable connector(s)). Such communication may be over the internet or any suitable public and/or private network or combination of networks (e.g., one or more networks 50). Sensor 115 may be any suitable sensor that may be configured to sense any suitable data from an external environment of subsystem 100 or from within or internal to subsystem 100 (e.g., light data via a light sensor, audio data via an audio sensor (e.g., microphone(s), musical instrument(s), and/or any other suitable audio data sensors), location-based data via a location-based sensor system (e.g., a global positioning system (“GPS”)), and/or the like, including, but not limited to, a microphone, camera, scanner (e.g., a barcode scanner or any other suitable scanner that may obtain product or location or other identifying information from a code, such as a linear barcode, a matrix barcode (e.g., a quick response (“QR”) code), or the like), web beacon(s), proximity sensor, light detector, temperature sensor, motion sensor, biometric sensor (e.g., a fingerprint reader or other feature (e.g., facial) recognition sensor, which may operate in conjunction with a feature-processing application that may be accessible to subsystem 100 or otherwise to system 1 for authenticating a user), gas/smell sensor, line-in connector for data and/or power, and/or combinations thereof, etc.). Power supply 117 can include any suitable circuitry for receiving and/or generating power, and for providing such power to one or more of the other components of subsystem 100. Subsystem 100 may also be provided with a housing 111 that may at least partially enclose one or more of the components of subsystem 100 for protection from debris and other degrading forces external to subsystem 100. Each component of subsystem 100 may be included in the same housing 111 (e.g., as a single unitary device, such as a laptop computer or portable media device) and/or different components may be provided in different housings (e.g., a keyboard input component may be provided in a first housing that may be communicatively coupled to a processor component and a display output component that may be provided in a second housing, and/or multiple servers may be communicatively coupled to provide for a particular subsystem). In some embodiments, subsystem 100 may include other components not combined or included in those shown or not all of the components shown or several instances of one or more of the components shown.

Processor 112 may be used to run one or more applications, such as an application that may be provided as at least a part of one or more data structures 119 that may be accessible from memory 113 and/or from any other suitable source (e.g., from MMS subsystem 10 via an active internet connection). Such an application data structure 119 may include, but is not limited to, one or more operating system applications, firmware applications, software applications, communication applications, internet browsing applications (e.g., for interacting with a website provided by MMS subsystem 10 for enabling subsystem 100 to interact with an online service or platform of MMS subsystem 10 (e.g., a MMSP)), MMS applications (e.g., a web application or a native application or a hybrid application that may be at least partially produced and/or managed by MMS subsystem 10 for enabling subsystem 100 to interact with an online service or platform of MMS subsystem 10 (e.g., a MMSP)), any suitable combination thereof, or any other suitable applications. For example, processor 102 may load an application data structure 119 as a user interface program to determine how instructions or data received via an input component of I/O component 116 or via communications component 114 or via sensor component 115 or via any other component of subsystem 100 may manipulate the way in which data may be stored and/or provided to a user via an output component of I/O component 116 and/or to any other subsystem via communications component 114. As one example, an application data structure 119 may provide a user (e.g., customer, producer, enabler, or otherwise) with the ability to interact with a music management service or the MMSP of MMS subsystem 10, where such an application 119 may be a third party application that may be running on subsystem 100 (e.g., an application associated with MMS subsystem 10 that may be loaded on subsystem 100 from MMS subsystem 10 or via an application market) and/or that may be accessed via an internet application or web browser running on subsystem 100 (e.g., processor 112) that may be pointed to a uniform resource locator (“URL”) whose target or web resource may be managed by MMS subsystem 10 or any other remote subsystem. One, some, or each subsystem 100 may be or may include a portable media device (e.g., a smartphone), a laptop computer, a tablet computer, a desktop computer, an appliance, a wearable electronic device (e.g., a smart watch), a virtual and/or augmented reality device, a musical instrument, at least one web or network server (e.g., for providing an online resource, such as a website or native online application, for presentation on one or more other subsystems) with an interface for an administrator of such a server, any other suitable electronic device(s), and/or the like.

MMS subsystem 10 may include a housing 11 that may be similar to housing 111, a processor component 12 that may be similar to processor 112, a memory component 13 that may be similar to memory component 113, a communications component 14 that may be similar to communications component 114, a sensor component 15 that may be similar to sensor component 115, an I/O component 16 that may be similar to I/O component 116, a power supply component 17 that may be similar to power supply component 117, and/or a bus 18 that may be similar to bus 118. Moreover, MMS subsystem 10 may include one or more data sources or data structures or applications 19 that may include any suitable data or one or more applications (e.g., any application similar to application 119) for facilitating a music management service or MMSP that may be provided by MMS subsystem 10 in conjunction with one or more subsystems 100. Some or all portions of MMS subsystem 10 may be operated, managed, or otherwise at least partially controlled by an entity (e.g., administrator) responsible for providing a music management service to one or more clients (e.g., customer, producer, enabler, etc.) or other suitable entities.

MMS subsystem 10 may communicate with one or more subsystems 100 via communications network 50. Network 50 may be the internet or any other suitable network, such that when communicatively intercoupled via network 50, any two subsystems of system 1 may be operative to communicate with one another (e.g., a subsystem 100 may access data (e.g., from a data structure 19 of MMS subsystem 10, as may be provided as a music management service via processor 12 and communications component 14 of MMS subsystem 10) as if such data were stored locally at that subsystem 100 (e.g., in memory component 113)).

Various clients and/or partners may be enabled to interact with MMS subsystem 10 for enabling the music management services and the MMSP. For example, at least one customer subsystem (e.g., subsystem 100a and/or 100b of system 1) may be operated by any suitable customer client while interacting with any suitable song objects of a particular song or multimedia composition (e.g., video synchronized with a song). Such a customer or song consumer (e.g., for a “consumer modification tier” of the MMSP) may be any suitable entity or entities, including, but not limited to, advertising agencies, multi-media/video production companies, video creation platforms (e.g., YouTube, Vimeo, Twitch, TikTok, Facebook, etc.), video editing software companies (e.g., Adobe Premiere Pro, Apple Final Cut Pro, DaVinci Resolve, etc.), theatre and/or dance companies, film directors, videographers, social media influencers, music editors, video game developers, podcast creators, audiobook production companies, home video creators, and/or the like. As another example, at least one song producer subsystem (e.g., subsystem 100e and/or 100f of system 1) may be operated by any suitable song producer client while interacting with one or more song objects and/or phrase objects and/or particular styles for producing a song or multimedia composition (e.g., video synchronized with a song). Such a song producer (e.g., for a “song production tier” of the MMSP) may be any suitable entity or entities, including, but not limited to, music production agencies, music composers, music arrangers, music producers, audio engineers, beat makers, vocalists, recording artists, music hobbyists, music students, those interested in learning about music creation, and/or the like. As another example, at least one style producer subsystem (e.g., subsystem 100g and/or 100h of system 1) may be operated by any suitable style producer client while interacting with one or more particular style objects (e.g., Style Objects 505) and/or track objects for producing a style for a song or multimedia composition (e.g., video synchronized with a song). Such a style producer (e.g., for a “style production tier” of the MMSP) may be any suitable entity or entities, including, but not limited to, music production agencies, music composers, music arrangers, music producers, audio engineers, beat makers, and/or the like. As another example, at least one instrument producer subsystem (e.g., subsystem 100i and/or 100j of system 1) may be operated by any suitable instrument producer client while interacting with one or more particular audio samples (e.g., Audio Samples 512) and/or instrument object data for producing an instrument for an instrument library to be used for creating style(s) for a song or multimedia composition (e.g., video synchronized with a song). Such an instrument producer (e.g., for an “instrument production tier” of the MMSP) may be any suitable entity or entities, including, but not limited to, sample library companies (e.g., Native Instruments, Red Room Audio, Sonokinetic, Spectrasonics, 8Dio, Cinesamples, Embertone, etc.), music production agencies, sound designers, audio engineers, audio sample artists, and/or the like. As another example, at least one third party enabler subsystem (e.g., subsystem 100c and/or 100d of system 1) may be operated by any suitable third party enabler (“TPE”) clients to enable at least partially any suitable operation provided by the MMSP. Such a third party enabler may be any suitable entity or entities, including, but not limited to, a third party application or service provider that may be operative to process or provide any suitable subject matter (e.g., video, descriptions of songs or styles or instruments, etc.), financial institutions that may provide any suitable financial information or credit scores or transmit or receive payments of any suitable party, social networks that may provide any suitable connection information between various parties or characteristic data of one or more parties, licensing bodies, third party advertisers, owners of relevant data, software providers, providers of web servers and/or cloud storage services, point of sale service providers, e-commerce software providers, hardware companies (e.g., Apple Inc., Samsung Electronics Co. Ltd, Dell Technologies Inc. Sony Corp., etc.), video creation platforms (e.g., YouTube, Vimeo, Twitch, TikTok, Facebook, etc.), video editing software companies (e.g., Adobe Premiere Pro, Apple Final Cut Pro, DaVinci Resolve, etc.), social media companies (e.g., Facebook, Instagram, Twitter, etc.), payment processing companies (e.g., Stripe, Paypal, Venmo, etc.), any other suitable third party service provider that may or may not be distinct from a customer, a creator, and MMS subsystem 10, and/or the like.

Each subsystem 100 of system 1 (e.g., each one of subsystems 100a-100j) may be operated by any suitable entity for interacting in any suitable way with MMS subsystem 10 (e.g., via network 50) for deriving value from and/or adding value to a service of the MMSP of MMS subsystem 10. For example, a particular subsystem 100 may be a server operated by a client entity that may receive any suitable data from MMS subsystem 10 related to any suitable music management service of the MMSP provided by MMS subsystem 10 (e.g., via network 50). Additionally or alternatively, a particular subsystem 100 may be a server operated by a client entity that may upload or otherwise provide any suitable data to MMS subsystem 10 related to any suitable music management service of the MMSP provided by MMS subsystem 10 (e.g., via network 50).

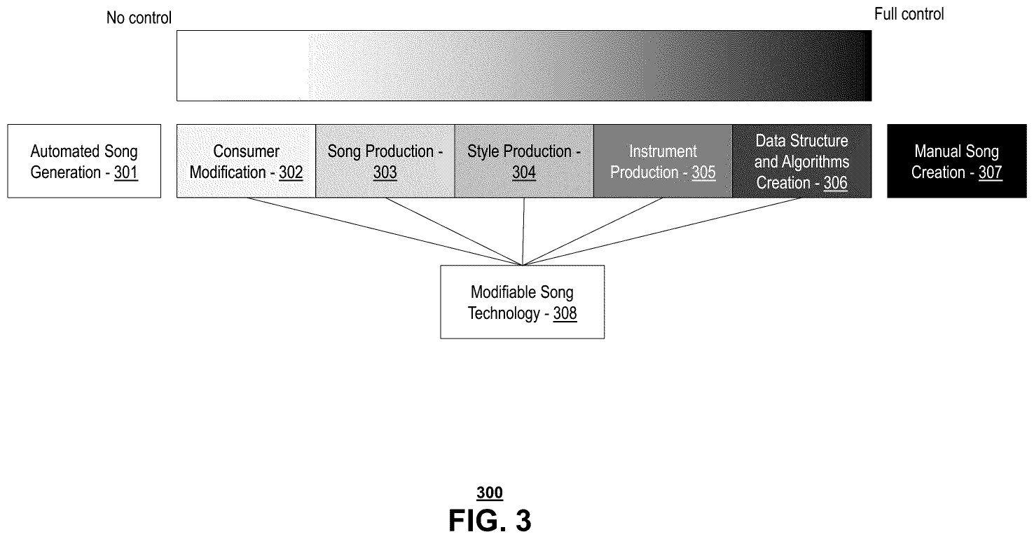

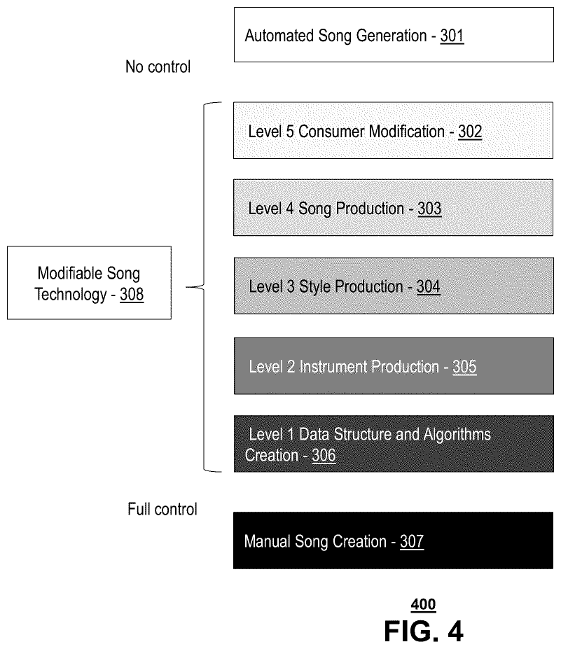

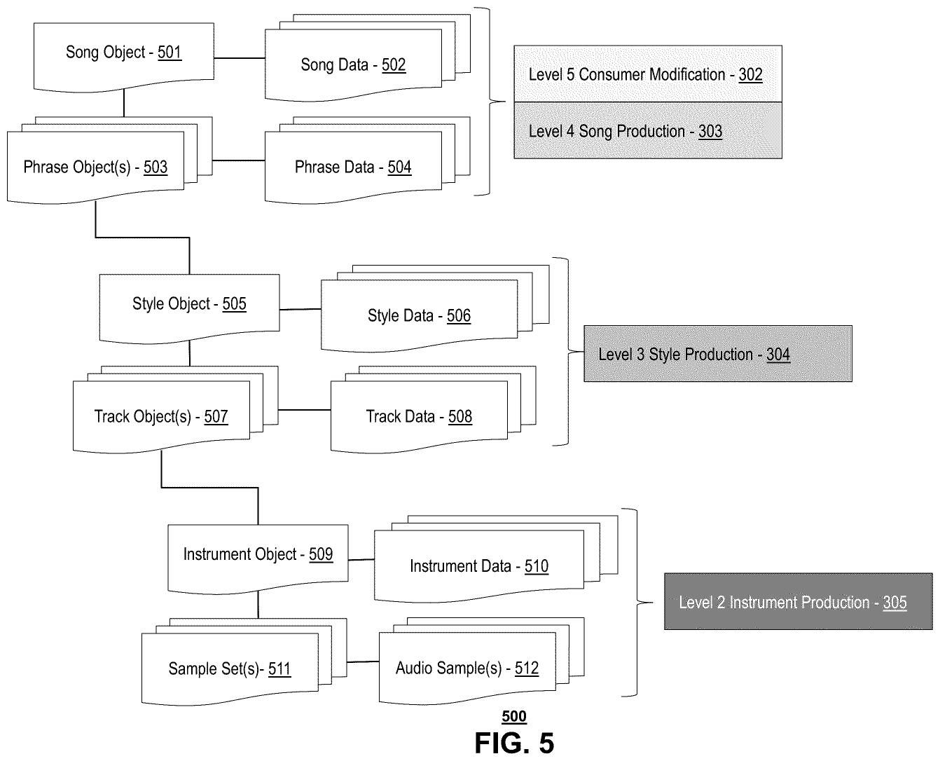

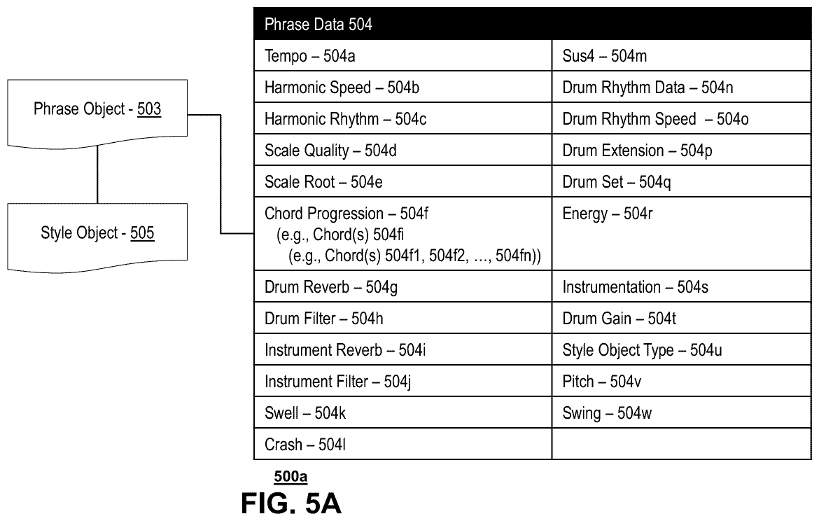

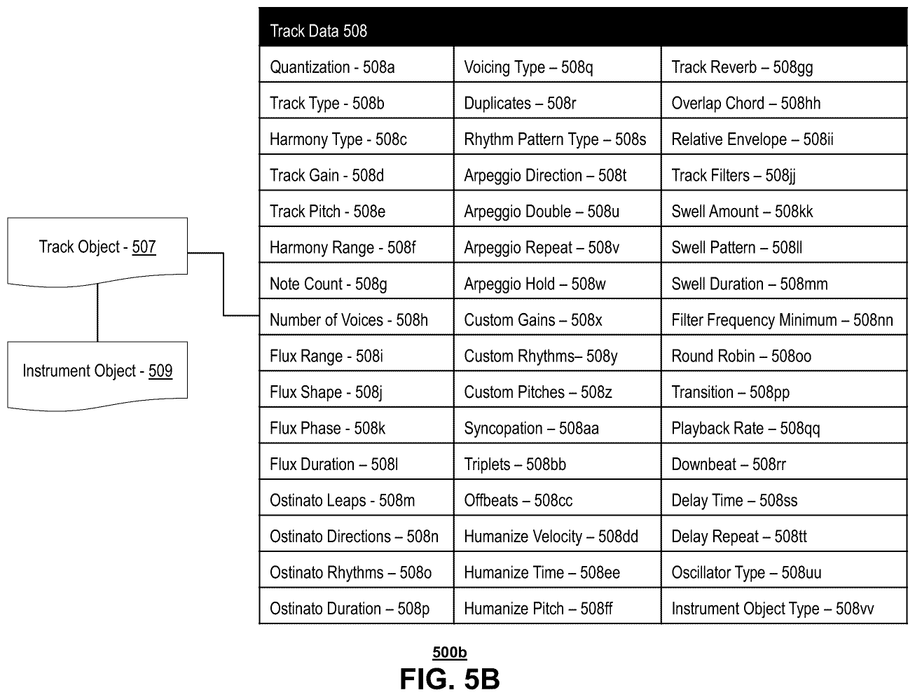

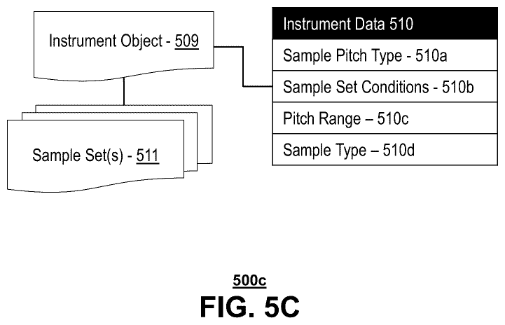

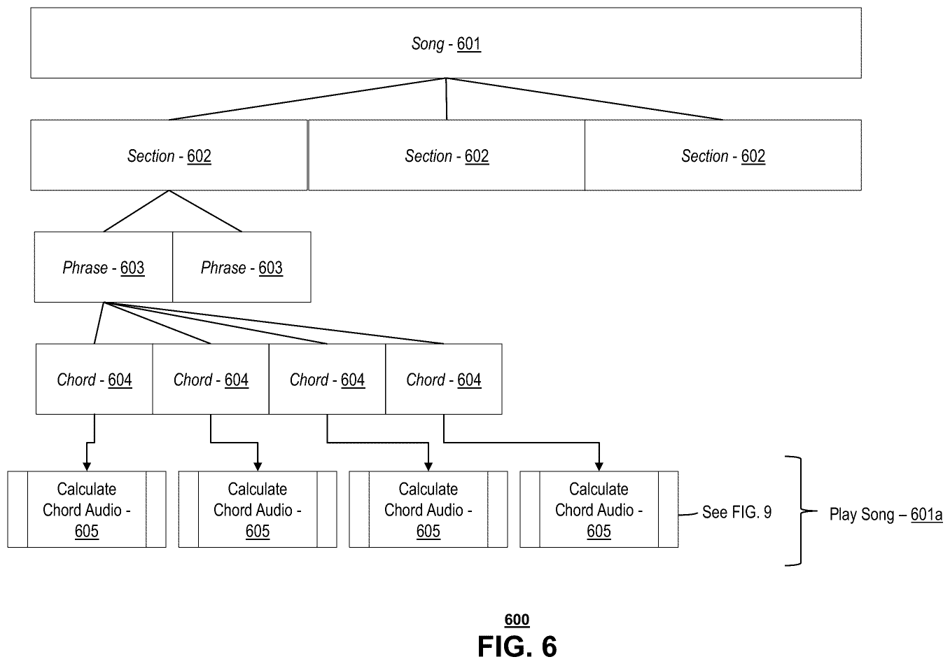

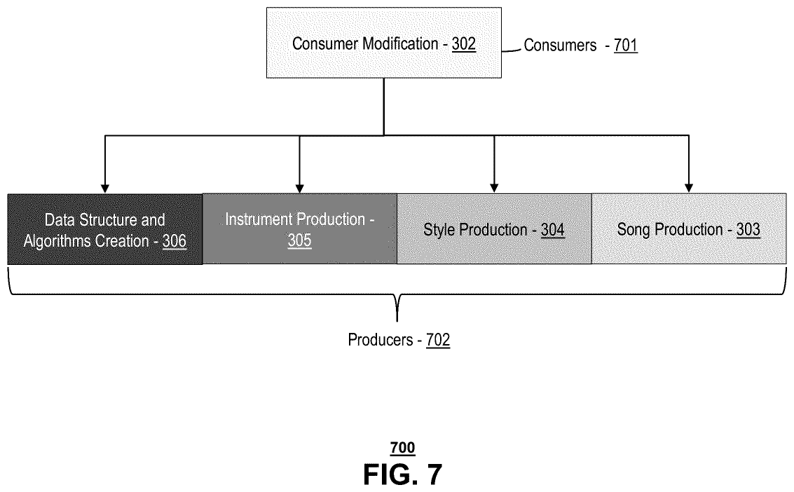

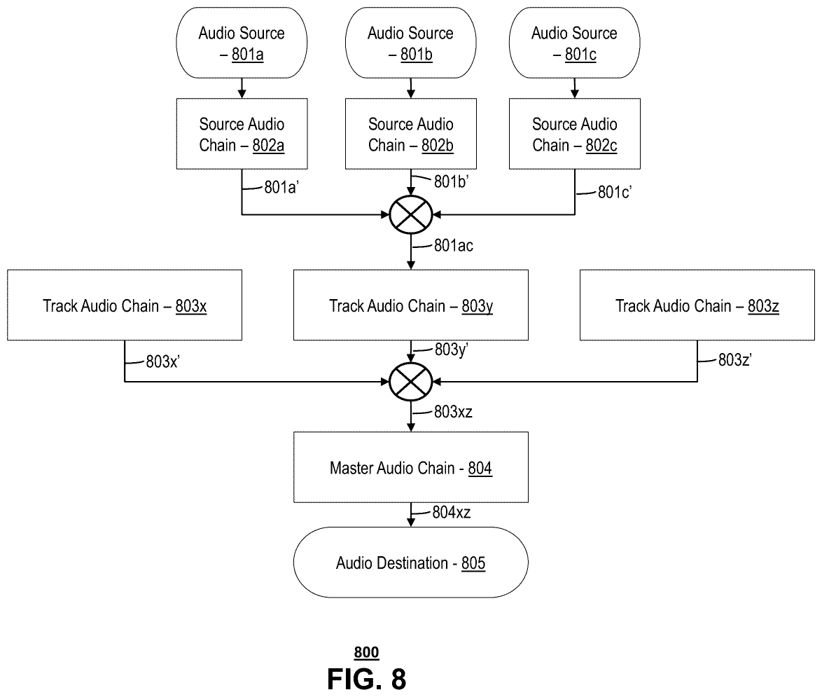

### FIG. 3—Automation-Manual Spectrum

FIG. 3 shows an illustration of a spectrum 300 between automated song generation 301 (e.g., music generation with no user control) and manual song creation 307 (e.g., music creation with full user control). On such a spectrum, the MMSP may be configured to provide technology, which may be referred to herein as “Modifiable Song Technology”, that may be a system that can bridge the two poles of the spectrum. The effectiveness and uniqueness of this technology may be found in the way that it can selectively draw upon the strengths and benefits of both automation and manual creative input. The creation of a single song may be the result of thousands of musical choices regarding music theory, composition, orchestration, audio processing, mixing, and/or the like. As shown in FIG. 3, such Modifiable Song Technology 308 may be configured to structure these choices into separate tiers of control. In each tier, creative choices may be made. The choices available in each tier may be built upon the choices of the previous tier. This may bridge across the spectrum from the full control of the manual method 307 to the limited control of the automated method 301.

As shown in FIG. 3, a spectrum 300 between process(es) of automated song generation 301 (e.g., little to no control) and process(es) of manual song creation 307 (e.g., full control) may span various levels of abstraction of the Modifiable Song Technology 308. With respect to automated song generation, artificial intelligence (“AI”) and other fully automated music generation systems may not allow users to make specific creative changes to a song once generated. AI generated music often works within a “black box,” meaning the user doesn't have full control over compositional decisions. Furthermore, AI generated music often is not deterministic, meaning the user will not get consistent output providing the same input. Additionally, conventional non-AI generated solutions are often limited in their output because they are not extensible. Conversely, with respect to manual song creation, to create high quality music manually takes a lot of time, resources, and expertise. Songs created in this manual way are static and cannot be modified (e.g., a manually created song may be recorded live and rendered audio that exists in the form of a static audio file (e.g., there is no built in way to change the key or chord progression of such an audio file)). Modifiable Song Technology 308 may be configured to provide variable levels of abstraction, allowing users to control as much or as little of the song creation as desired. It may produce deterministic output, so the user can still exercise their artistry and rely on consistent audio renderings. It may be extensible, in that the technology can be designed to be extended at each layer of abstraction, which may allow meta-users to further develop the platform, thus the only constraint to musical composition may be the users' creativity. It may connect human creativity with automation. It may enhance the creative process for music producers, enabling highly efficient and creative song production. Songs produced in this way are dynamic in that they can be modified by anyone, which enhances the song selection experience and the editing process for consumers. As shown, Modifiable Song Technology 308 may be an integrated system that enables various musical choices to be accessible by distinct processes and distinct users of those processes. These processes and their corresponding users may be song consumers (e.g., users of customer subsystem(s) 100a/100b) using process(es) of consumer modification 302, song producers (e.g., users of song producer subsystem(s) 100e/100f) using process(es) of song production 303, style producers (e.g., users of style producer subsystem(s) 100g/100h) using process(es) of style production 304, instrument producers (e.g., users of instrument producer subsystem(s) 100i/100j) using process(es) of instrument production 305, and data structure and algorithm creators or coders (e.g., users of MMS subsystem 10) using process(es) of data structure and algorithm creation 306, and/or the like.

### FIG. 4—Modifiable Song Control/Constraint Tiers

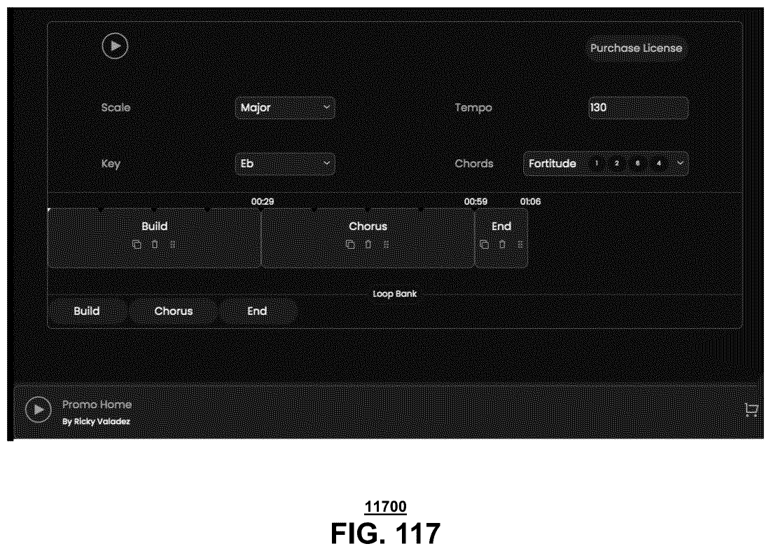

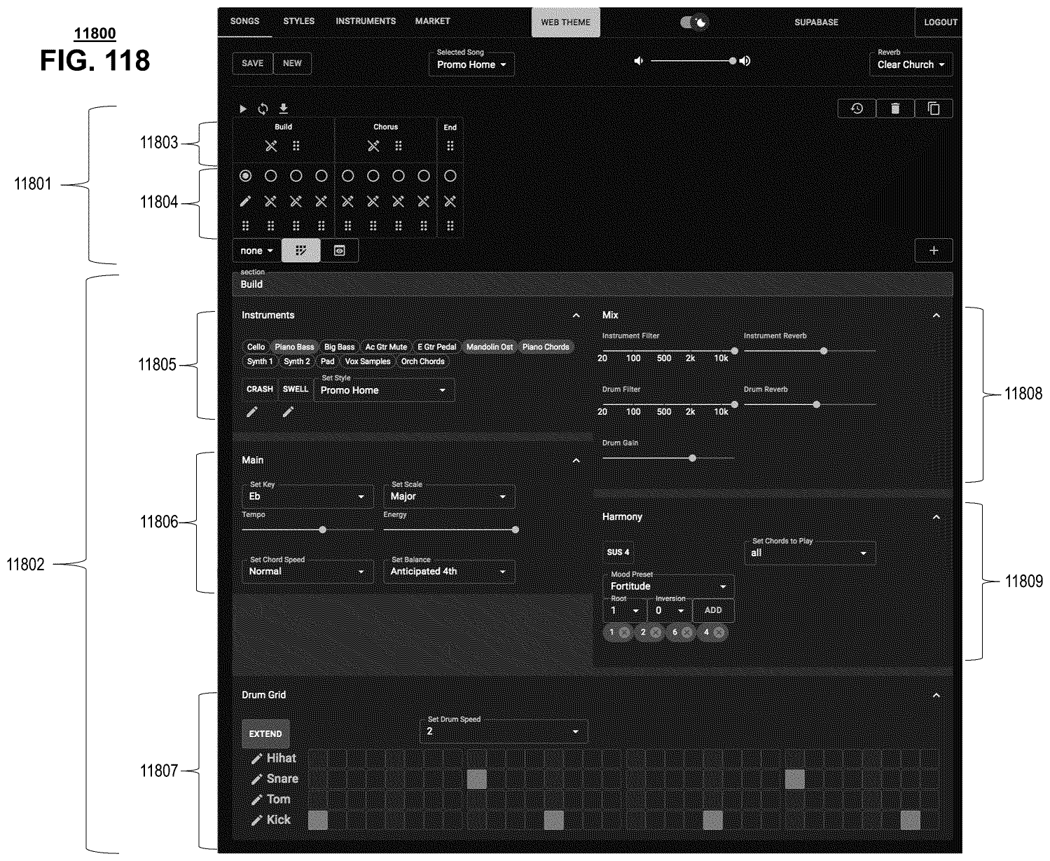

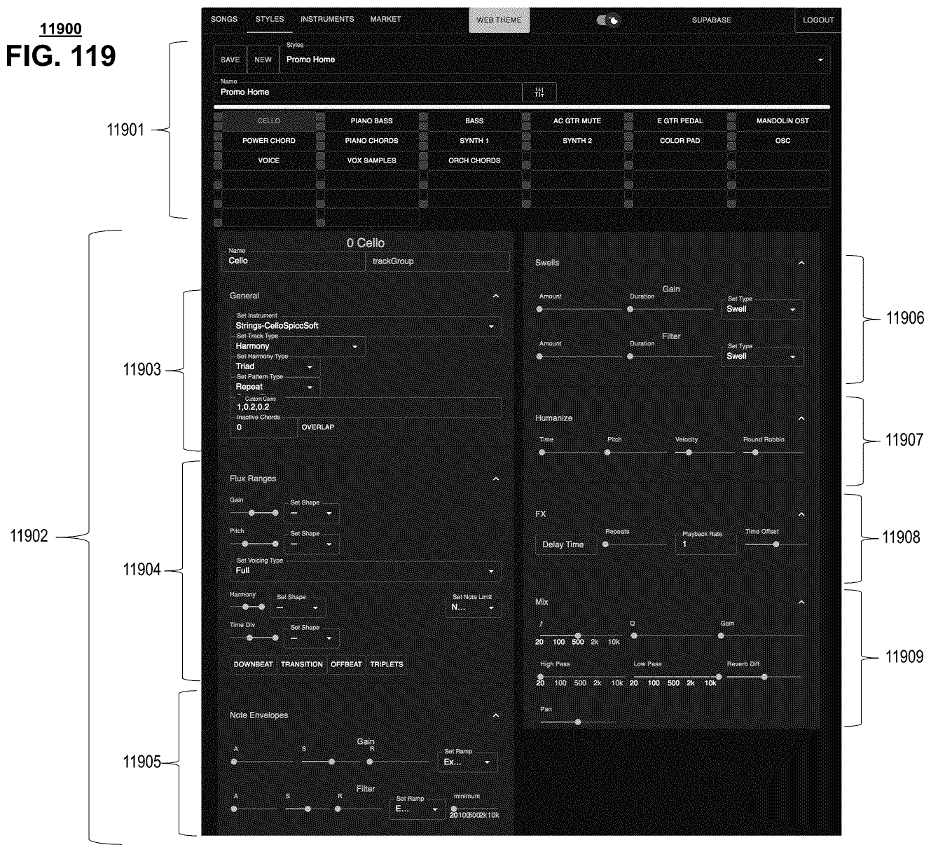

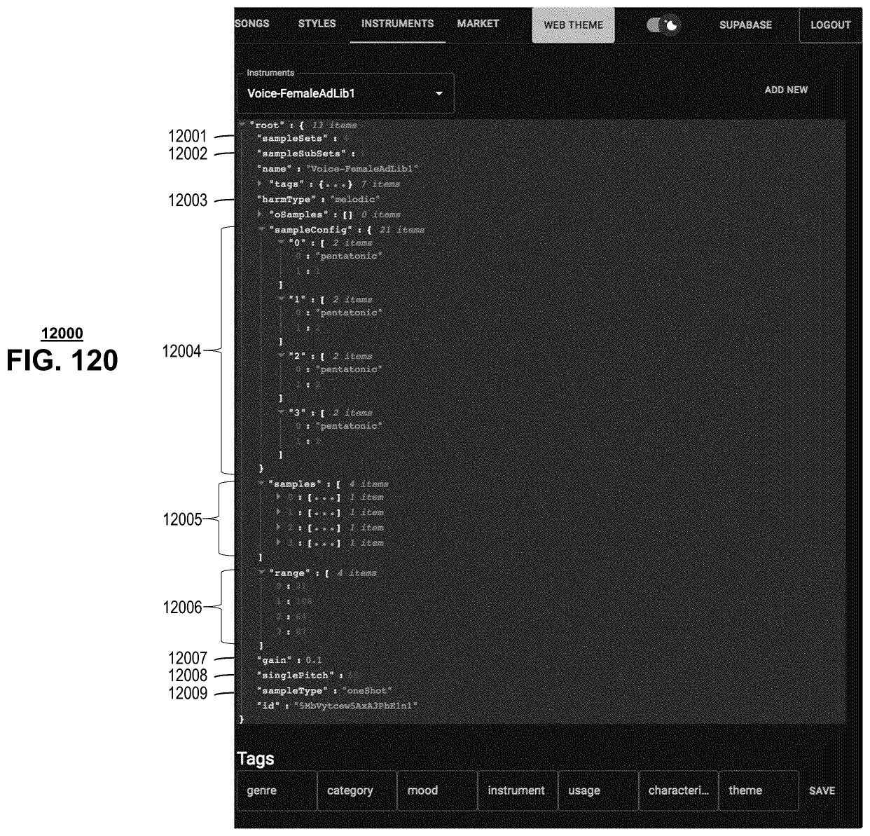

One of the unique features that may enable Modifiable Song Technology 308 to be useful and effective may be a structure for tiering different levels of control for different user types (e.g., structure 400 of FIG. 4). There may be provided strategic constraints to the controls that may be made available to each user type. This may spread out the musical choices according to the capabilities of the user. The controls available may be constrained to those that may produce the greatest perceptible difference in the music, while at the same time ensuring musically desirable results. As shown by the visual of structure 400 of FIG. 4, a narrowing range of choices or control may be made available in each tier. At each tier of publicly available controls, users of differing experience can make meaningful contributions to a song. Tiers with a greater range of control may require greater skill while tiers with minimal controls may be more widely accessible. This structure may create an ecosystem of users that can create, collaborate, modify, and purchase songs. At each level, personal musical decisions may be made within the constraints set by the previous level. With process(es) of manual song creation 307 (e.g., at the full control end of the spectrum), there may be no limitations to how music is composed or produced. There may be no constraints on quality. To produce acceptable quality music manually, it generally may require years of training and experience. However, at level 1 of Modifiable Song Technology 308, any suitable process(es) of data structure and algorithm creation 306 may constrain the musical possibilities of the output. These constraints (e.g., as may be defined by the MMSP (e.g., by creators of the MMSP at subsystem 10) before use by any end users (e.g., users of subsystems 100a/100e/100g/100i)) may enforce a quality threshold, making it easier for users to create quality music with little musical training. At level 2 of Modifiable Song Technology 308, any suitable process(es) of instrument production 305 may be done by specialists (e.g., very skilled or trained or vetted end users (e.g., instrument producers of subsystem(s) 100i/100j)) who may record audio samples (e.g., Audio Samples 512) and/or organize instrument data (e.g., Instrument Data 510), which may inform the algorithms how each sample set should be processed. All potential sounds may be constrained to an available instrument library, which may ensure a level of sonic quality (see, e.g., GUI screen 12000 of FIG. 120). Instrument production 305 of level 2 may be constrained by constraint(s) set by data structure and algorithm creation 306 of level 1. For example, level 2 and levels 3-5 may derive their functionality from and/or have their potential inputs constrained by the data structure and algorithms created at level 1 (e.g., the options for how samples may be organized (e.g., as sample sets) and/or how they can be programmed to behave (e.g., setting sample pitch type, sample type, and sample set conditions) may all be predefined in level 1). At level 3 of Modifiable Song Technology 308, any suitable process(es) of style production 304 may be done by users (e.g., skilled end users (e.g., style producers of subsystem(s) 100g/100h)) who may determine how each instrument may be performed when processed through the algorithms, such as by providing style production controls to modify style objects (e.g., Style Objects 505) and/or track objects (e.g., Track Objects 507). This may be the most granular level of control available to users and may enable the greatest range of possibilities (see, e.g., GUI screen 11900 of FIG. 119). Style production 304 of level 3 may be constrained by constraint(s) set by instrument production 305 of level 2. For example, when designing a style, style producers may be constrained to use only those instruments and samples that have been created in level 2. Additionally or alternatively, depending on a selected instrument, each track of a style may have constraints specific to the instrument data input in level 2 for that selected instrument. For example, an instrument including samples of chords may have constraints on Track Harmony Type value options limited to the “chord root” value, where the sample may be applied as intended by its creator at level 2. Other track data controls may be constrained by the predefined data structure and algorithms from level 1. At level 4 of Modifiable Song Technology 308, any suitable process(es) of song production 303 may be done by users (e.g., skilled end users (e.g., song producers of subsystem(s) 100e/100f)) who may determine high level song characteristics and the structure and development of a song for each phrase, such as by providing song production controls to modify song objects (e.g., Song Objects 501) and/or phrase objects (e.g., Phrase Objects 503). This may determine high level song characteristics, and the structure and development of the song for each phrase. This may be based on previously created styles (see, e.g., GUI screen 11800 of FIG. 118). Song production 303 of level 4 may be constrained by constraint(s) set by style production 304 of level 3. For example, when designing a song, song producers may be constrained to use only styles or tracks from styles that have been created in level 3. Other phrase data controls and their related algorithms or processes may be predefined in level 1. At level 5 of Modifiable Song Technology 308, any suitable process(es) of consumer modification 302 may be done by users (e.g., less skilled end users (e.g., consumers of subsystem(s) 100a/100b)) to use modification controls to modify the most general characteristics of a previously created song object (e.g., Song Object 501). These minimal controls may enable the least musical users to make substantial modifications (see, e.g., GUI screen 11700 of FIG. 117). Consumer modification 302 of level 5 may be constrained by constraint(s) set by song production 303 of level 4. For example, when modifying a song, consumers may be constrained to use only songs that have been created in level 4. In level 4, a song producer may design more specifically the qualities of a song, including, but not limited to, the drum sounds, the drum rhythm, the reverb and filter settings, and/or the like. These may be built-in characteristics of the song that the consumer may be constrained by, while still being enabled to modify other more general characteristics in level 5 (e.g., while all phrase data types 504a-504w may be made available to a user in level 4, only phrase data types 504a-504f, 504k-504m, 504s, and 504u-504w (if not also types 504n, 504o, 504p, and/or 504q) may be made available to a user in level 5, which may enable a simpler level 5). While, with automated song generation 301 (e.g., at the little or no control end of the spectrum), no control of specific song data with AI or fully automated systems may be enabled. While these tiers of control could be misunderstood to be arbitrary variations of user interfaces or embodiments, this structure of varying levels of access to modification controls is a novel design for user experience and collaboration which may only be possible when designed around an integrated system of methods and processes that makes each musical choice independently modifiable.

### FIG. 5—Data Structure 500

As shown in FIG. 5, a data structure 500 of a song in the MMSP may be designed to isolate portions of data as data objects that may be related to musical choices made within specific user control tiers. These various data objects may be managed by the MMSP. As shown in FIG. 5, a Song Object 501 may contain one or more Phrase Object(s) 503 and may contain Song Data 502 (e.g., Name, Tags, etc.). Phrase Object(s) 503 may contain a Style Object 505 and may contain Phrase Data 504 (e.g., tempo, harmonic speed, etc.). Each Phrase Object 503 may include its own Style Object 505 in a 1:1 manner (e.g., as may be selectively identified by phrase data style object type 504u), such that a style can be changed throughout a song (e.g., a first phrase of a song may have a first style while a second phrase of the song may have a second style that is different than the first style). Song Object 501, Song Data 502, Phrase Object(s) 503, and Phrase Data 504 may be created in process(es) of Level 4's Song Production 303 by a Song Producer user. Additionally or alternatively, Song Object 501, Song Data 502, Phrase Object(s) 503, and Phrase Data 504 may be modified by process(es) of Level 5's Consumer Modification 302 by a Song Consumer user. Additionally or alternatively, as shown in FIG. 5, a Style Object 505 may contain one or more Track Object(s) 507 and may contain Style Data 506 (e.g., Compression, Limiter, etc.). Tracks Object(s) 507 may contain an Instrument Object 509 and Track Data 508 (e.g., quantization, track type, voicing type, etc.). Each Track Object 507 may include its own Instrument Object 509 in a 1:1 manner (e.g., as may be selectively identified by track data instrument object type 508vv), such that an instrument can be changed throughout a style object and/or a song (e.g., a first track of a song may have a first instrumentation while a second track of the song (e.g., of the same or different style object as the first track) may have a second instrumentation that is different than the first instrumentation). Style Object 505, Style Data 506, Track Object(s) 507, and Track Data 508 may be created in process(es) of Level 3's Style Production 304 by a Style Producer user. Additionally or alternatively, as shown in FIG. 5, an Instrument Object 509 may contain one or more Sample Set(s) 511 and Instrument Data 510 (e.g., sample pitch type, sample set conditions, etc.). Sample Set(s) 511 may contain one or more Audio Sample(s) 512. Instrument Object 509, Instrument Data 510, Sample Set(s) 511, and Audio Sample(s) 512 may be created in process(es) of Level 2's Instrument Production 305 process by an Instrument Producer user. In addition to the above data, other data objects (e.g., Chord Duration Data 906, Track Update Data 909, Harmony Data 910, and Note Event(s) Data 911) may be created (e.g., in a Calculate Chord Audio process (e.g., see process(es) 605 (e.g., of FIGS. 6 and 9))).

### FIG. 5A—Phrase Data 504

As shown in chart 500a of FIG. 5A, a Phrase Object 503 may include a Style Object 505 and Phrase Data 504, where Phrase Data 504 may include any suitable type(s) of phrase data object(s), including, but not limited to, Tempo 504a, Harmonic Speed 504b, Harmonic Rhythm 504c, Scale Quality 504d, Scale Root 504e, Chord Progression 504f, Drum Reverb 504g, Drum Filter 504h, Instrument Reverb 504i, Instrument Filter 504j, Swell 504k, Crash 504l, Sus4 504m, Drum Rhythm Data 504n, Drum Rhythm Speed 504o, Drum Extension 504p, Drum Set 504q, Energy 504r, Instrumentation 504s, Drum Gain 504t, Style Object Type 504u, Pitch 504v, Swing 504w, and/or the like, one, some, or each of which may have its value(s) be defined or modified by a user (e.g., a song producer and/or song modifier). Tempo 504a may have any suitable numerical value representing beats per minute (e.g., 20-400). Harmonic Speed 504b may have any suitable numerical value representing average beats per chord for instrument tracks (e.g., 2 would yield a “fast” harmonic speed, 4 would yield a “Normal” harmonic speed, 8 would yield a “Slow” harmonic speed, etc.). Harmonic Rhythm 504c may have an array of any suitable numerical values that represent the proportion of beats per given chord in relation to the average beats per chord (e.g., [1.5,0.5] would render two chords where the first has three times more beats than the second). Scale Quality 504d may have a value representing any suitable diatonic scale (e.g., “Major”, “Natural Minor”, “Harmonic Minor”, etc.). Scale Root 504e may have a value representing any suitable scale root (e.g., “A”, “B flat”, “B”, “C”, “D flat”, “D”, “E flat”, “E”, “F”, “F sharp”, “G”, “A flat”). Chord Progression 504f may have an array of one or more value pairs, each value pair representing a particular Chord 504fi (e.g., Chord 604) of Chord Progression 504f that may include any suitable number n chords (e.g., Chords 504f1-504fn (e.g., 1 chord, 2 chords, 3 chords, . . . , n chords)), representing the chord root and chord inversion of each chord, in sequence if two or more chords in the chord progression (e.g., [{root:1, inversion:0} 504f1, {root:5, inversion:1} 504f2](e.g., when there are two chord objects 504fi (e.g., n=2) in the chord progression in the phrase), or [{root:1, inversion:0} 504f1] (e.g., when there is only one chord object 504fi (e.g., n=1) in the chord progression in the phrase)). Drum Reverb 504g may have a numerical value representing the percentage of gain applied to the wet channels and reduced from the dry channels of the drum track(s) (e.g., a value of 100 for 100% wet and 0% dry). Drum Filter 504h may have any suitable numerical value representing the filter frequency of a high pass filter of the drum track(s) (e.g., 20-20,000). Instrument Reverb 504i may have a numerical value representing the percentage of gain applied to the wet channels and reduced from the dry channels of the instrument track(s) (e.g., a value of 100 for 100% wet and 0% dry). Instrument Filter 504j may have a numerical value representing the filter frequency of a high pass filter of the instrument track(s). Swell 504k may have a Boolean value (e.g., true or false) that indicates whether a swell may occur in a given Phrase. Crash 504l may have a Boolean value (e.g., true or false) that indicates whether a crash may occur in a given Phrase. Sus4 504m may have a Boolean value (e.g., true or false) that indicates whether the 5 chord (e.g., dominant chord) in a chord progression may have a suspended fourth. Drum Rhythm Data 504n may have a set of numerical arrays representing the gain value for each note of each drum (percussion) track (e.g., {hihat:[1,0.8,1,0.8], snare:[0,0,1,0], toms:[0,0,0,1], kick:[1,1,0,0]}). Drum Rhythm Speed 504o may have any suitable numerical value representing the number of drum beats per measure (e.g., 32 would yield a “fast” drum rhythm speed, 16 would yield a “slow” drum rhythm speed, etc.). Drum Extension 504p may have a Boolean value (e.g., true or false) that indicates whether a drum pattern may be extended from a 16 beat pattern to a 32 beat pattern. Drum Set 504q may have a set of arrays containing references to Audio Samples 512 associated with each drum track (e.g., {hihat:[“hihat sample 1” ], snare:[“snare sample 1”, “snare sample 2” ], toms:[“toms sample 3” ], kick:[“kick sample 5” ]}). Energy 504r may have a numerical value representing the energy of the music as further described herein. Instrumentation 504s may have an array of references to the non-percussion Track Object(s) to be enabled in the current Phrase (e.g., [“piano”, “guitar”, “voice” ]). Drum Gain 504t may have any suitable numerical value representing the Gain of the drums (e.g., 0-10.0). Style Object Type 504u may have a reference to a specified Style Object 505 among the library of available Style Objects 505 (e.g., “Cinematic Piano Style”) (e.g., which may allow a song producer to select a particular Style Object 505 for use for the particular Phrase Object 503). No matter which Style Object 505 is selected by Style Object Type 504u, the track(s) of that Style Object may be selectively enabled/disabled to define which track(s) are to be active during a certain phrase of the song (e.g., as may be defined by Instrumentation 504s (e.g., for muting one or more instruments or tracks of a selected style). Pitch 504v may have any suitable numerical value representing transposition by semitones (e.g., −12 to 12). Swing 504w may have a numerical value representing the percentage of the strength of the swing (e.g., 0-100). Certain type(s) of phrase data object(s) of Phrase Data 504 may be used to define a musical context, which may be a harmonic and time structure necessary for a style to be implemented (e.g., for a style to be realized (e.g., for use in playing back a style during a style creation process by a style producer)). For example, phrase data objects 504a-504f may be defined in order to provide a musical context.

### FIG. 5B—Track Data 508

As shown in chart 500b of FIG. 5B, a Track Object 507 may include an Instrument Object 509 and Track Data 508, where Track Data 508 may include any suitable type(s) of track data object(s), including, but not limited to, Quantization 508a, Track Type 508b, Harmony Type 508c, Track Gain 508d, Track Pitch 508e, Harmony Range 508f, Note Count 508g, Number of Voices 508h, Flux Range 508i, Flux Shape 508j, Flux Phase 508k, Flux Duration 508l, Ostinato Leaps 508m, Ostinato Directions 508n, Ostinato Rhythms 508o, Ostinato Duration 508p, Voicing Type 508q, Duplicates 508r, Rhythm Pattern Type 508s, Arpeggio Direction 508t, Arpeggio Double 508u, Arpeggio Repeat 508v, Arpeggio Hold 508w, Custom Gains 508x, Custom Rhythm 508y, Custom Pitches 508z, Syncopation 508aa, Triplets 508bb, Offbeats 508cc, Humanize Velocity 508dd, Humanize Time 508ee, Humanize Pitch 508ff, Track Reverb 508gg, Overlap Chord 508hh, Relative Envelope 508ii, Track Filters 508jj, Swell Amount 508kk, Swell Pattern 508ll, Swell Duration 508mm, Filter Frequency Minimum 508nn, Round Robin 508oo, Transition 508pp, Playback Rate 508qq, Downbeat 508rr, Delay Time 508ss, Delay Repeat 508tt, Oscillator Type 508uu, Instrument Object Type 508vv, and/or the like, one, some, or each of which may have its value(s) be defined or modified by a user (e.g., a style producer). Quantization 508a may have any suitable numerical value representing the number of rhythmic subdivisions within a measure (e.g., 0-128). Track Type 508b values may include, but are not limited to, “Drums” (or “Percussion”), “Melody”, “Ostinato”, and “Harmony”. Harmony Type 508c values may include, but are not limited to, “Mode Tonic”, “Scale Root”, “Scale Root+Fifth”, “Chord Root”, “Chord Root+Fifth”, “Triad”, “Chromatic”, “Chord Mode”, “Bass Note”, “Hinge Tone”, “Diatonic”, “Pentatonic”, “Quartatonic”, “Tritonic”, “Chord Scale”, and “Custom”. Track Gain 508d may have any suitable numerical value representing the Gain of the track (e.g., 0-10.0). Track Pitch 508e may have any suitable numerical value representing transposition by semitones (e.g., −12 to 12). Harmony Range 508f may have any suitable numerical value representing the range of the harmony within the Pitch Range of the instrument (e.g., 0-127). Note Count 508g may have any suitable numerical value representing the number of distinct pitches that may be played within a Chord (e.g., 0-24). Number of Voices 508h may have any suitable numerical value representing the number of distinct notes events that may be played within a Chord. Flux Range 508i may have a pair of numerical values that represent the minimum and maximum limits of value fluctuations (e.g., [0,127]) that may be applied to track data that has a range (e.g., data 508a, 508d, 508e, 508f, and/or 508h). Flux Shape 508j values may include, but are not limited to, “Flat”, “Swell”, “Ramp Up”, “Ramp Down”, “Square”, and/or the like that may be applied to track data that has a range (e.g., data 508a, 508d, 508e, 508f, and/or 508h). Flux Phase 508k may have a numerical value representing the percentage phase offset applied to the Flux Shape 508j (e.g., 0-100) that may be applied to track data that has a range (e.g., data 508a, 508d, 508e, 508f, and/or 508h). Flux Duration 508l may have any suitable numerical value representing the duration of time by number of Chords in which the Flux Shape 508j cycle will repeat (e.g., 1-64) that may be applied to track data that has a range (e.g., data 508a, 508d, 508e, 508f, and/or 508h). Ostinato Leaps 508m may have an array of randomly selected numerical values (e.g., [1,3,2,1]). Ostinato Directions 508n may have an array of randomly selected values either ‘up’ or ‘down’ that represent the direction of each ostinato note from the previous (e.g., [“up”, “up”, “down” ]). Ostinato Rhythms 508o may have an array of randomly selected values that represent the duration of each ostinato note (e.g., [1,1.5,0.5]). Ostinato Duration 508p may have any suitable numerical value representing the duration of time by number of Chords in which the Ostinato data 508m-508o may be updated or changed (e.g., 1-64). Voicing Type 508q may have a value of “full” or “random”. Duplicates 508r may have a Boolean value (e.g., true or false) that indicates whether duplicate pitches are permitted within the same Chord. Rhythm Pattern Type 508s values may include, but are not limited to, “arpeggio”, “repeat”, “strum”, “custom”. Arpeggio Direction 508t values may include, but are not limited to, “up”, “down”, “up down”, “down up”, “out up”, “out down”. Arpeggio Double 508u may have a Boolean value (e.g., true or false) that indicates whether each note in an arpeggio pattern may be doubled. Arpeggio Repeat 508v may have a Boolean value (e.g., true or false) that indicates whether the arpeggio pattern may be repeated for the remainder of the Chord. Arpeggio Hold 508w may have a Boolean value (e.g., true or false) that indicates whether the duration of each arpeggio note may be extended to the end of Chord. Custom Gains 508x may have an array of any suitable numerical values that represent modifications to the Gain for each Note (e.g., [1,0,0.5,0,2]). Custom Rhythms 508y may have an array of any suitable numerical values that represent modifications to the Start Time of each Note (e.g., [1,0.5,4,1,2]). Custom Pitches 508z may have an array of any suitable numerical values that represent indices of available harmony data arrays (e.g., [0,0,2,1,0]). Syncopation 508aa may have a Boolean value (e.g., true or false) that indicates whether Custom Rhythms 508y may syncopate across multiple Chords. Triplets 508bb may have a Boolean value (e.g., true or false) that indicates whether the Quantization 508a value may be multiplied by three. Offbeats 508cc may have a Boolean value (e.g., true or false) that indicates whether the Start Time for all of the Notes may be shifted to the offbeat of the Quantization 508a value. Humanize Velocity 508dd may have any suitable numerical value representing the amount of random variation applied to the Note Gain (e.g., 0-100). Humanize Time 508ee may have any suitable numerical value representing the amount of random variation applied to the Note Start Time (e.g., 0-100). Humanize Pitch 508ff may have any suitable numerical value representing the amount of random variation applied to the Note Pitch (e.g., 0-100). Track Reverb 508gg may have a numerical value representing the percentage of gain applied to the wet channel and reduced from the dry channel of the tracks (e.g., a value of 100 for 100% wet and 0% dry). Overlap Chord 508hh may have a Boolean value (e.g., true or false) that indicates whether the Note duration may overlap onto the next Chord. Relative Envelope 508ii may have a set of numerical values representing relative duration for each point in an envelope (e.g., {attack:0, sustain:50, delay:50, release: 10}). Track Filters 508jj may have a set of any suitable numerical value representing the filter frequency and any suitable numerical value representing the filter gain for each filter of the of the track (e.g., {“peaking filter”:{gain:3, frequency: 500},“high pass filter”:{gain:1, frequency: 10,000}}). Swell Amount 508kk may have a numerical value representing the percentage of modification for a Swell (e.g., 0-100). Swell Pattern 508ll values may include, but are not limited to, “Swell Up”, “Swell Down”, “Ramp Up”, “Ramp Down”, and/or the like. Swell Duration 508mm 508l may have any suitable numerical value representing the duration of time by number of Chords in which the Swell Pattern 508ll will repeat (e.g., 1-64). Filter Frequency Minimum 508nn may have any suitable numerical value representing the minimum frequency value that a filter envelope may have. Round Robin 508oo may have any suitable numerical value representing the number of Audio Samples 512 that may be used for repeated Notes of the same Pitch within the same Chord (e.g., 0-32). Transition 508pp may have a Boolean value (e.g., true or false) that indicates whether the Note Start Time may be modified to synchronize with the end of the Chord. Playback Rate 508qq may have any suitable numerical value representing the Audio Source playback rate (e.g., 0.01-100). Downbeat 508rr may have a Boolean value (e.g., true or false) that indicates whether the Note Start Time may be modified to synchronize with the beginning of the Chord. Delay Time 508ss may have any suitable numerical value representing the relative amount of time (e.g., based on the duration of the measure) that a note may be delayed (e.g., 0-1.0). Delay Repeat 508tt may have any suitable numerical value representing the number of repeats a delay may have (e.g., 1-64). Oscillator Type 508uu values may include, but are not limited to, “sine”, “triangle”, “sawtooth”, “square”, and/or the like. Instrument Object Type 508vv may have a reference to a specified Instrument Object 509 among the library of available Instrument Objects 509 (e.g., “Gentle Piano 1”) (e.g., which may allow a style producer to select a particular Instrument Object 509 for use for the particular Track Object 507). Certain type(s) of track data object(s) of Track Data 508 may or may not be relevant for a particular track type. For example, if a track is a melody track type, then track data 508c and 508s may not be relevant. Additionally or alternatively, if a track is an ostinato track type, then track data 508s may not be relevant. Additionally or alternatively, if a track is a harmony track type, and its pattern type is custom, then customization of track data 508x-508z and track data 508aa may be available. Additionally or alternatively, if a track is a percussion track type, then track data 508d, 508dd-508gg, 508ii, 508jj, 5088ss, and 508tt may be relevant. If Flux Shape 508j is not flat, then track data 508k and 508l may be available regardless of track type.

### FIG. 5C—Instrument Data 510

As shown in chart 500c of FIG. 5C, an Instrument Object 509 may include one more Sample Set(s) 511 and Instrument Data 510, where Instrument Data 510 may include any suitable type(s) of instrument data object(s), including, but not limited to, Sample Pitch Type 510a, Sample Set Conditions 510b, Pitch Range 510c, Sample Type 510d, and/or the like, one, some, or each of which may have its value(s) be defined or modified by a user (e.g., an instrument producer). Sample Pitch Type 510a values may include, but are not limited to, “single”, “melodic”, and “harmonic”, where a value of “single” may signify an audio sample containing a single pitch (e.g., a single note from a piano, guitar, violin, etc.), a value of “melodic” may signify an audio sample containing more than one pitch not occurring simultaneously (e.g., a violin sliding from one pitch to another, or a voice singing one pitch, then another, etc.), and a value of “harmonic” may signify an audio sample containing more than one pitch occurring simultaneously (e.g., a chord strummed on a guitar, an orchestra playing a full chord, etc.). Sample Set Conditions 510b may have a variety of data sets that describe the harmonic conditions in which each Sample Set 511 may be used (e.g., {0:[“scale”, 1], 1:[“scale”, 2], 2:[“triad”, 3]} (e.g., sample set 1: play when the Scale contains a minor 2nd above the Note; sample set 2: play when the Scale contains a major 2nd above the Note; sample set 3: play when the Triad contains a minor 3rd above the Note)) or (e.g., {0:[“Chord Quality”, “major” ], 1:[“Chord Quality”, “minor” ], 2:[“Chord Quality”, “sus4” ]} (e.g., sample set 1: play when the Chord Quality is Major; sample set 2: play when the Chord Quality is Minor; sample set 3: play when Chord Quality value is Suspended 4)). Pitch Range 510c may have a pair of numerical values that represent the minimum and maximum limits of the pitch of the instrument (e.g., [21,72]). Sample Type 510d values may include, but are not limited to, “Sustain”, “One Shot”, and/or the like, where a value of “Sustain” may signify a sample that may be looped (e.g., a sustained violin, horn, or voice), and a value of “One Shot” may signify a sample that may not be looped (e.g., a snare hit, string pluck, piano key strike etc.). Sample Set Conditions 510b data may only be required or available when the instrument contains more than one Sample Set 511 (e.g., when associated Sample Pitch Type 510a of the Instrument Object 509 is harmonic or melodic (e.g., an audio sample containing more than one pitch)), while Sample Pitch Type 510a, Pitch Range 510c, and Sample Type 510d may be available for any sample. Multiple pitches may be in a sample (e.g., an instrument that uses samples containing an individual note may have one sample set, while an instrument that uses samples containing a chord may have three sample sets (e.g., one for major chord, one for minor chord, one for sus4 chord)), where a two-dimensional way to access files may exist (e.g., one based on actual file based on root of chord or another based on accessing by sample set quality of the chord). For example, if there are 40 notes to be chorded, 3 sample sets may exist (e.g., one for major chord, one for minor chord, one for sus4 chord), with 40 samples per sample set, but only one set of instrument data variables 510a-510d may exist for the combined 3 sample sets/120 samples, where pitch range 510c may include indication of the lowest of the 40 notes and the highest of the 40 notes.

### FIG. 6—Time Structure 600

As shown in FIG. 6, a time structure 600 may be managed by the MMSP. As shown, a Song 601 time unit may contain one or more Section 602 time units and may represent the duration of a Song Object 501 when played. A Section 602 time unit may contain (e.g., be a grouping of) one or more Phrase 603 time units and may represent the duration of a grouping of Phrase Objects 503 when played. A Phrase 603 time unit may contain a Chord Progression 504f of one or more Chord 604 time units (e.g., chord(s) 504fi) and may represent the duration of a single Phrase Object 503 when played. The duration of each Chord 604 time unit may be determined by one or more data objects of Phrase Data 504 (e.g., Tempo 504a, Harmonic Speed 504b, Harmonic Rhythm 504c, etc.). For each Chord 604 time unit, a chord audio calculation process 605 of the MMSP may be run that Calculates Chord Audio (e.g., the audio that may be played within the duration of that Chord 604 time unit (e.g., as may be further described with respect to process Calculate Chord Audio 605 of FIG. 9)). Note Event(s) Data 911 may be calculated beginning at each Chord 604 time unit, which may enable the user to make changes to the Modifiable Song data and hear feedback as soon as the next Chord 604 is played. For example, process 605 may be automatically run for each chord of a song in real-time during playback of the song, such as in level 5 during playback of a song being modified by process 302, in level 4 during playback of a song during creation/editing of the song by process 303, and/or in level 3 during playback of a style with any suitable musical context during creation/editing of the style by process 304. This may be in contrast to a user experience in a manual song creation process 307 (e.g., using a DAW), where the user may record/change audio or Musical Instrument Digital Interface (“MIDI”) data in real-time, but cannot make global changes to all of the tracks as an integrated whole (e.g., if there are multiple MIDI tracks (e.g., melody, chords, etc.), a conventional DAW may not be able to enable a user to change the chord progression of just one track or phrase or section automatically, as there may be no computer knowledge or integration between the tracks (e.g., no ability to change harmonic rhythm when chords change), but instead a conventional DAW may require manual manipulation). Process 605 may enable automatic changes within and among tracks on a chord by chord basis (see, e.g., FIGS. 9 and 13), where a user may be modifying (e.g., via any suitable interaction(s) with the MMSP) any suitable data of song object 501 (e.g., phrase data 504) during the iteration(s) of process 605 (e.g., at any suitable time before or during or after the running of process 605 with a subprocess 605a (see, e.g., FIG. 9)), and such modified (e.g., user adjusted/selected) song object data of song object 501 may be utilized by process 605 as soon as the modification has been made (e.g., automatically during the running of process 605). This may also be in contrast to a user experience in a fully automated song creation process 301, as fully automated song generators may result in a rendered audio file with no real-time modification capability. Such real-time feedback of the MMSP via Modifiable Song Technology 308 may enable an improvisational workflow for song and style production and the decision-making process for modifying a song. The execution of real-time modifications with various musical controls and a high level of musical and audio quality may be enabled by the automated technology of the MMSP in novel and unique ways that are not able to be accomplished efficiently or effectively by a human composer.

### FIGS. 117-132—Exemplary GUI Screenshots 11700-13200

As shown by exemplary GUI screens 11700-13200 of respective FIGS. 117-132, one or various subsystems of system 1 may be configured to display various screens with one or more graphical elements of a GUI via any suitable I/O component(s) (e.g., I/O component 116). These may be specific examples of such displays of a GUI during use of one or various MMS applications of data structure(s) 119 on one or various customer subsystems by one or various types of end user for interacting with the MMSP.

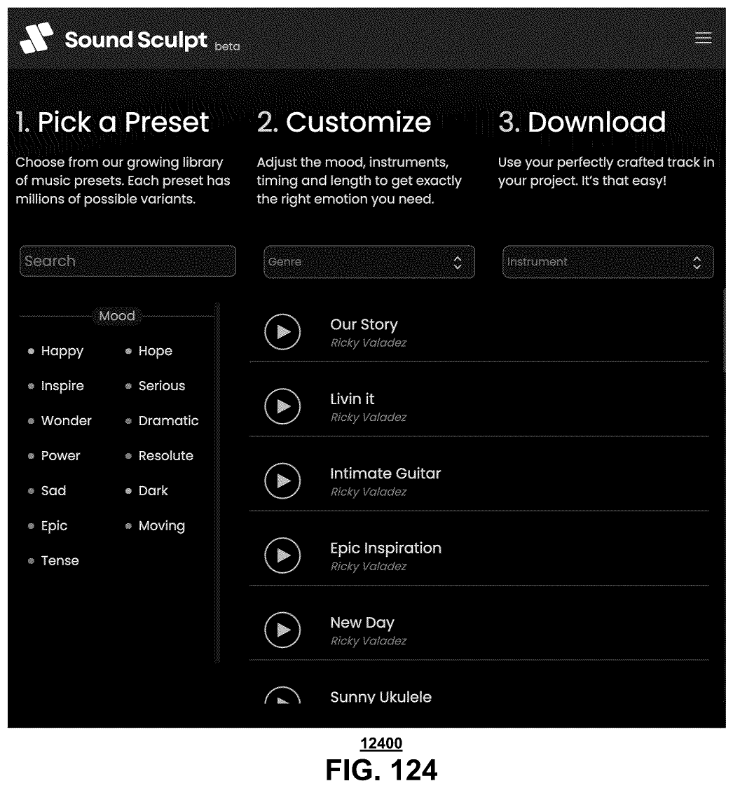

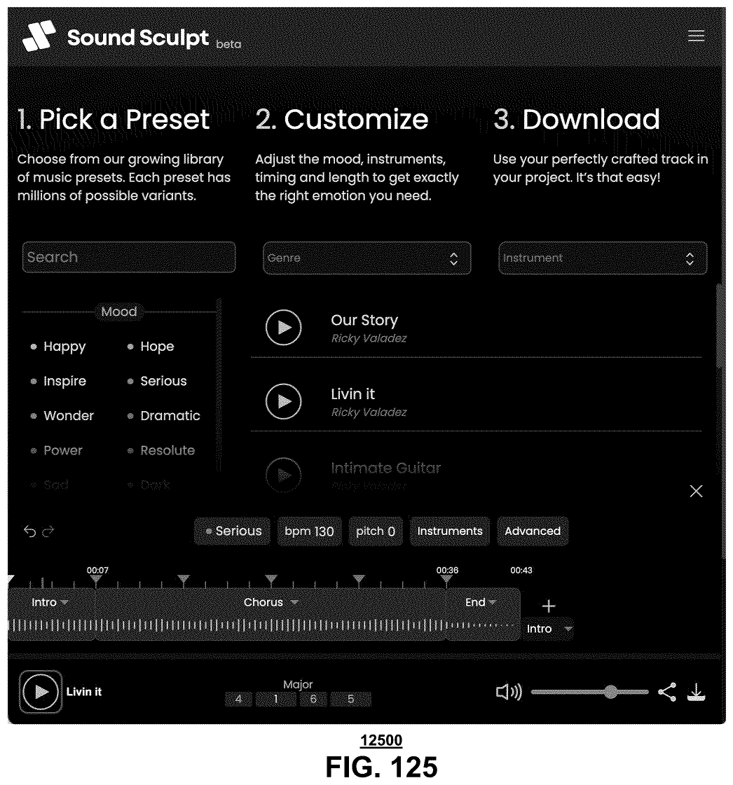

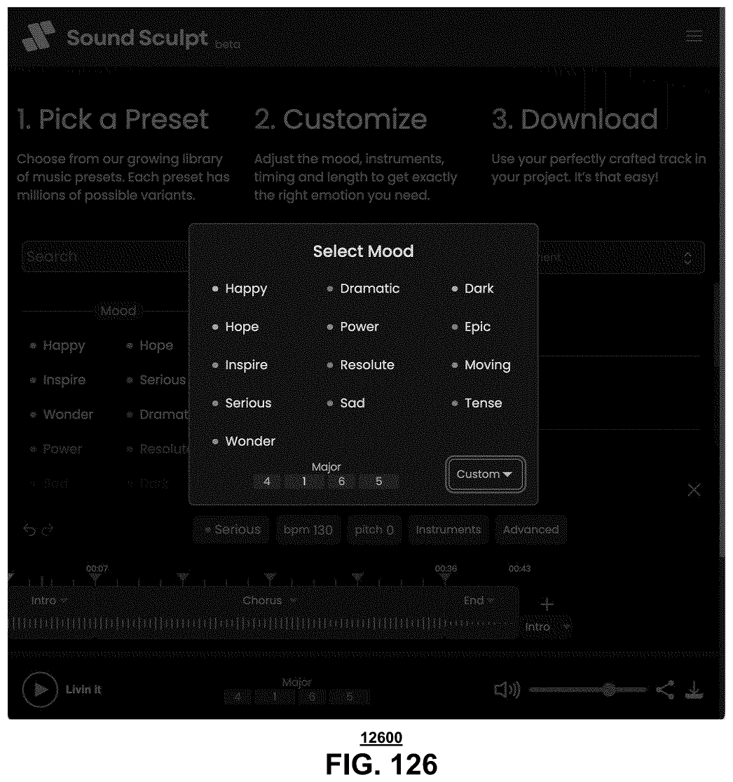

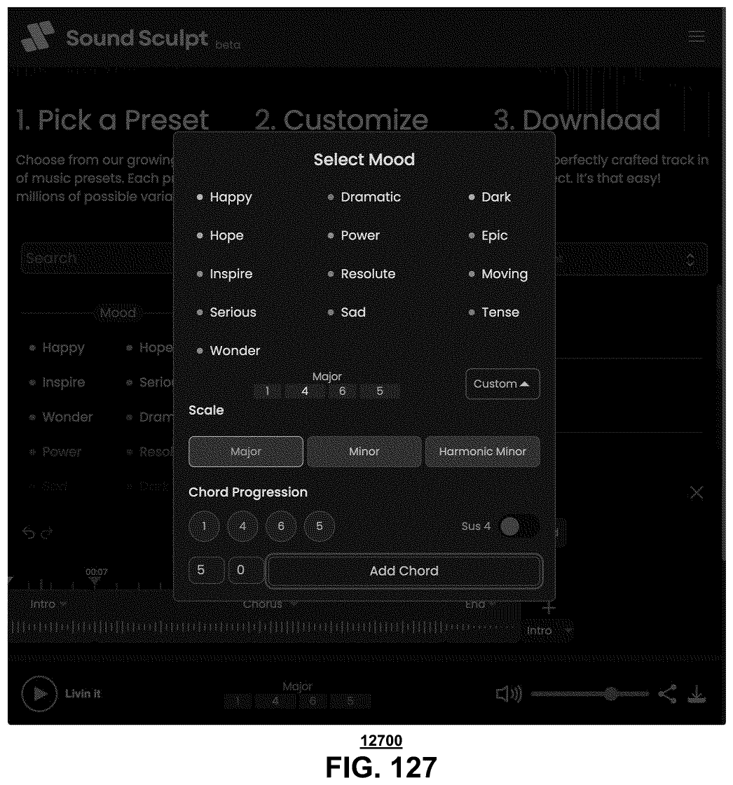

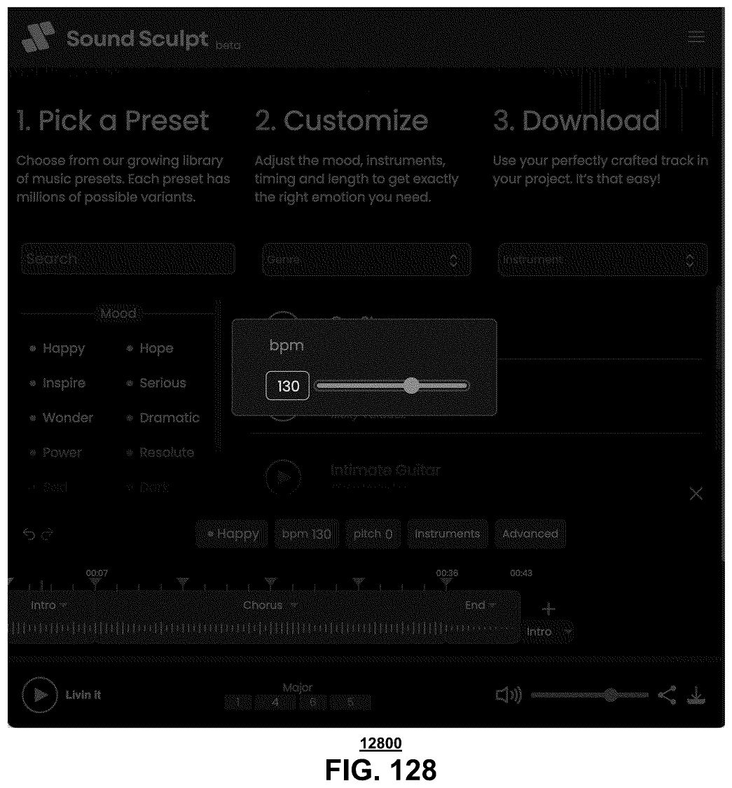

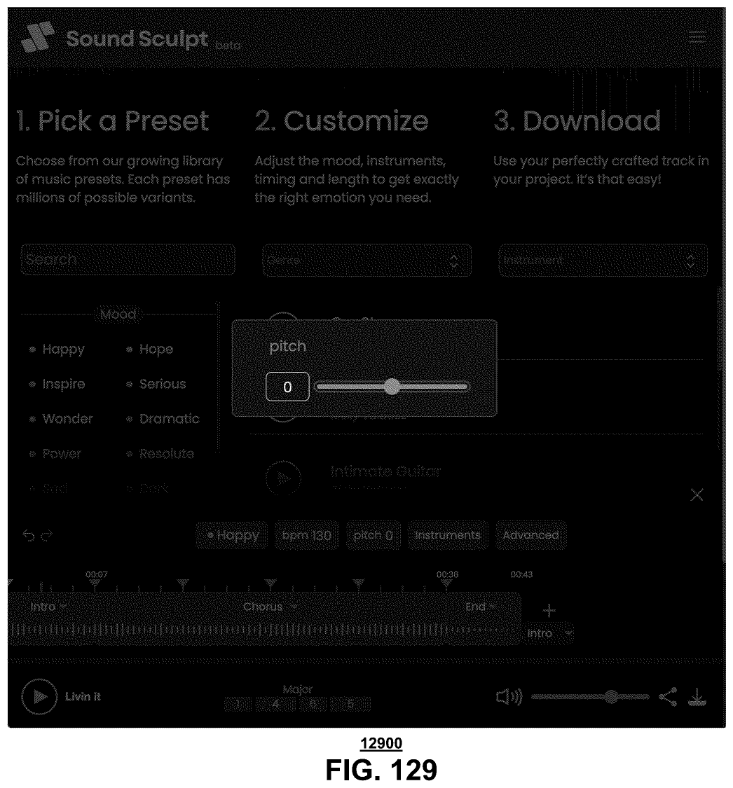

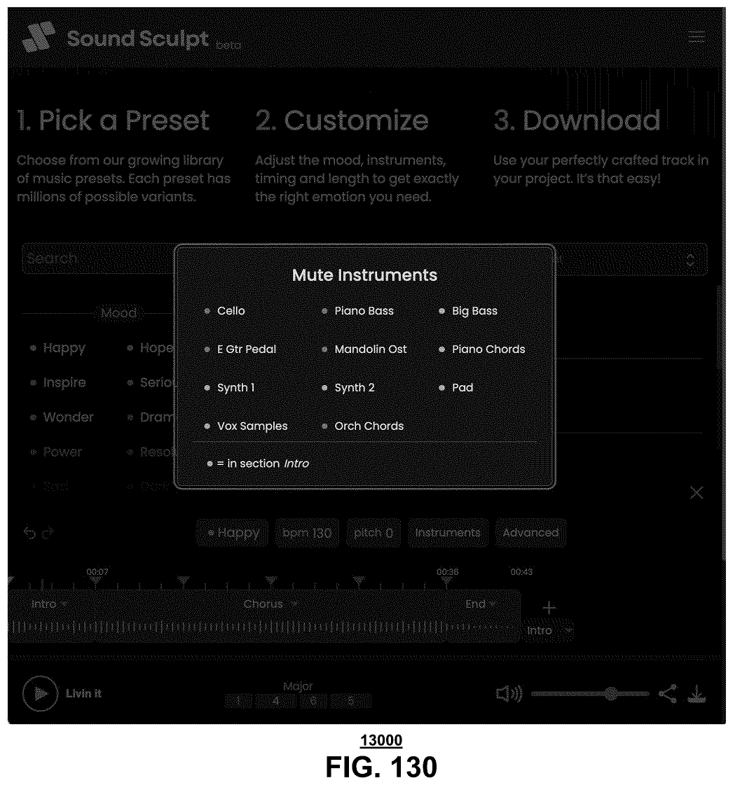

A song market app or song modification app of the MMSP may be provided to an end consumer (e.g., to a subsystem 100a, 100b, etc. of an end consumer) for use in modifying a song that has already been created. For example, as shown by exemplary GUI screen 12400 of FIG. 124, a song modification app of the MMSP may present a library of modifiable songs to a user. Upon selecting a song, modification and playback controls may be presented, as exemplified by GUI screen 12500 of FIG. 125. A user may be presented with an option to change the mood of a song by selecting from a list of moods, as exemplified by GUI screen 12600 of FIG. 126. A mood may be a preset combination of Scale Quality 504d and Chord Progression 504f data. While a user may be presented with an option to change the mood of a song by selecting from a list of moods, as exemplified by GUI screen 12600 of FIG. 126, a user may additionally or alternatively be presented with an option to independently customize or change the scale (e.g., major, minor, harmonic minor, etc.) of Scale Quality 504d and the chord progression (e.g., 1>4>6>5, etc.) of Chord Progression 504f rather than selecting a predefined mood, as exemplified by GUI screen 12700 of FIG. 127. Various additional or alternative modification controls may be presented to users, such as shown by exemplary GUI screens 12800-13100 of respective FIGS. 128-131 (e.g., beats per minute (“BPM”) of Tempo 504a in FIG. 128, pitch of Pitch 504v in FIG. 129, instrumentation (e.g., select specific tracks of a style) of Instrumentation 504s in FIG. 130, key of Scale Root 504e and/or harmonic rhythm of Harmonic Rhythm 504c and/or harmonic speed of Harmonic Speed 504b and/or swing of Swing 504w in FIG. 131, and/or the like). As another example, as shown by GUI screen 11700 of FIG. 117, a song modification app of the MMSP may enable a user to select a song (e.g., song “Promo Home”) and then provide the user with any suitable consumer modification controls for modifying the selected song, including, but not limited to, presenting representations of different sections of the song (e.g., “Build” and “Chorus” and “End”), each of which may be rearranged with respect to one another, duplicated, extended (e.g., in length), removed, and/or the like to further arrange the sections of the song, along with various other controls, such as scale, key, tempo, chords (e.g., chord progression), and/or the like, that the consumer may modify for one, some, or each section and/or for one, some, or each phrase of one, some, or each section. The consumer may playback the song and manipulate these controls in real-time (e.g., via and during process 605 (e.g., at subprocess 605a)). In some embodiments, a video may be synchronized with the song and may be similarly manipulated and/or may be played back to facilitate the consumer making changes to the song when desired based on viewing the video. For example, synchronizing specific moments in a song with specific moments in a video is a method for enhancing the experience of an audio-visual work. This may be done by either creating a custom film score that synchronizes with the previously edited video, or by editing the video to synchronize with a previously recorded song. The MMSP may provide a user with a new method of modifying a song to synchronize specific moments in a song with specific moments in a video. The user may be able to import or upload a video. The user may be able to interact with a timeline of the video. The user may be able to play, rewind, and seek through the video with transport controls. The user may be able to set time markers for synchronizing with specific moments in a song. As modifications are made to the song, the user may see how sections or phrases of the song change in the timeline in relation to the video and the time markers. The user may be enabled to playback the video synchronized with the song and may make modifications to the song in real time. The user of the MMSP may be enabled to automatically adjust the song to synchronize with the video by setting a sync point and pressing a “Sync” button for each sync point, which may initiate a process of the MMSP to calculate and automatically adjust the Tempo 504a and Harmonic Speed 504b of the previous phrases so that the nearest Section 602 beginning synchronizes with the sync point. This method of modifying a song to synchronize to video may enable a user with little to no musical skill to create a custom score for a fixed video. Therefore, this technology may alter the mood and timing of a song in real-time. In contrast, conventionally, in order to synchronize video and audio, video editors may either edit their video to match the music (e.g., when using a fixed static audio file), or they may hire a composer to compose manually a song that syncs with their video and they often also use a fixed static audio file, but chop it up, copy and paste sections, and crossfade it to try and sync it up, but there are many limitations and challenges with that.

A content production app of the MMSP may be provided to various content creators (e.g., to song producers (e.g., to a subsystem 100e, 100f, etc. of a song producer user), to style producers (e.g., to a subsystem 100g, 100h, etc. of a style producer user), to instrument producers (e.g., to a subsystem 100i, 100j, etc. of an instrument producer user), and/or the like) for use in producing the components of a song that may later be modified by an end consumer (e.g., via a song modification app).

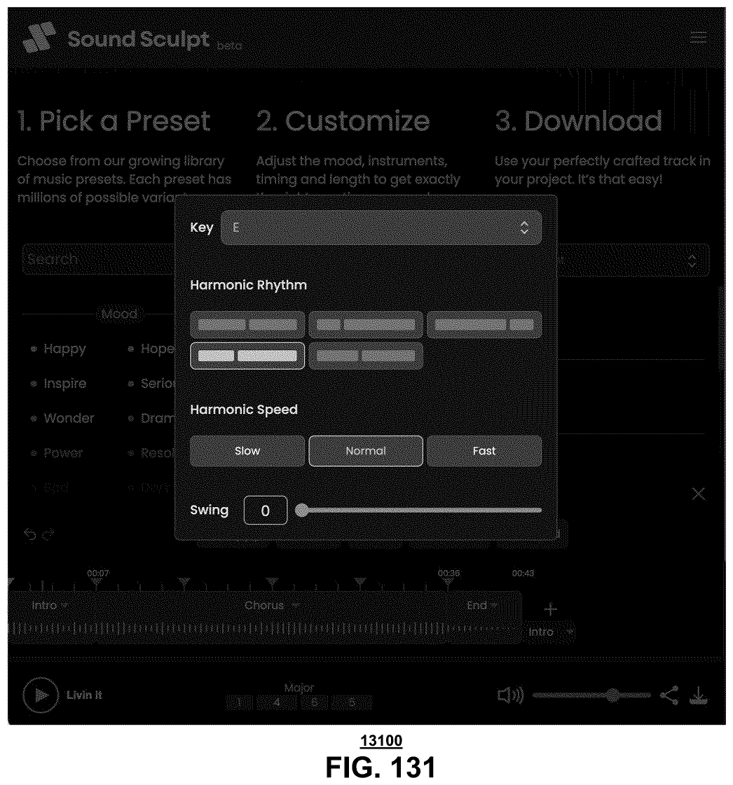

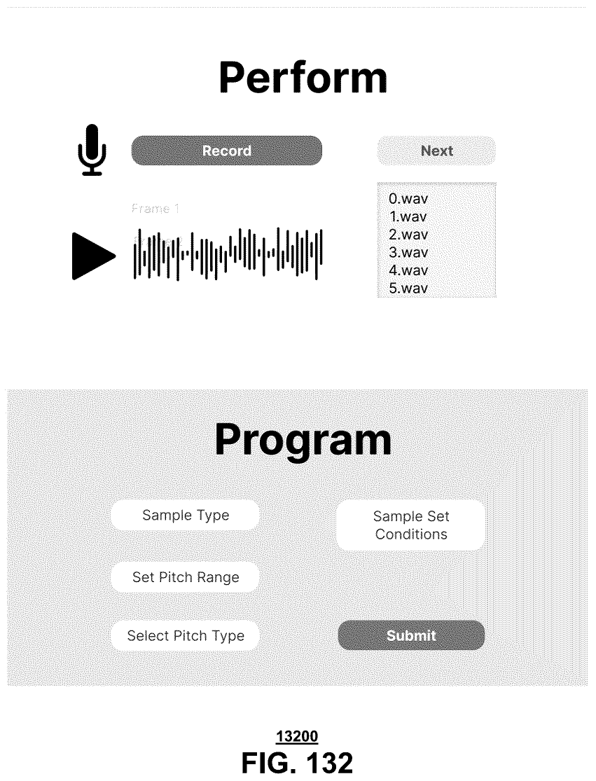

For example, as shown by GUI screen 13200 of FIG. 132, an instrument production panel of a content production app of the MMSP may enable a user to record and upload Audio Samples 512 and program instrument object data 510 (e.g., of Instrument Object 509) for those Audio Samples 512, which may inform the algorithms of the MMSP how each Audio Sample 512 should be processed, where all potential sounds may be constrained to the available instrument library, which may ensure a level of sonic quality. GUI screen 12000 of FIG. 120 may highlight instrument object data controls 12001-12009 (e.g., as described with respect to FIGS. 86-95). This instrument production panel may selectively show one, some, or all instruments within the content production app and the various shown inputs may be used to inform the algorithms of the app how the instrument(s) should behave. Once an instrument producer has designed an instrument, a style producer may design a style that includes the instrument.

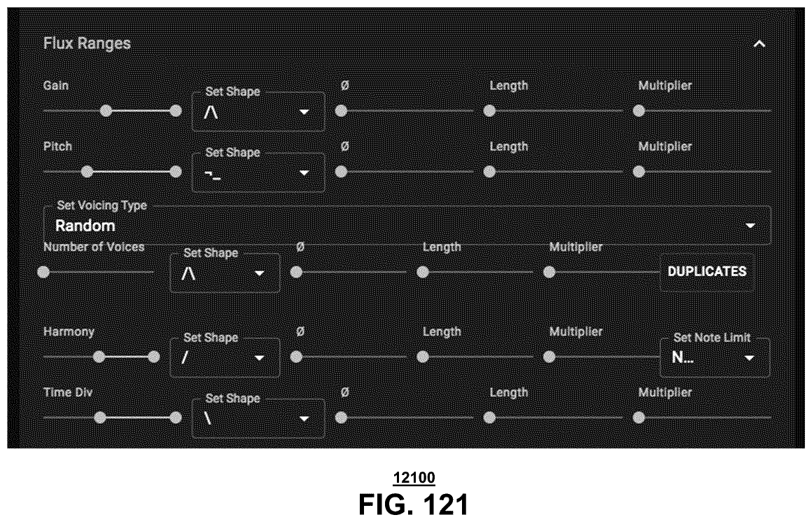

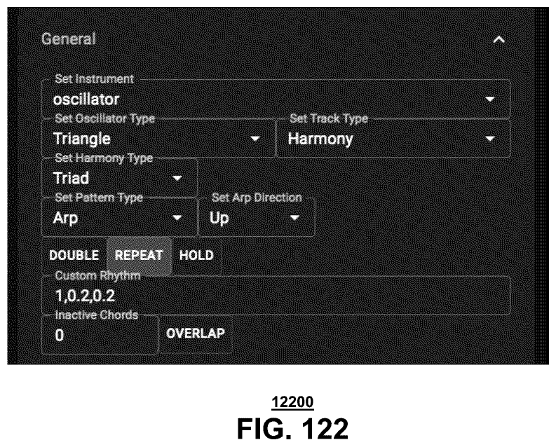

As another example, as shown by GUI screen 11900 of FIG. 119, by GUI screen 12100 of FIG. 121, and/or by GUI screen 12200 of FIG. 122, a style production panel 11900 of a content production app of the MMSP may enable a user to modify Style Object 505 and Track Object(s) 507 that may determine how each instrument may be performed when processed through the algorithms of the MMSP, where this may be the most granular level of control available to users, and may enable the greatest range of possibilities. For example, GUI screen 11900 of FIG. 119 may include any suitable content production app controls, such as Style Object 505 data controls 11901 and Track Object(s) 507 data controls 11902 (e.g., as described herein (e.g., with respect to FIGS. 32-35, 48-54, 60-65, 75-76, 100-104, and 113)), flux parameters 11904 (e.g., as described herein (e.g., with respect to FIGS. 28-31 and 48-50)), track rhythm pattern types with the “Set Pattern Type” select 11903 and track quantization controls with buttons “Offbeat” and “Triplets” 11904 (e.g., as described herein (e.g., with respect to FIGS. 63-65)), track envelope data controls 11905 (e.g., as described herein (e.g., with respect to FIGS. 77-78)), track swell data controls 11906 (e.g., as described herein (e.g., with respect to FIGS. 79-84)), track humanize controls 11907, track FX controls 11908, track Mix controls 11909, and/or the like. Additionally or alternatively, GUI screen 12100 of FIG. 121 may include any suitable content production app controls, such as flux data controls (e.g., as described herein (e.g., with respect to FIGS. 28-31 and 48-50)). Additionally or alternatively, GUI screen 12200 of FIG. 122 may include any suitable content production app controls, such as general track controls (e.g., as described herein (e.g., with respect to FIGS. 54, 48-50, and 116)). This style production panel may show each of the tracks in a particular style (e.g., cello, synth, voice, etc.), and the various shown controls may be used to manipulate each particular track of the style. Once a Style Producer has designed a style, a song producer may design a song that includes the style.

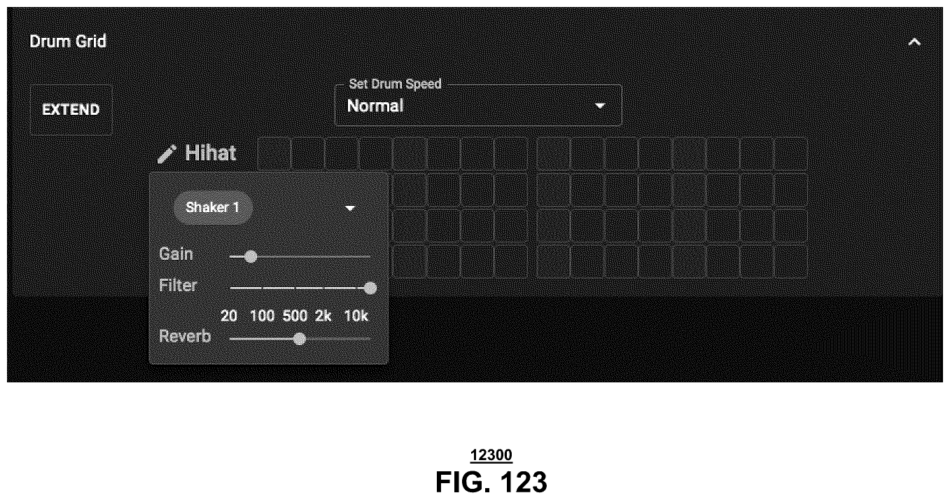

As yet another example, as shown by GUI screen 11800 of FIG. 118 and GUI screen 12300 of FIG. 123, a song production panel of a content production app of the MMSP may enable a user to modify Song Objects 501 and Phrase Objects 503, which may determine high level song characteristics, and the structure and development of the song for each phrase, which may be based on previously created styles. For example, GUI screen 11800 of FIG. 118 may include any suitable content production app controls, such as Song Object 501 controls 11801 and Phrase Object 503 data controls 11802 (e.g., as described herein (e.g., with respect to FIGS. 17, 21-23, 26, 27, 48-50, 73, and 74)), sections 11803, phrases of each section 11804, one of which may be selected for creation/adjustment of selected phrase data (e.g., as described herein (e.g., with respect to FIG. 6)), “Main” controls 11806, such as tempo, Harmonic Speed 504b (e.g., “Set Chord Speed” select), and Harmonic Rhythm 504c (e.g., “Set Balance” select) data controls of a selected phrase (e.g., as described herein (e.g., with respect to FIGS. 10-12)), “Mix” controls 11808, “Harmony” controls 11809 including Chord Progression 504f controls of a selected phrase (e.g., as described herein (e.g., with respect to FIGS. 13, 17, and 48-50)), “Instrument” controls 11805 including Swell 504k and Crash 504l of a selected phrase (e.g., as described herein (e.g., with respect to FIGS. 68-72)), “Drum Grid” controls 11807, such as beat pattern, and drum speed of a selected phrase (e.g., as described herein (e.g., with respect to FIGS. 24-25)), and/or the like. For example, GUI screen 12300 of FIG. 123 may include any suitable content production app controls, such as phrase drum track data controls (e.g., as described herein (e.g., with respect to FIG. 67)). This song production panel may allow producers to pick a style or styles and craft a song over time with different sections based on any instrument settings (e.g., to define macros of song). The different sections of the song (e.g., build, chorus, end) can be created, rearranged, duplicated, and the like, where each section may have one or more columns, each representing a phrase of the song section, whereby a producer can drill down to specific instruments, mix, main harmony, drum grid, and/or the like for a particular phrase of a particular section of a particular song being crafted. Once a song has been produced with a structure, the song may be submitted to the MMSP marketplace, where consumers can come and make modifications and purchase or otherwise utilize the song for their end purpose(s) (e.g., using a song market app or song modification app of the MMSP).

Each screen of any such GUI of the MMSP may include various user interface elements. For example, as shown, each one of screens 11700-13200 of FIGS. 117-132 may include any suitable user selectable options and/or information conveying features. The operations described with respect to various GUIs may be achieved with a wide variety of graphical elements and visual schemes. Therefore, the described embodiments are not intended to be limited to the precise user interface conventions adopted herein. Rather, embodiments may include a wide variety of user interface styles.

### MMSP Possibilities

Up to this point, various overarching principles of the MMSP have been mentioned, such as describing how the MMSP may provide a new experience for music creators, and those seeking to purchase or modify music. The functionality of the MMSP may be applied to innovate the creation/modification process of music that ultimately may result in an exported audio file. The ability to modify elements of a song may be especially useful in the commodity music market, where creators seek music to synchronize with videos, podcasts, television, movies, radio, advertisements, and the like. In addition to these new methods to the song creation process, there are other applications of the MMSP that may be enabled, for example, based on various key features of the MMSP, such as real-time feedback and modification, and a complete data structure for each song, which may be related to specific musical concepts.

One such application may be music visualization. Traditional music visualizers use data from an audio file to present visual representations of the music. An audio file often only contains data of the frequency and amplitude of the waveform over time. These visualizers cannot distinguish one instrument from another, specific pitches, or detailed harmonic information. Through the MMSP, it is possible to get data for every single note and sound that is played regarding its time, pitch, gain, and other details regarding its context, such as chord tones and scale tones, which can be used to provide a much richer and more informative music visualization experience.

Another such application may be music games and education. With the many different modification controls and real-time feedback made available by the MMSP, the experience of modifying or creating music can become an end in itself. This can be coupled with real-time visualization feedback. These experiences can be designed for educational purposes to discover and explore different music theory and music production concepts. They can also be designed for therapeutic or entertainment purposes. For most video games, there is a single trigger that will change the audio from one prerecorded audio sample (e.g., Audio Sample 512) to another. With Modifiable Song Technology 308 of the MMSP, game developers may provide a much more nuanced and integrated audio experience, slowly transforming the mood of a song with an array of user inputs, creating seamless audio transitions while keeping specific motifs and audio hooks unperturbed by the changes.

Another such application may be scientific research and therapy. Humans often intuitively sense that music influences our minds and bodies. This is observed by the vast quantity of music that is labeled for therapeutic application in areas such as reducing stress, improving sleep, pain management, altering mood, and/or improving mental alertness. A review of 44 studies showed that “[t]hirteen of 33 biomarkers tested were reported to change in response to listening to music” (https://pubmed.ncbi.nlm.nih.gov/29779734/). Despite such studies, a substantial void exists in the understanding of how specific musical characteristics affect pain perception, stress reduction, and overall well-being. For example, in order to measure the effect of various tuning systems on a person's heart rate or brainwave activity, one would need to produce the same song with various tuning systems, ensuring that all other musical elements remain the same for a controlled experiment. This would be extremely time consuming using the traditional method of music production. But with the MMSP, the ability to change the tuning system may be already built into every song. To answer the undeniable need for evidence-based approaches to music therapy, the MMSP may be an innovative solution to investigate music's therapeutic potential with scientific precision. The MMSP may be capable of facilitating highly controlled trials by enabling researchers to modify individual musical characteristics while maintaining consistency across all other variables. A common tuning system of western culture is Equal Temperament. There are hundreds of other systems that have been developed. Each can be determined by the relationship between the scale root and each scale degree. The MMSP may be configured to have data for every note regarding its relation to the key and scale. Therefore, the MMSP can automatically modify the pitch for each note to match specific tuning systems. Additionally, the MMSP can be configured to produce dynamic tuning systems automatically based on the relation of each note and the current chord root and inversion. For example, musical characteristics, such as key, tempo, scale, tuning, chord progression, and others, may be independently modified in real-time as a piece of music plays for the listener while all other musical characteristics remain unchanged. This may make it possible to: (a) measure the effects of specific musical characteristics in a highly controlled manner (e.g., biomarkers could be recorded in response to changes in musical characteristics or various combinations, thus revealing how musical characteristics may be used as interventions to manage chronic pain, reduce stress, and improve sleep); and/or (b) run adaptable tests to achieve specific biomarker targets using biofeedback as input (e.g., with each adaptation, the MMSP could measure whether the biomarkers respond positively or negatively towards the target, adapting according to feedback). This data can be stored as a personal calibration for the user. In addition to personally calibrated data, users could opt-in to submit their data to be aggregated with other users to find commonalities. This may further develop the science of music as a therapy using a more quantifiable and objective standard.

### FIG. 7—Revenue Structure

From a revenue perspective, the different tiers of control for user types of the MMSP can be grouped into two user categories of structure 700 of FIG. 7, consumers 701 and producers 702. Traditionally, to produce acceptable quality music has required years of training and experience. In the modifiable song production ecosystem of the MMSP, there are opportunities for creative contribution for various levels of skill. Users who wouldn't normally be able to produce a song could contribute to designing a modifiable song by using a style created by another user as a foundation and then creating a new drum beat that gives it an entirely new sound. An input revenue can come from consumers from a variety of websites or applications that may use a library of modifiable songs of the MMSP. Some examples of how a modifiable song library could be used include, but are not limited to, music for videos, music for interactive games and education, music for research and therapy, music for custom radio for stores, and/or the like. When a modifiable song license is sold, the revenue may be split between every party that contributed to its production. For example, as shown in FIG. 7, consumers 701 using process(es) of consumer modification 302 may provide revenue from market song modification to producers 702 of various types, including, but not limited to producers who contribute through process(es) of the following: data structure and algorithms creation 306, instrument production 305, style production 304, song production 303, and/or the like. Data structure and algorithms creators may be any suitable producers, such as share-holders of the MMSP and/or of the company(ies) that may use the MMSP. Instrument producers may be any suitable producers, such as those that may require a specialized technical skill, which may be handled in-house, but could be opened up to user submissions with enough quality control and guidelines. This revenue portion may be split among producers proportional to the number of instruments used in the song. Style producers may be any suitable producers, such as public users that may have more granular control over which instruments may be used and how they may behave. Song producers may be any suitable producers, such as public users that may potentially only be music hobbyists that enjoy crafting the macro structure of a song. This structure 700 of FIG. 7 may create a necessarily collaborative music creation economy and community. The economic incentive for producers may help the community grow faster. The available resources for future producers may increase with every new instrument, style, and/or song that may be created. Therefore, creative production is likely to grow exponentially as the community of producers grows. This structure may provide an innovative relationship between the various producers and the consumers that can economically promote collaborative music creation. For example, a style producer may also produce a song that includes their style, but they may also benefit financially if other song producers use their style because it may increase their opportunities to monetize their style.

### FIG. 8—Audio Processing Graph

In the art of digital audio mixing, there are various mathematical processes that may change the sound of an audio signal. Individual audio signals can be merged into a single audio bus that can be processed as a whole. Audio Processing Graph 800 of FIG. 8 shows how the audio signals may be routed through various audio chains from any suitable number of individual Audio Sources 801a-801c to an Audio Destination 805. There may be any number of Audio Sources processed by the MMSP. Audio Sources 801a-801c are used specifically as an example of Audio Processing Graph 800, and the term Audio Source(s) in general may be herein referenced as Audio Source(s) 801. Audio Sources 801 may be determined and scheduled by process(es) of Calculate Chord Audio 605 described herein. An Audio Source 801 may, for example, be either an Audio Sample 512 or a Synthesized Oscillator. When a note event of Note Event(s) Data 911 is processed by the MMSP, it may create an Audio Source 801. Each note event of Note Event(s) Data 911 may be associated with a single Track Object 507. A single Audio Source 801a may be coupled to a Source Audio Chain 802a that may include a chain of one or more audio processes of the MMSP that may only apply to that individual Audio Source 801a. These audio processes may include, but are not limited to, processes for or using gain, filters, attack, decay, sustain and release (“ADSR”) envelopes, and/or the like. There may be any number of Track Audio Chains processed by the MMSP. Track Audio Chains 803x-803z are used specifically as an example of the Audio Processing Graph 800, and the term Track Audio Chain(s) in general may be herein referenced as Track Audio Chain(s) 803. One Track Audio Chain 803 may be created for each Track Object 507. The processed outputs 801a′-801c′ of one or more Source Audio Chains 802a-802c may be bussed together as bussed processed output 801ac and then fed into a Track Audio Chain 803y that may include a chain of one or more audio processes of the MMSP. These audio processes may include, but are not limited to, processes for or using wet and dry audio paths for reverb application, panning, filtering, equalization (“EQ”), and/or the like. There may be multiple Source Audio Chains 802 per Track Object 507. The output of one or more Track Audio Chains 803x-803z as processed outputs 803x′-803z′ may be bussed together as bussed processed output 803xz then fed into a Master Audio Chain 804 that may include a chain of one or more audio processes of the MMSP that may apply to the entire song for producing output 804xz for an Audio Destination 805. These audio processes may include, but are not limited to, processes for or using reverb, gain, multi-band compression, limiting, and/or the like. Audio Destination 805 may be either an online audio context for providing device audio output for real-time playback of the audio or an offline audio context for rendering the audio for download. The offline audio context may be used when a user wants to render or export a song as an audio file, and this process may be done in less time than the duration of the song. The potential processes for each chain and the overall sequence of Audio Processing Graph 800 may be hardcoded in level 1 for data structure and algorithms creation 306. A main intended purpose of FIG. 8 may be to give a more complete understanding of the details of the MMSP and lay a foundation of terms that are used throughout this disclosure. Process(es) of a Master Audio Chain 804 may be determined by Style Data 506 (e.g., Phrase Data 504 (e.g., reverb/filters) may influence Style Data 506, while most other determinators may come directly from Style Data 506 (e.g., data accessible to a style producer but potentially not accessible to a song producer or song modifier (e.g., name/meta & instructions for master audio chain))). Process(es) of a Track Audio Chain 803 and/or of a Source Audio Chain 802 may be determined by Track Data 508 (e.g., Track Filters 508jj, Track Reverb 508gg, Swell Amount 508kk, Filter Frequency Minimum 508nn, and/or the like for Track Audio Chain 803 and/or Relative Envelope 508ii, Filter Frequency Minimum 508nn, and/or the like for Source Audio Chain 802). Scheduled Audio Source(s) 913 of Calculate Chord Audio process 605 may be provided as an instruction set for each relevant chord of process 605, and such an instruction set for a chord may include any suitable instructions, including, but not limited to, instructions on when and how to play oscillator or way file(s), which way files to play, when to play them, what additional effects in source audio chains to be applied (e.g., including source audio chains connected to every audio source), and/or the like, wherein Scheduled Audio Source(s) 913 of Calculate Chord Audio process 605 for a chord may include Audio Source(s) 801 and Source Audio Chain(s) 802 for that chord. While data of FIGS. 5A-5C may be used by process 605 to define Scheduled Audio Source(s) 913 of Calculate Chord Audio process 605 for a chord, that Scheduled Audio Source(s) 913 for the chord may be an instruction set for that particular chord, such as an instruction for every sound to be played during that chord and associated start time, duration, pitch, effects, and/or the like for each way file of those sounds (or oscillator). Each Audio Source 801 may be an indicator of a particular single way file (e.g., Audio Sample 512 or oscillator), the start time, duration, and any effects (e.g., for the associated Source Audio Chain 802) for that way file, while bussed processed output 801ac may be indicative of the collection of way files of Audio Sources 801a-801c for their particular Track Audio Chain 803 (e.g., Track Audio Chain 803y). The instrumentation of all Audio Source(s) 801 of a particular Track Audio Chain 803 of a particular chord may be of the same instrumentation (e.g., Instrument Object 509). Track Audio Chain(s) 803 and Master Audio Chain 804 for a particular chord may be defined by subprocess 907 of process 605, while each one of processed Track Audio Chains 803x′, 803y′, 803z′ may be based on the effects of their Track Audio Chain(s) 803 (e.g., effects per instrument), and/or while bussed processed output 803xz may be indicative of the collection of instrumentation that go together for the chord. Therefore, Source Audio Chain(s) 802 may be the effects applied on a sound by sound basis of an instrumentation, while bussed processed output 801ac may be a combination of instrumentation for a track (e.g., all notes of a particular instrument for a track of a chord), Track Audio Chain(s) 803 may be the effects applied on a track basis of an entire chord, and/or Master Audio Chain 804 may be the effects applied to an entire chord. When a chord is to be played back, process 605 may create an Audio Destination 805, a Master Audio Chain 804, and Track Audio Chain(s) 803, while Audio Source(s) 801 and Source Audio Chain(s) 802 may be updated when a song modifier makes updates during playback. Therefore, “audio processing elements” may include audio sources and the sequence of audio process chains through which they pass until they reach an audio destination (e.g., Audio Source(s) 801, Source Audio Chain (s) 802, Track Audio Chain(s) 803, Master Audio Chain 804, Audio Destination 805, Scheduled Audio Source(s) 913 (e.g., Audio Source(s) 801 that have been scheduled to start at a specified time), etc.). “Data Objects” may include the data and variables that may be input by users, and the temporary data that may be calculated from processing user input data (e.g., Song Objects 501, Song Data 502, Phrase Objects 503, Phrase Data 504 (e.g., data 504a-504w), Style Objects 505, Style Data 506, Track Objects 507, Track Data 508 (e.g., data 508a-508vv), Instrument Object 509, Instrument Data 510 (e.g., data 510a-510d), Sample Set(s) 511, Audio Samples 512, Chord Duration Data 906, Track Update Data 909, Harmony Data 910 (e.g., data 910a-910c), Note Event(s) Data 911 (e.g., data 911aa-911jj), etc.). “Time Units” may include the duration of time that specified Data Objects may yield when played (e.g., Song 601 time unit, Section 602 time units, Phrase 603 time units, Chord 604 time units, etc.).

### FIG. 9—Calculate Chord Audio 605

For each Chord 604 (e.g., chord object 504fi) of a Chord Progression 504f in a Phrase 603, any suitable process(es) of Calculate Chord Audio 605 may be run, which may calculate everything that may be played within the duration of that Chord 604. FIG. 9 shows an exemplary flow of subprocesses that may be run by Calculate Chord Audio 605.

When a song is loaded and chosen for playback (e.g., at subprocess 601a of FIG. 6) on the MMSP as accessed by and presented to a user, the MMSP may be configured to automatically run the process(es) of Calculate Chord Audio 605 of FIG. 9 while the MMSP may also be configured concurrently or simultaneously to accept user modification (e.g., at subprocess 605a) for updating any suitable song object data (e.g., Phrase Data 504). FIG. 9 may illustrate a process from content play to scheduled samples (e.g., including their audio processes), FIG. 8 may illustrate a signal flow of content from samples to speakers, and FIG. 6 may illustrate time of content. When run, Calculate Chord Audio 605 may automatically initiate a subprocess Calculate Chord Duration 901, which may calculate the duration of a Chord 604 using data from Song Object 501 resulting in Chord Duration Data 906. Chord Duration Data 906 may have any suitable numerical value representing the absolute duration in seconds of the given Chord 604, which may be used in various subprocesses within subprocess 908 and subprocess 912. Subprocess 901 may be processed for every chord of Song Object 501 in series (e.g., as illustrated in FIG. 6), such that process 605 may be initiated once and then iterated over each chord of the song in series while process 605 is being run (e.g., during play back of process 601a). For example, when a user starts process 605 (e.g., presses play for a particular song or other suitable content (e.g., style implemented in a musical context)), process 605 may be initiated at subprocess 901 for a first chord (e.g., the first chord of the song or the next chord if the content is being started from the middle of the song) and iterated over the following chords as long as the process is being run. For real-time playback, a delay subprocess 905 of process 605 may be configured to have process 605 wait until the relevant particular chord is to be played back to enable seamless real-time playback for the user. For offline rendering, the delay may be 0 or as soon as the device can run it. Each of the processes that follow subprocess 901 of process 605 may also repeat for every chord of the song during its playback (e.g., during playback or creation, process 605 may repeat for all chords of the content until the process is terminated). This may be further described with respect to FIGS. 10-12. A subprocess Final Chord 902 may determine if the Chord 604 is the Final Chord 902 of Song Object 501. If subprocess 902 determines it is not the final Chord 604 of Song 601, this process may initiate a subprocess Determine Next Chord 904, which may determine the next Chord 604 of Song 601, after which it may initiate a delay subprocess Delay 905 for the duration of the Chord 604 before initiating again subprocess Calculate Chord Duration 901 with the next Chord 604 of Song 601, regardless of whether the next Chord 604 is in the same Phrase 603 as the previous Chord 604 or a next Phrase 603 of the song, regardless of whether the next Chord 604 is in the same Section 602 as the previous Chord 604 or a next Section 602 of the song (e.g., after the final Chord 604 in a Phrase 603, it may cycle to the first Chord 604 of the next Phrase 603 in sequence). If subprocess 902 determines it is the final Chord 604 of Song 601, this process may, at subprocess 903, stop cycling to the next (non-existent) Chord 604.

After completing each iteration of subprocess Calculate Chord Duration 901, a subprocess Update Master and Track Audio Chain 907 may initiate. This subprocess 907 may use data from Style Data 506 and/or Track Data 508 within Song Object 501 and may create or update Master Audio Chain 804 and an independent Track Audio Chain 803 corresponding with each Track Object 507. Track Audio Chain 803 may include, but is not limited to, audio processes for reverb, filters, EQ, panning, and/or the like. Each Track Audio Chain 803 may pass into a single Master Audio Chain 804 with audio processes that may include, but are not limited to, gain, compression, limiting, and/or the like. The parameters for these audio processes may be updated within this subprocess 907. Each Track Audio Chain 803 may be updated using Track Data 508. For example, Track Reverb 508gg data may be used to update the amount of gain given to the wet and dry audio paths from that track, Track Filters 508jj data may be used to update the filter properties of the track, such as the high pass filter frequency, and/or the like. This subprocess may create or update the Master Audio Chain 804 using Style Data 506 and Phrase Data 504. For example, Style Data 506 may include data for pre-compression gain, multi-band compression, post compression gain, and final limiter, which may be used to update the gain, compressors, and/or limiters of Master Audio Chain 804.

After completing subprocess 907, a subprocess Calculate Composition Data 908 may initiate. Subprocess 908 may use Phrase Data 504 and Track Data 508 from Song Object 501 and Chord Duration Data 906. Subprocess 908 may be run for each individual chord and its own chord duration data 906 (e.g., as it becomes available by a particular iteration of subprocess 901). Subprocess 908 may contain subprocess(es) that may calculate elements of composition including, but not limited to, time, pitch, harmony, melody, rhythm, and/or the like (e.g., as may be described with respect to FIG. 13). Subprocess 908 may return Track Update Data 909, which may be temporarily stored and used in a later iteration of subprocess 908 (e.g., for the next chord to be processed by the next iteration of process 605 of FIG. 9 and its iteration of subprocess 908). Subprocess 908 may return Harmony Data 910 for the current Chord 604, a list of one or more note events with Note Event(s) Data 911 associated with each Track Object 507, Song Object 501, and Chord Duration Data 906 for the current Chord 604.

Each note event of Note Event(s) Data 911 returned by subprocess 908 may be individually processed by a subprocess Calculate Audio Data 912. Subprocess 912 may use Song Object 501, Chord Duration Data 906, and Harmony Data 910 and Note Event(s) Data 911 returned from subprocess 908. Subprocess 912 may contain subprocesses that may calculate elements of audio mixing including, but not limited to, reverb, panning, gain, filters, delays and/or the like (e.g., as may be described with respect to FIG. 66). Subprocess 912 may run for each Note Event(s) Data 911 received from subprocess 908. It may create one or more Audio Sources 801 and one or more corresponding Source Audio Chains 802. It may connect Audio Sources 801 to Source Audio Chains 802 and may connect Source Audio Chains 802 to Track Audio Chains 803 (e.g., the Track Audio Chains 803 created earlier at subprocess 907). For example, Master Audio Chain 804 may be created first, followed by Track Audio Chain(s) 803, then Audio Source(s) 801 and Source Audio Chain(s) 802 may be connected to the pre-existing Track Audio Chain(s) 803. It may schedule Audio Sources 801 to be played. As shown, subprocess 912 may result in one or more Scheduled Audio Source(s) 913. Such Scheduled Audio Source(s) 913 may be connected through an Audio Processing Graph to an Audio Destination (see, e.g., graph 800 of FIG. 8 with Audio Sources 801 and Audio Destination 805).

It is understood that the operations (e.g., subprocesses) shown in process 605 of FIG. 9 are only illustrative and that existing operations may be modified or omitted, additional operations may be added, and the order of certain operations may be altered.

### FIG. 9A—Harmony Data 910

As shown in FIG. 9A, Harmony Data 910 may include any suitable type(s) of harmony data object(s), including, but not limited to, Quality 910a, Scale 910b, and Triad 910c. Quality 910a values may include, but are not limited to, “major”, “minor”, and “suspended fourth”. Scale 910b may have an array of seven numerical values that represent the pitches of the scale represented within the lowest octave of MIDI numbers (e.g., The C Major scale would yield [0,2,4,5,7,9,11]). Triad 910c may have an array of three numerical values that represent the pitches of the triad represented within the lowest octave of MIDI numbers (e.g., The C Major triad would yield [0,4,7]).

### FIG. 9B—Note Event(s) Data 911

As shown in FIG. 9B, Note Event(s) Data 911 may include any suitable type(s) of note event(s) data object(s), including, but not limited to, Gain 911aa, Start Time 911bb, Pitch 911cc, Duration 911dd, Envelope 911ee, Swell Automation Nodes 911ff, Loop Start Time Offset 911gg, Filter Frequency 911hh, Delay 911ii, and Round Robin Index 911jj. Gain 911aa may have any suitable numerical value representing the Gain of the Note Event 911 (e.g., 0-10.0). Start Time 911bb may have any suitable numerical value representing the start time of the Note Event 911 (e.g., 0-1000.0). Pitch 911cc may have any suitable numerical value representing the pitch of the Note Event 911 (e.g., 0-127). Duration 911dd may have any suitable numerical value representing the duration of the Note Event 911 in seconds (e.g., 0-20.0). Envelope 911ee may have a set of numerical values representing absolute duration in seconds for each point in an envelope (e.g., {attack:0, sustain:2.342, delay:2.342, release:0.857}). Swell Automation Nodes 911ff may have an array of node data including numerical values for the time and multiplier of each node (e.g., [{time:32.33, multiplier:0},{time:38.82, multiplier:1}]). Loop Start Time Offset 911gg may have any suitable numerical value representing the offset time from the original Start Time 911bb of a note that is looping (e.g., 0-1000.0). Filter Frequency 911hh may have any suitable numerical value representing the Filter Frequency of the Note Event 911 (e.g., 0-10.0). Delay 911ii may have any suitable numerical value representing the number of times a Note Event 911 has been delayed (e.g., 0-64). Round Robin Index 911jj may have any suitable numerical value representing the index of the given array of round robin notes (e.g., 0-36).

### FIGS. 10-12—Calculate Chord Duration 901

Process(es) of Calculate Chord Duration 901 may calculate the duration of a Chord 604 using Phrase Data 504, such as Tempo 504a, Harmonic Rhythm 504c, and Harmonic Speed 504b. Such data may be modified by a user through a GUI, such as through controls 11806 of GUI screen 11800 of FIG. 118. Tempo 504a may be input as beats per minute and may be translated into milliseconds per measure (4 beats).

Harmonic Rhythm 504c may determine the distribution of time between every grouping of two Chords 604. The musical notation shown in FIG. 10 illustrates the distribution of time between chord 1 and chord 2 in various Harmonic Rhythm 504c possibilities 1000, including an Even distribution 1001, Uneven 1002, Anticipated Quarter note 1003, and Anticipated Eighth note 1004. Harmonic Rhythm 504c possibilities include, but are not limited to, those shown in FIG. 10.

Harmonic Speed 504b may determine the number of beats per Chord 604. The musical notation shown in FIG. 11 represents several potential Harmonic Speed 504b possibilities 1100 using the Uneven 1002 Harmonic Rhythm 504c example shown in FIG. 10. A Fast 1101 Harmonic Speed 504b plays two Chords 604 in one 4/4 measure, or in four beats, a Normal 1102 Harmonic Speed 504b plays two Chords 604 in eight beats, while a Slow 1103 Harmonic Speed 504b plays two Chords 604 in sixteen beats. Potential Harmonic Speed 504b possibilities include, but are not limited to, those exemplified in FIG. 11.

FIG. 12 shows a notated representation 1200 of the duration of four Chords 604 with the following parameters or data of a Phrase Object 503: Tempo 504a: 90, Harmonic Rhythm 504c: Uneven (e.g., as shown in 1002 of FIG. 10), Harmonic Speed 504b: Fast (e.g., as shown in 1101 of FIG. 11). After calculating the number of beats per Chord 604 and the duration of a beat in milliseconds, the Chord Duration Data 906 (e.g., the number of beats per the chord and the duration of a beat, and/or the product of the number of beats per the chord and the duration of a beat) and the Song Object 501 may be passed to process Update Master and Track Audio Chain 907, and then to process Calculate Composition Data 908, and then to process Calculate Audio Data 912.

### FIG. 13—Calculate Composition Data 908

After completing process Update Master and Track Audio Chain 907, process Calculate Composition Data 908 may initiate. Process 908 may use Phrase Data 504 and Track Data 508 data from the Song Object 501 as well as Chord Duration Data 906. Process 908 may contain a series of subprocesses that may calculate elements of composition including, but not limited to, time, pitch, harmony, melody, rhythm, and/or the like. Process 908 may return Track Update Data 909, which may be stored and used in a later iteration of process 908 (e.g., for the next chord to be processed by the next iteration of process 605 of FIG. 9 and its iteration of subprocess 908). Process 908 may return Harmony Data 910 for the current Chord 604 and a list of one or more Note Event(s) 911 associated with each Track Object 507 of the style of the phrase containing the chord. Process 908 is run for each track (Track Object 507) of the style of the phrase containing the relevant chord (e.g., in series or in parallel). Each Note Event 911 returned may be individually passed to process Calculate Audio Data 912. FIG. 13 shows a series of subprocesses that may run within process Calculate Composition Data 908.

A subprocess Is Track Percussion Track Type 1300 of subprocess 908 may receive data 501 and 906 as input and may determine the Track Type 508b for each track (Track Object 507) of the style of the phrase containing the relevant chord (e.g., in series or in parallel) and initiate the appropriate subprocess for that Track Type 508b. Subprocess 908 may advance from subprocess 1300 to subprocess 1303 if the track type is determined to be a Percussion track type (e.g., “drums”). Alternatively, subprocess 908 may advance from subprocess 1300 to subprocess 1301 if the track type is determined not to be a Percussion track type. Modify Progression 1301 may receive data 501 and 906 as input and may make modifications to Chord Progression 504f based on Scale Quality 504d. This may result in a processed Phrase Object 503a and may return data 501, 503a, and 906.

Subprocess Calculate Harmony 1302 may receive data 501, 503a, and 906 as input, and may calculate Harmony Data 910 for the current Chord 604 and for the upcoming Chord 604 based on Chord Progression 504f and Scale Quality 504d. This may result in processed Harmony Data 910 and may return data 501, 503a, 906, and 910.

Subprocess Create Percussion Rhythms 1303 may receive data 501 and 906 as input and may determine the timing and gain for each note of each Track Object 507 of Track Type 508b “drums” based on Drum Rhythm Data 504n and Drum Set 504q. This may return a list of one or more Note Events 911 associated with each Track Object 507 of Track Type 508b “drums”.

Subprocesses 1300, Modify Progression 1301, Calculate Harmony 1302, and Create Percussion Rhythms 1303 may run once per each track (Track Object 507) of the style of the phrase containing the relevant Chord 604 (e.g., in series or in parallel). After these subprocesses have run, the following subprocesses of subprocess 1312 may run for processing one, some, or each Track Object 507 that is not Track Type 508b “drums” that is found within the Instrumentation 504s of the current Phrase Object 503. While a subprocess 908 may be run for each chord, within each subprocess 908 a subprocess 1312 may be run for each non-percussion track that is to be played (e.g., each enabled non-percussion track (e.g., per data 504s)) for the current chord (e.g., the chord associated with the current subprocess 908 associated with the current subprocess 1312).

A subprocess Adjust Energy 1304 of subprocess 1312 may receive data 501, 503a, 906, and 910 as input, and may adjust Quantization 508a value based on Energy 504r. Lower Energy 504r values may correlate with lower Quantization 508a values. This may result in processed Track Data 508a and may return data 501, 503a, 508a, 906, and 910.

A subprocess Update Track Data 1305 of subprocess 1312 may receive data 501, 503a, 508a, 906, and 910 as input, and may update Track Data 508 data that will change over the duration of multiple Chords 604. These changes may be set from stateful data within the Track Object 507. This may result in processed Track Update Data 909 and may return data 501, 503a, 508a, 906, 909, and 910.

A subprocess Determine Track Type 1306 of subprocess 1312 may determine the Track Type 508b and initiate the appropriate subprocess for that Track Type 508b. Each Track Type 508b may be processed differently. The Track Type 508b values include, but are not limited to, Percussion (Drums), Melody, Ostinato, and Harmony. Subprocess 1306 may advance to only one of subprocesses 1307-1309 based on its determination (e.g., on a track level).

A subprocess Create Melody 1307 of subprocess 1312 may receive data 501, 503a, 508a, 906, 909, and 910 as input, and may create a melody from the Track Data 508. This may result in a list of one or more Note Event(s) 911 and may return data 909, 910, and 911.

A subprocess Create Ostinato 1308 of subprocess 1312 may receive data 501, 503a, 508a, 906, 909, and 910 as input, and may create an ostinato from the Track Data 508. This may result in a list of one or more Note Event(s) 911 and may return data 909, 910, and 911.

A subprocess Create Harmony 1309 of subprocess 1312 may receive data 501, 503a, 508a, 906, 909, and 910 as input, and may determine the harmony from the Track Data 508. This may create an ordered array of Note Pitch Data 1310 and may return data 501, 503a, 508a, 906, 909, 910, and 1310.

A subprocess Create Rhythm 1311 of subprocess 1312 may receive data 501, 503a, 508a, 906, 909, 910, and 1310 as input, and may determine the rhythmic character of the harmony from the Track Data 508, such as arpeggios, repeated chords, random timing, and/or the like. This may result in a list of one or more Note Event(s) 911 and may return data 909, 910, and 911.

It is understood that the operations (e.g., subprocesses) shown in process 908 of FIG. 13 are only illustrative and that existing operations may be modified or omitted, additional operations may be added, and the order of certain operations may be altered.

### Modify Progression 1301

Subprocess Modify Progression 1301 may make modifications to the Chord Progression 504f based on the Scale Quality 504d. Such data may be modified by a user through a GUI, such as by GUI screen 11800 of FIG. 118, where the “Set Scale” select 11806 may modify the Scale Quality 504d and the Chord Progression controls 11809 may modify the Chord Progression 504f. The Chord Progression 504f may contain a sequence of Chord objects, each Chord object may have a Root and an Inversion. The Chord Progression 504f may be independent of any scale and may therefore be applied to different scale contexts. For example, example 1400 of FIG. 14 shows the Chord Progression 504f data 1401 of a four-chord progression as it applies to the C Major scale 1402 and the C Minor scale 1403.

Within the scope of popular music, the chord progression 1401 may be commonly found in the context of a Minor scale, but may be less common in the context of a Major scale, because of presence of the B diminished chord in the Major scale. In popular music, it is more common for the chord progression to be diatonic to a scale and to include only major and minor chords. It is less common that a diminished chord will be used. Subprocess Modify Progression 1301 may change the Chord Progression 504f when a diminished chord would be used in a Major or Natural Minor scale. Modification(s) of subprocess 1301 may be programmed to be carried out automatically. By handling this automatically, it enables the MMSP to translate chord progressions from major scales to minor scales while sounding natural. The diatonic diminished chord may be replaced with the most harmonically similar chord. Because the most similar chord's root is a major 3rd lower, the inversion may be raised by one to reduce change in the bass note. For example, example 1500 of FIG. 15 shows the Chord Progression 504f data 1501 and a notated example 1502 of how the Chord Progression 504f shown as data 1401 would be modified if it were applied to the Major scale. Compare data 1401 with data 1501 and example 1402 with example 1502. As another example, example 1600 of FIG. 16 shows a four-chord progression that illustrates how the diminished chord in the Natural Minor scale may be modified. The original Chord Progression 504f data 1601 and its notated example 1602 may be compared with the modified Chord Progression 504f data 1603 and its notated example 1604. To produce the more exotic sounds expected in the Harmonic Minor scale, there may be no modifications to the diminished chord in the context of the Harmonic Minor scale. Whether or not there may be modification(s) made by subprocess 1301 may be programmed automatically (e.g., major and minor scales may be modified, and harmonic minor scales may not be modified).

### Calculate Harmony 1302

Subprocess Calculate Harmony 1302 may use Scale Quality 504d and Chord Progression 504f, and the Track Type 508b data. Such data may be modified by a user through a GUI, such as GUI screen 11800 of FIG. 118, where the “Set Scale” select 11806 may modify the Scale Quality 504d, the “Set Key” 11806 select may modify the Scale Root 504e, and the Chord Progression controls 11809 may modify the Chord Progression 504f, and as shown by GUI screen 11900 of FIG. 119, where the “Set Harmony Type” select may modify the Harmony Type 508c. Subprocess Calculate Harmony 1302 may calculate the Harmony Data 910 that will be used for all Track Objects 507 that are not Track Type 508b “drums” within the current Chord 604. Such calculation of subprocess 1302 may be made automatically based on user modifications accessible in Style Production 304, Song Production 303, and/or Consumer Modification 302. This may give as much specific harmonic control as possible to the Style Production 304 users, while still enabling Song Producers and/or Song Consumers to translate those harmonies to different contexts. The Style Producer may choose harmonies based on relationships and patterns rather than specific notes. This calculation of subprocess 1302 may be specific to harmony, but it is a representative microcosm of the whole MMSP in that it may parse the principles of harmony in such a way that users may control a dimension of the harmonic makeup (e.g., the harmonic “DNA”). A style producer may create the foundational harmonic patterns and relationships as building blocks, and higher-level users may alter the contexts in which they manifest. Such calculation in conjunction with data structure 500 may be a unique offering. The Harmony Type 508c may determine the harmonic options for each Track Object 507 based on the context of the Scale Quality 504d, Scale Root 504e, and current Chord. Some of the Harmony Type 508c value options may be based on common musical terms, others may be designations for harmonic behavior that is uniquely defined by the MMSP (e.g., as “Hinge Tone”, “Quartatonic”, and/or “Tritonic”, as described herein).

Harmony Types 508c may include, but are not limited to, the following. Harmony Type 508c Mode Tonic may be the tonic of the mode based on the first chord in the progression (e.g., in the key of C major a progression starting with the four-chord would have a Mode Tonic of F). Harmony Type 508c Scale Root may be the root of the scale (e.g., in C Major it would be C, and in C Minor it would be C). Harmony Type 508c Scale Root+Fifth may be similar to Scale Root but adding the fifth above (e.g., in D Minor it would be D and A). Harmony Type 508c Chord Root may be the root of the current chord (e.g., for a G chord in C Major it would be G). Harmony Type 508c Chord Root+Fifth may be similar to Chord Root but adding the fifth above (e.g., for a G chord in C Major it would be G and D). Harmony Type 508c Triad may be the root, third, and fifth of the current chord (e.g., for an F chord in C Minor it would be F, Ab, and C). Harmony Type 508c Chromatic may be all twelve chromatic notes. Harmony Type 508c Chord Mode may be all seven notes of the scale starting at the root of the current chord. Harmony Type 508c Bass Note may be the lowest note of the triad depending on its inversion (e.g., in the key of C Major with an F Chord in 1st inversion it would be an A). Harmony Type 508c Hinge Tone may be the note above the Bass Note in the Triad (e.g., in the key of C Major with an F Chord in 1st inversion it would be a C). The Harmony Type 508c Diatonic may have all seven notes of the diatonic scale depending on the Scale Quality 504d. For example, example 1700 of FIG. 17 shows notation of harmony options in the different scale contexts of C Major 1701, Natural Minor 1702, and Harmonic Minor 1703 with a Diatonic Harmony Type 508c. In the Harmonic Minor scale context, the 7th scale degree may be the leading tone when the current Chord is a 5 (e.g., the dominant chord), otherwise the 7th scale degree may be a flatted 7th similar to Natural Minor. The Harmony Type 508c Pentatonic may be a custom five note scale depending on the Scale Quality 504d. For example, example 1800 of FIG. 18 shows notation of harmony options in the different scale contexts of C Major 1801, Natural Minor 1802, and Harmonic Minor 1803 with a Pentatonic Harmony Type 508c. In the Harmonic Minor scale context, the 7th scale degree may be the leading tone when the current Chord is a 5 (e.g., the dominant chord), otherwise the 7th scale degree may be a flatted 7th similar to Natural Minor. The Harmony Type 508c Quartatonic may be a custom four note scale depending on the Scale Quality 504d. For example, example 1900 of FIG. 19 shows notation of harmony options in the different scale contexts of C Major 1901, Natural Minor 1902, and Harmonic Minor 1903 with a Quartatonic Harmony Type 508c. The Harmony Type 508c Tritonic may be a custom three note scale depending on the Scale Quality 504d. For example, example 2000 of FIG. 20 shows notation of harmony options in the different scale contexts of C Major 2001, Natural Minor 2002, and Harmonic Minor 2002 with a Tritonic Harmony Type 508c. The Harmony Type 508c Chord Scale may have a custom scale depending on the current Chord data and the Scale Quality 504d. For example, example 2100 of FIG. 21 shows notation of what each of the 7 Chord Scales may be in the different scale contexts of C Major 2101 and Natural Minor 2102. In the Harmonic Minor scale context, the 7th scale degree may be the leading tone when the current Chord is a 5 (e.g., the dominant chord), otherwise the 7th scale degree may be a flatted 7th similar to Natural Minor.

In addition to the aforementioned Harmony Types 508c, a Track Object 507 may have a Custom Harmony Type 508c that may include a customized combination of notes in relation to the Chord data, the Scale Root 504e, and/or any of the other Harmony Types 508c. A GUI screen or any other suitable presentation may be presented (e.g., in the Track Controls of a Style Production panel in GUI screen 11900 to enable a user to select chord tones, scale degrees, and/or Harmony Types 508c (not shown in FIG. 119). For example, example 2200 of FIG. 22 shows notation of the available notes in a custom selection of Chord Notes (1 and 3) 2201, it also shows notation of the available notes in a custom selection of Scale Notes (1 and 5) 2202 in the context of the C Major Scale with a Chord Progression 504f of roots [1, 5, 6, 4], and it also shows notation of the Custom Harmony 2203 for each chord when the available notes from each custom selection are combined.

Subprocess Calculate Harmony 1302 may also calculate Low Harmony data for each Chord. When dense chords are played in the lower range, it may sound harmonically messy and confusing. When the notes of a chord are distributed throughout the lower range, modeling the natural harmonic series, it may give a stronger sense of balance and harmonic clarity. For this reason, subprocess Calculate Harmony 1302 may determine an optimal Low Harmony distribution of notes based on the current Chord Quality (e.g., major, minor, diminished, etc.) and Inversion (0, 1, 2). For example, FIG. 23 shows a grid 2300 of three rows and three columns, each cell illustrating in musical notation what may be the Low Harmony distribution for each combination of Chord Quality and Inversion through the octave range, where row 1 is a major Chord Quality, row 2 is a minor Chord Quality, row 3 is a diminished Chord Quality, and where column 1 is not inverted, column 2 is in first inversion, and column 3 is in second inversion. Subprocess Calculate Harmony 1302 may return the Low Harmony data for the current chord. The MMSP may be configured to calculate Low Harmony data at subprocess 1302 automatically (e.g., through code, regardless of any other user input).

### Create Percussion Rhythms 1303

Subprocess Create Percussion Rhythms 1303 may use Drum Rhythm Data 504n, Drum Set 504q, Harmonic Speed 504b, Drum Rhythm Speed 504o, and Drum Extension 504p. Such data may be modified by a user through a GUI, such as GUI screen 11800 of FIG. 118, where the “Set Chord Speed” select 11806 may modify the Harmonic Speed 504b, the “Set Drum Speed” select 11807 may modify the Drum Rhythm Speed 504o, the “extend” button 11807 may modify the Drum Extension 504p, the rhythm grid 11807 on the bottom may modify the Drum Rhythm Data 504n, and edit icons for “Hi-hat”, “Snare”, “Tom”, and “Kick” 11807 may modify the Drum Set 504q. The Drum Rhythm Data 504n may contain the relative timing and gain for each note. The Drum Set 504q may contain references to the drum Audio Samples 512 selected by the user. Subprocess Create Percussion Rhythms 1303 may use this data to calculate the absolute timing and gain for each drum note. A subtle amount of randomization may be applied to the Gain of each Note to add realism to the sound. The notes for each Track Object 507 that is not Track Type 508b “drums” may be calculated for each Chord 604. Harmonic Rhythm 504c may determine the distribution of time between every grouping of two chords. While it is common in popular music to change chords at times other than the downbeat of a new measure, it is uncommon for the drum rhythm to repeat in an uneven manner, thus causing the song to sound disjointed. To keep the rhythm constant throughout uneven Harmonic Rhythms 504c, process Create Percussion Rhythms 1303 may create a rhythm that spans the duration of multiple measures at a time. For example, example 2400 of FIG. 24 illustrates the relationship of time between a 16 beat pattern 2402, two Chords 2401 with a Harmonic Rhythm 504c value of ‘Anticipated Quarter’ (e.g., as described herein with respect to Calculate Chord Duration 901 and FIG. 10), and two measures 2403. Similar to how the Harmonic Speed 504b may be changed, the Drum Rhythm Speed 504o may also be changed independently. The number of beats in a pattern may also be modified by the Drum Extension 504p (e.g., extended from a 16 beat pattern to a 32 beat pattern). Given the variability of these data, process Create Percussion Rhythms 1303 may calculate whether the Rhythm will extend across two or more measures, and whether the Rhythm must be repeated. For example, FIG. 25 shows a table 2500 that illustrates how variations in such data may change how the drum pattern extends or repeats across the Chords 604. All examples use a Harmonic Rhythm 504c value of ‘Anticipated Quarter’ (e.g., as described herein with respect to Calculate Chord Duration 901 and FIG. 10). The drum pattern extensions in the top row of the table 2501 may exist when the Drum Rhythm Speed 504o value is “fast”. The drum pattern extensions in the bottom row of the table 2502 may exist when the Drum Rhythm Speed 504o value is “slow”. The drum pattern extensions in the left column of the table 2503 may exist when the Drum Extension 504p value is “16”. The drum pattern extensions in the left column of the table 2504 may exist when the Drum Extension 504p value is “32”. The top pattern extensions within each of the four cells of the table (e.g., 2505) may exist when the Harmonic Speed 504b value is “Slow”. The middle pattern extensions within each of the four cells of the table (e.g. 2506) may exist when the Harmonic Speed 504b value is “Normal”. The bottom pattern extensions within each of the four cells of the table (e.g. 2507) may exist when the Harmonic Speed 504b value is “Fast”.

### Adjust Energy 1304

The Quantization 508a may determine the rhythmic division of the notes that will be played for that track. For example, a Quantization 508a value of 1 would mean that the track only plays notes on the whole note beats. A value of 8 would only play notes on the eighth note beats. The Quantization 508a may determine the Start Time 911bb and may not determine the Note Duration 911cc. The Quantization 508a may not determine rhythmic patterns, rather it may determine the minimum time unit in which a rhythm can be applied. Rhythm creation may be determined in subprocesses Create Melody 1307, Create Ostinato 1308, and Create Rhythm 1311. For example, example 2600 of FIG. 26 shows notation of potential rhythms with different Quantization 508a values. The notation 2601 for a Quantization 508a value of 1 may contain whole notes. The notation 2602 for a Quantization 508a value of 4 may contain whole notes, half notes, and quarter notes. The notation 2603 for a Quantization 508a value of 8 may contain whole notes, half notes, quarter notes, and eighth notes. A Style Object 505 may have multiple Track Objects 507 that may have different Quantization 508a values. Higher values may evoke a greater sense of energy because they may play faster rhythms and more notes. The Energy 504r may enable adjustments of the Quantization 508a values of all Track Objects 507 within that Phrase 603. This data may be modified by a user through a GUI, such as GUI screen 11800 of FIG. 118, where the “Energy” slider may modify the Energy 504r. This may be done by reducing each Quantization 508a value from its original value. For example, FIG. 27 shows a table 2700 that illustrates how the Energy 504r value 2701 in column 1 may modify each Quantization 508a value 2702 in columns 2 through 5, where the initial Quantization 508a value may correspond with the highest potential Energy 504r value. Process Adjust Energy 1304 may use the Energy 504r value to adjust each Quantization 508a value.

### Update Track Data 1305

Each Track Object 507 may have stateful data that may change over time. Such data includes, but is not limited to, Flux Parameter data 508i-508k and Ostinato data 508m-508o. Process Update Track Data 1305 may calculate and set these data changes (e.g., as Track Update Data 909).

Track Object 507 data may contain data objects whose values may change in a continuous flux. These may include, but are not limited to, Track Gain 508d, Quantization 508a, Harmony Range 508f, Track Pitch 508e, and Note Count 508g. The Track Gain 508d value may determine the gain, loudness, or volume of the Track Audio Chain 803. Quantization 508a is explained in process Adjust Energy 1304. The Harmony Range 508f may determine the range of notes that are available to play. The Track Pitch 508e data may determine the pitch that is at the center of the Harmony Range 508f. For example, if the Harmony Range 508f value is 13 and the Track Pitch 508e value is 66, then the available notes may be the 13 notes from 60 to 72, where 60 corresponds with the pitch of middle C. The notation and pitch numbers of this example are shown by example 2800 of FIG. 28. As another example, if the Harmony Range 508f value was 1 and the Track Pitch 508e value was 72, then the available notes would be the 1 note from 72 to 72. The notation and pitch numbers of this example are shown in example 2900 of FIG. 29. The Note Count 508g data may determine the number of notes that may be played. Objects whose values may change in a continuous flux may have Flux Parameter data that may determine how their values change over time. The Flux Parameter data may include Flux Range 508i, Flux Shape 508j, Flux Duration 508l, and Flux Phase 508k. This data may be modified by a user through a GUI, such as shown in the highlighted area of GUI screen 11900 of FIG. 119, and in GUI screen 12100 of FIG. 121 where the range sliders on the left may modify Flux Range 508i data, the “Set Shape” selects may modify Flux Shape 508j data, the “Ø” sliders may modify Flux Phase 508k data, and the “Length” and “Multiplier” sliders may modify Flux Duration 508l data. The Flux Range 508i data may set the minimum and maximum limits of the value changes. For example, a Track Object 507 with a Flux Range 508i from 0.5 to 1 that is applied to the Track Gain 508d may always have a Track Gain 508d value within that range. The Flux Shape 508j data may set the direction and pattern of the value changes over time. For example, example 3000 of FIG. 30 shows illustrations of several Flux Shape 508j options using a Flux Range 508i of 0.5 to 1 applied to the Track Gain 508d. The Flux Duration 508l data may set the duration of time in which the Flux Shape 508j cycle will repeat. The duration may be measured by units of Chords 604 and may have no limit. For example, a Track Gain 508d value could gradually change from 0.5 to 1 for the duration of an entire song. The Flux Phase 508k may offset the Flux Shape 508j cycle. For example, example 3000 of FIG. 30 illustrates various Flux Shape 508j options with a Flux Phase 508k value of 0. As another example, example 3100 of FIG. 31 shows the same Flux Shape 508j options compared with example 3000 of FIG. 30, however these are offset with a Flux Phase 508k value of 50 percent. Compare patterns 3101 with 3001, 3102 with 3002, 3103 with 3003, 3104 with 3004, 3105 with 3005. The capacity for each of these values to change over longer periods of time may enable a Style Producer to craft tracks with more subtlety and nuance, which may increase its musicality and avoid being too repetitious. Process Update Track Data 1305 may use Track Flux Parameter data to calculate changing values for Track Object 507 data.

### Determine Track Type 1306

Subprocess Determine Track Type 1306 may determine a Track Object's Track Type 508b value. This value may be modified by a user through a GUI, such as shown in the “Set Track Type” select of GUI screen 11900 of FIG. 119. When the Track Type 508b value is “Ostinato”, subprocess Update Track Data 1305 may calculate changing Track Object's Ostinato data 508m-508o. While the notes for each chord may be calculated for each Chord 604, the nature of an ostinato may require that there be repetition through rhythmic and melodic consistency from Chord 604 to Chord 604. When a Track Type 508b value is “Ostinato”, subprocess Update Track Data 1305 may create a Track Object's Ostinato data 508m-508o that provides the rhythmic and melodic structure from which the notes of the ostinato may be calculated. The Ostinato data 508m-508o may enable rhythmic and melodic characteristics of the ostinato to be consistent from Chord 604 to Chord 604. This data may include Ostinato Rhythms 508o, Ostinato Directions 508n, and Ostinato Leaps 508m. Ostinato Rhythms 508o may be an array of randomly selected values that represent the duration of each note based on the Quantization 508a value. For example, example 3200 of FIG. 32 shows the notation 3202 of a given set of Ostinato Rhythms 508o data 3201 using a Quantization 508a value of 8. Ostinato Directions 508n may be an array of randomly selected values (either ‘up’ or ‘down’) that may determine the direction of the interval between the current note and the previous note within the Chord 604. For example, example 3300 of FIG. 33 shows the notation of a given set of Ostinato Directions 508n data 3301 using the same Ostinato Rhythms 508o data 3201 as it may be applied in the context of a C Major Scale with a Chord Progression 504f of roots [1, 5] and a Harmony Type 508c value of Triad. Ostinato Leaps 508m may be an array of randomly selected values that may determine whether the next note will be the nearest available pitch within the Harmony Type 508c constraints, or if it will leap to the nearest pitch beyond that. For example, example 3400 of FIG. 34 shows the notation 3402 of a given set of Ostinato Leaps 508m data 3401 using the same Ostinato Rhythms 508o data 3201 and Ostinato Directions 508n data 3301 in the previous example. Subprocess Update Track Data 1305 may create the Track Ostinato data for Rhythms 508o, Directions 508n, and Leaps 508m. That data may be used in subprocess Create Ostinato 1308, where the notes may be calculated based on the Harmony Type 508c. In order to control the degree of variety in the Track Object's Ostinato data 508m-508o, the Ostinato Duration 508p data and corresponding controls may enable a Style Producer to set the frequency of the Track Object's Ostinato data 508m-508o updates. The Ostinato Duration 508p may be measured in time units of Phrases 603. The ostinato may change patterns up to once per Phrase 603.

### Create Melody 1307

Subprocess Determine Track Type 1306 may determine the Track Object's Track Type 508b value. This value may be modified by a user through a GUI, such as shown in the “Set Track Type” select of GUI screen 11900 of FIG. 119. When a Track Type 508b value is “Melody”, subprocess “Create Melody” 1307 may run.

If the Harmony Range 508f is greater than an octave, then the Harmony Range 508f may become the range for the melody, otherwise the melody range may be an octave.

A Start Note may be calculated for the current Chord 604, and a Destination Note may be calculated for the following Chord 604. Both of these may be randomly selected among the three notes of the Triad, which random selection may be weighted with the greatest weight on the Hinge Tone (e.g., the note above the bass note), and the least weight on the note that is neither the Hinge Tone nor the Bass Note. The direction from the Start Note to the Destination Note may also be randomly selected, either ‘up’ or ‘down’. The Start Note of a melody may play on the downbeat of a chord and the Destination Note may play on the downbeat of the following chord. After each iteration of subprocess 1307, the Destination Note of the previous Chord 604 may become the Start Note of the current Chord 604. For example, example 3500 of FIG. 35 shows potential Start Notes and Destination Notes for two Chords using the C Major Scale and the Chord Progression 504f of roots [1, 5, 6] (3501, 3502, and 3503 respectively). The rest of subprocess 1307 may determine how to move from the Start Note to the Destination Note in a melodic way using the context of the current Chord, and the Scale Degree of the notes.

Beginning with the Start Note, a sequence of notes may be calculated that melodically lead into the Destination Note. This sequence may be calculated 1 note at a time. Note Motion options may be calculated for each note based on the scale degree of the note and the context of the Chord. Subprocess 1307 may use Note Motion options that may be more likely to sound good when preceded by a specified scale degree. For example, example 3600 of FIG. 36 shows a chart 3601 that lists the diatonic distance (positive for up and negative for down) that may sound best for a melody line moving from each scale degree, the chart is also illustrated as notation for in the context of C major 3602 and C minor 3603. This demonstrates an example of the Note Motion options for each scale degree 1 through 7. In addition to the Note Motion data shown in FIG. 36, a Style Producer may set custom Note Motion data. For explanation purposes, the following examples of Note Motion may all use the Note Motion data shown in FIG. 36. As an example of calculating each note based on the scale degree of the previous note, example 3700 of FIG. 37 shows a four-note sequence. After determining potential Note Motion options from the Start Note, subprocess 1307 process may then make adjustments based on the current Chord. Note Motion options within a minor 3rd may always be permitted regardless of the Chord context. Note Motion options that would be greater than a minor 3rd may only be permitted if the note is also in the Chord. This is illustrated in example 3800 of FIG. 38 using the 3rd scale degree in the C Major Scale. For example, example 3900 of FIG. 39 shows the adjusted Note Motion options for the 3rd scale degree based on the context of three different chords in the C Major Scale. As another example, example 4000 of FIG. 40 shows Note Motion options for the 7th scale degree. Note Motion options may be further adjusted by adding in notes of the Chord that are within a minor 3rd. For example, example 4100 of FIG. 41 shows the Note Motion options for the 7th scale degree in the context of two different chords in the C Major Scale.

After the Note Motion options have been calculated and adjusted, one of those notes may be selected as the next note in the sequence. The selection may be done by sorting the Note Motion options in order of those that are closest to the Destination Note, then randomly selecting one among several of the closest options. After this note has been added to the sequence, the process may repeat with a new set of Note Motion options based on the scale degree of the next note. This cycle may continue until the Destination Note is selected from among the Note Motion options. For example, example 4200 of FIG. 42 shows a sequence of notes each followed by the Note Motion options adjusted based on the Chord. Example 4300 of FIG. 43 shows the same resulting melody sequences without the Note Motion options.

After the note sequence is determined, then one of several predetermined rhythmic patterns may be randomly applied based on the number of notes in the sequence. For example, example 4400 of FIG. 44 shows the same sequence with a rhythm applied. This note sequence along with its rhythmic data may be converted into a list of Note Events 911, which may be passed into subprocess Calculate Audio Data 912.

### Create Ostinato 1308

A Track Object's Ostinato data 508m-508o may be created in subprocess Update Track Data 1305. This data set may include Ostinato Rhythms 508o data, Ostinato Directions 508n data, and Ostinato Leaps 508m data. For example, FIG. 45 shows a chart of potential Track Ostinato data 4500. Subprocess Create Ostinato 1308 may receive a Track Object's Ostinato data 508m-508o and may calculate a list of Note Events 911 based on the context of the Scale Quality 504d, Scale Root 504e, Chord Progression 504f, and Harmony Type 508c, and Quantization 508a. Such data may be modified by a user through a GUI, such as GUI screen 11800 of FIG. 118, where the “Set Scale” select 11806 may modify the Scale Quality 504d, the “Set Key” select 11806 may modify the Scale Root 504e, and the Chord Progression controls 11809 may modify the Chord Progression 504f, and in GUI screen 11900 of FIG. 119, where the “Set Harmony Type” 11903 select may modify the Harmony Type 508c value and the “Time Div” 11904 slider may modify the Quantization 508a value. For example, example 4600 of FIG. 46 shows a notated example 4602 of how the Track Ostinato data 4500 shown in FIG. 45 would be applied given the specific Phrase Data 504 and Track Data 508 shown in the table 4601. To illustrate how the same Track Object Ostinato data 508m-508o could vary in different contexts, example 4700 of FIG. 47 shows examples of variations of the Phrase Data 504 data and Track Data 508 in table 4601 of FIG. 46 and using the Track Object Ostinato data 508m-508o in table 4500 of FIG. 45. Notation 4702 is a notated illustration of a variation of the Scale Quality 504d value set to C Minor 4701. Notation 4704 is a notated illustration of a variation of the Chord Progression 504f data 4703. Notation 4706 is a notated illustration of a variation of the Harmony Type 508c value 4705. Notation 4708 is a notated illustration of a variation of the Quantization 508a value 4707. The resulting Note Event(s) 911 may then be passed into subprocess Calculate Audio Data 912.

### Create Harmony 1309

Subprocess Create Harmony 1309 may use Scale Quality 504d, Scale Root 504e, and Chord Progression 504f, Track Pitch 508e, Number of Voices 508h, Harmony Data 910, Voicing Type 508q, and Duplicates 508r. Such data may be modified by a user through a GUI, such as GUI screen 11800 of FIG. 118, where the “Set Scale” select 11806 may modify the Scale Quality 504d, the “Set Key” select 11806 may modify the Scale Root 504e, and the Chord Progression controls 11809 may modify the Chord Progression 504f, and GUI screen 12100 of FIG. 121, where the “Pitch” range slider may modify the Track Pitch 508e value, the “Number of Voices” range slider may modify the Number of Voices 508h value, the “Harmony” range slider may modify the Harmony Range 508f, and the “Duplicates” button may modify the Duplicates 508r value, and GUI screen 11900 of FIG. 119, where the “Set Voicing Type” select may modify the Voicing Type 508q. Subprocess Create Harmony 1309 may create an ordered array of Note Pitch Data 1310 that may be used in subprocess Create Rhythm 1311.

The range of notes that may be used for a given harmony may be determined by the Harmony Range 508f value and the Track Pitch 508e value. For example, a Harmony Range 508f value of 12 and a Track Pitch 508e value of 66 would result in a range from 60 to 72. Example 4800 of FIG. 48 illustrates this data 4801 in notation form 4802.

The Chord Progression 504f, Scale Quality 504d, Scale Root 504e, and Harmony Type 508c may determine which notes within that range are available for the harmony. Example 4900 of FIG. 49 uses the data in table 4801 and shows an example of how a set of this data 4901 may result in available notes 4902. Example 5000 of FIG. 50 shows how variations of the Phrase Data 504 and Track Data 508 in 4901 may result in different available notes. Notation 5002 is a notated illustration of a variation of the Phrase Object's 503 Chord data 5001. Notation 5004 is a notated illustration of a variation of the Scale Quality 504d value set to D Major 5003. Notation 5006 is a notated illustration of a variation of the Harmony Type 508c value 5005.

If the Voicing Type 508q value is “full”, then all of the available notes within the range may be added to an ascending ordered array and passed into subprocess Create Rhythm 1311. Given the table of data 5101 shown in example 5100 of FIG. 51, the resulting array may be [60, 64, 67, 72] as notated in notation 5102.

If the Voicing Type 508q value is “random”, then the Number of Voices 508h value may be used to determine the number of notes that will be randomly selected from the available notes. Using the example data 5101 in example 5100 of FIG. 51, it may result in an array of any of these four notes [60, 64, 67, 72]. This may include repeated notes, such as all notes being pitch [60, 60, 60, 60] of notation 5201, all different notes [72, 67, 64, 60] in any order of notation 5202, or any other combination of notation 5203. For example, example 5200 of FIG. 52 shows such notations of three potential combinations. If the result has repeated notes, the Duplicates 508r value may determine whether the repeated notes will stay in the array or be removed, potentially leaving the result as a single note. For example, example 5300 of FIG. 53 shows how the notation examples in FIG. 52 may look if Duplicates 508r value is “false”. Compare notation 5201 with notation 5301, notation 5202 with notation 5302, and notation 5203 with notation 5303.

### Create Rhythm 1311

Subprocess Create Rhythm 1311 may receive an array of Note Pitch Data 1310 from subprocess Create Harmony 1309, and may use the Rhythm Pattern Type 508s, Arpeggio Direction 508t, Arpeggio Double 508u data, Arpeggio Repeat 508v, Arpeggio Hold 508w data, Custom Gains 508x, Quantization 508a, Triplets 508bb, and/or Offbeats 508cc. Such data may be modified by a user through a GUI, such as GUI screen 12200 as shown in FIG. 122, where the “Set Pattern Type” select may modify the Rhythm Pattern Type 508s value, the “Set Arp Direction” select may modify the Arpeggio Direction 508t value, the “Double” button may modify the Arpeggio Double 508u value, the “Repeat” button may modify the Arpeggio Repeat 508v value, the “Hold” button may modify the Arpeggio Hold 508w value, the “Custom Gains” input may modify the Custom Gains 508x data, and in GUI screen 11900 of FIG. 119, where the “Time Div” range slider 11904 may modify the Quantization 508a value, the “Triplets” button 11904 may modify the Triplets 508bb, and the “Offbeats” button 11904 may modify the Offbeats 508cc. Using such data, subprocess Create Rhythm 1311 may create Note Event(s) 911, which may be passed into subprocess Calculate Audio Data 912.

If the Rhythm Pattern Type 508s value is “Arpeggio”, then the array of Note Pitch Data 1310 may be sorted according to the Arpeggio Direction 508t value. Example 5400 of FIG. 54 shows several possible examples of how a Note Pitch Data 1310 array of [64, 67, 60]could be sorted. The Arpeggio Direction 508t value options may include, but are not limited to, those shown in FIG. 54. After the Note Pitch Data 1310 array is sorted according to the Arpeggio Direction 508t, then a list of one or more Note Events 911 may be created based on the Quantization 508a value. For example, example 5500 of FIG. 55 shows the same Note Pitch Data 1310 array as it would result with different Quantization 508a values. If Arpeggio Repeat 508v value is “true”, then the pattern may be repeated for the remainder of the Chord 604. This is illustrated in FIG. 56 with example 5600, as compared with example 5500 of FIG. 55. For example, this may be illustrated by comparing notation 5501 with notation 5601, notation 5502 with notation 5602, and notation 5503 with notation 5603. The list of Note Events 911 may include data for the Pitch 911cc, Start Time 911bb, Duration 911dd, Gain 911aa, and Round Robin Index 911k. A subtle randomization may be applied to the Gain to add realism. All repeated es within a Chord 604 may be given a Round Robin Index 911k beginning with 0 and incrementing by 1. The Round Robin Index 911k data is further described herein with respect to a process Calculate Instrument Sample Source 8503 of FIG. 85. Moreover, for example, example 5700 of FIG. 57 shows the Round Robin Index 911k values for each instance of 60 (e.g., middle C) within that Chord 604. If the Arpeggio Double 508u value is “true”, then each note in the pattern may be doubled as shown in FIG. 58 with example 5800. If Arpeggio Hold 508w value is “true”, then the duration of each note may be extended to the end of Chord 604, as shown by example 5900 in FIG. 59.

If the Rhythm Pattern Type 508s value is “repeat”, then the array of Note Pitch Data 1310 may be played on every beat according to the Quantization 508a value. A subtle randomization may be applied to the Gain to add realism. The Gain of every other beat may be slightly reduced to add a subtle accent to the repeats. Example 6000 of FIG. 60 shows a few examples of the same Note Pitch Data 1310 array as it would result with different Quantization 508a values. All repeated es within a Chord 604 may also be given a Round Robin Index 911k value beginning with 0 and incrementing by 1. The Round Robin Index 911k is further described herein with respect to process Calculate Instrument Sample Source 8503 of FIG. 85.

If the Track Object 507 has Custom Gains 508x data, then it may be applied to the Rhythm Pattern Type 508s value of “arpeggio” and “repeat”. The Custom Gains 508x data may be an array of numbers that may represent modifications to the Gain for each Note Event 911. The array may be any length. If there are more beats than array indices, then the array may repeat. For example, example 6100 of FIG. 61 and example 6200 of FIG. 62 show how differing Custom Gains 508x data would modify the repeats shown in FIG. 60. Compare the following (notation 6001, notation 6101, notation 6201), (notation 6002, notation 6102, notation 6202), and (notation 6003, notation 6103, notation 6203).

If the Rhythm Pattern Type 508s value is “strum”, then the array of Note Pitch Data 1310 may be played on every beat according to the Quantization 508a value. In place of a Custom Gains 508x, a random selection from a list of predefined patterns may be applied to modify the gain of each beat. The random selection of a predefined strum pattern may happen for each Chord 604. These changes may add realism and variety to the strum. A subtle randomization may also be applied to the Gain to add variety. For example, example 6300 of FIG. 63 shows an example of strum data. All repeated es within a Chord 604 may also be given a Round Robin Index 911k value beginning with 0 and incrementing by 1. The Round Robin Index 911k data is further described herein with respect to process Calculate Instrument Sample Source 8503 of FIG. 85.

If a Rhythm Pattern Type 508s value is “random”, then each in the array of Note Pitch Data 1310 may be randomly assigned a Start Time 911bb that syncs to the beat according to the Quantization 508a value. If the Quantization 508a value is 0, then the Start Time 911bb for each note may be randomly assigned a time in milliseconds within the time of the Chord 604. If a Offbeats 508cc value is “true”, then the Start Time 911bb for all of the Note Events 911 may be shifted to the offbeat of the Quantization 508a value. For example, example 6400 of FIG. 64 shows a repeated arpeggio of [60, 64, 67] without the offbeat 6401 compared with an offbeat 6402. If a Triplets 508bb value is “true”, then the Quantization 508a value may be multiplied by three. For example, example 6500 of FIG. 65 shows a repeated arpeggio of [60, 64, 67] without the triplet 6501 compared with a triplet 6502.

If a Rhythm Pattern Type 508s value is “custom”, then data from the Custom Gains 508x, Custom Rhythms 508y, and Custom Pitches 508z may be applied to determine a custom pattern. The Custom Gains 508x data may be an array of numbers that may represent modifications to the Gain for each Note Event 911. The array may be any length. If there are more beats than array indices, then the array may repeat. For example, example 6100 of FIG. 61 and example 6200 of FIG. 62 show how differing Custom Gains 508x data would modify the repeats shown in FIG. 60. Compare the following (notation 6001, notation 6101, notation 6201), (notation 6002, notation 6102, notation 6202), and (notation 6003, notation 6103, notation 6203). The Custom Rhythms 508y data may be an array of numbers that may represent modifications to the Start Time 911bb of each Note Event 911. The values in the Custom Rhythms 508y data may act as multipliers to Quantization 508a value. For example, if the Quantization 508a value is 8, then a value of 1 within the Custom Rhythms 508y data array would represent an eighth note, a value of 2 would represent a quarter note (i.e., twice the duration), and a value of 0.5 would represent a sixteenth note (i.e., half the duration). The array may be any length. If there are more beats than the sum of the array values, then the array may repeat. For example, with a Quantization 508a value of 8, a Custom Rhythms 508y array of [3,2,2] would only account for 7 of the 8 beats in a measure. In this case, it may repeat as [3,2,2,3,2,2]. The rhythm may be cropped to fit the number of beats available in the Chord 604, thereby producing the rhythmic pattern [3,2,2,1] with a Quantization 508a value of 8, and [3,1] with a Quantization 508a value of 4. If the Syncopation 508aa value is true, then the Custom Rhythms 508y may syncopate across multiple Chords 604 without cropping the rhythm within the number of beats available in the Chord 604. For example, a Custom Rhythms 508y array of [3,3,3,3,3,1] accounts for 16 beats. Rather than cropping the rhythm to [3,3,2] for an 8 beat Chord 604, the rhythmic pattern may continue until it has completed all 16 beats of the two Chords 604. The Custom Pitches 508z data may be an array of numbers that represent indices Note Pitch Data 1310 returned from subprocess Create Harmony 1309. For example, if the Note Pitch Data 1310 is [60,62,64,67], then a Custom Pitches 508z array of [2,1,2,3,0] would result in these pitches [64,62,64,67,60]. The array may be any length. If there are more beats than array indices, then the array may repeat. If Custom Pitches 508z values exceed the Note Pitch Data 1310 array length, then the Custom Pitches 508z value may wrap around to stay within the bounds of the Note Pitch Data 1310 by taking the Custom Pitches 508z value modulo the Note Pitch Data 1310 array's length. The ability to modify Custom Gains 508x, Custom Rhythms 508y, and Custom Pitches 508z may enable a Style Producer to have millions of creative options for designing unique and specific musical patterns, retaining their own musical signature when applied to hundreds of different musical contexts of harmony and time that may be modified by a Song Producer or Song Consumer. This part of the MMSP may also fit the analogy of giving a Style User the ability to encode a rhythmic and harmonic pattern as part of the DNA of the song, which higher-level users can manifest in various musical contexts. Data of chart 500a may be user adjustable (e.g., during song creation and/or song modification), while data of chart 500b may be used to make musical choices that may be related to relationships/patterns rather than specific notes (e.g., data of chart 500a may be utilized to determine how the MMSP may apply those patterns). The MMSP may automatically update certain data for or related to data of chart 500b, which may change which sample set(s) 511 may be used with respect to data of chart 500c. Data of chart 500b and/or data of chart 500c may not be updated by a song producer and/or song modifier (e.g., such data may be fixed by a style producer and/or instrument producer, respectively), while updates by a song creator or song modifier to data of chart 500a may change what portions of libraries are being used/pointed to by the data of chart 500b and/or by the data of chart 500c. Process 605 of FIG. 9 may be run over and over again on a single chord (e.g., vamp) with no song structure. For example, a style producer may utilize the MMSP to repeatedly play a single chord as a musical context (e.g., to focus on one instrument at a time) and can change track data being fed in and select from a library of instruments and variables of the data of chart 500b and change a range of instrument(s), chord, melody, and/or the like. If a track type is melody, it may not use certain track data. When a chord may include multiple tracks, subprocess 908 of FIG. 13 may loop through each track (e.g., different iterations of subprocess 908 of FIG. 13 may run in parallel, one for each track of the chord), while a subprocess 912 of FIG. 66 may be run for all note events for each track of the chord (e.g., after subprocess 908 may have looped through each track of the chord).

### FIG. 66—Calculate Audio Data 912

After completing subprocess Calculate Composition Data 908, subprocess Calculate Audio Data 912 of process Calculate Chord Audio data 605 may initiate. Subprocess 912 may use Phrase Data 504 and Track Data 508 from the Song Object 501, the Harmony Data 910 returned from subprocess Calculate Composition Data 908, the Chord Duration Data 906, and Note Event 911 data received from subprocess Calculate Composition Data 908. Subprocess 912 may contain subprocesses that calculate elements of audio mixing including, but not limited to, reverb, panning, gain, filters, delays, and/or the like. Subprocess 912 may run for each Note Event 911 received from subprocess Calculate Composition Data 908. Subprocess 912 may create one or more Audio Sources 801 and one or more corresponding Source Audio Chains 802, which may connect to a single Track Audio Chain 803. FIG. 66 shows subprocesses that may run within subprocess Calculate Audio Data 912.

Data 510, 906, 910, and 911 may be received as input by subprocess Calculate Audio Data 912.

Subprocess 912 may include a subprocess 6601 that may determine whether the Note Event 911 is associated with a Track Object 507 of Track Type 508b “drums”. If it is determined at subprocess 6601 that the Note Event 911 is associated with a Track Object 507 of Track Type 508b “drums”, then a subprocess Calculate Drum Sample 6602 may initiate. As shown in FIG. 67, subprocess Calculate Drum Sample 6602 may receive data 510, 906, 910, and 911 as input, and may create the drum Audio Sample 512 Audio Source 801a, and Source Audio Chain 802, and may connect the Audio Source 801 to the Source Audio Chain 802, and may connect the Source Audio Chain 802 to its corresponding Track Audio Chain 803 and schedule it to play.

If it is determined at subprocess 6601 that the Note Event 911 is not associated with a Track Object 507 of Track Type 508b “drums”, and if it is determined at a subprocess 6603 that suspended 4th modifications are needed, then a subprocess Sus4 Modification 6604 may initiate. Subprocess Sus4 Modification 6604 may receive data 510, 906, 910, and 911 as input, and may modify suspended 4th notes resulting in processed Note Event 911a data, and may return data 510, 906, 910, and 911a. After completing subprocess Sus4 Modification 6604, if it is determined at a subprocess 6605 that the suspended 4^{th} needs resolution, then a new Note Event 911 may be created to resolve the suspended 4^{th} and subprocess Calculate Audio Data 912 may be re-initiated with the new Note Event 911 data. If it is determined at subprocess 6605 that the suspended 4^{th} h does not need resolution, then no additional Note Events 911 may be created and subprocess Calculate Audio Data 912 may stop at operation 6606.

If it is determined at subprocess 6601 that the Note Event 911 is not associated with a Track Object 507 of Track Type 508b “drums” and if it is determined at subprocess 6603 that suspended 4th modifications are not needed, or after completing subprocess Sus4 Modification 6604, a subprocess Calculate Note Duration 6607 may initiate. Subprocess Calculate Note Duration 6607 may receive data 510, 906, and 910, and either data 911 or 911a as input, and may calculate the duration that the note will play resulting in processed Note Event 911b data, and may return data 510, 906, 910, and 911b.

After completing subprocess Calculate Note Duration 6607, a subprocess Calculate Note Envelopes 6608 may receive data 510, 906, 910, and 911b as input, and may calculate Envelope 911ee data for audio process values, which may include, but are not limited to, gain and filter audio process values. This may result in processed Note Event 911c data and may return data 510, 906, 910, and 911c. This Envelope 911ee data may include, but is not limited to, attack, sustain, and release envelopes. These envelopes may be based off of the Note Duration 911dd value of the Note Event 911.

If it is determined at a subprocess 6609 that final bar modifications are needed, then a subprocess Final Bar Modification 6610 may initiate. Subprocess Final Bar Modification 6610 may receive data 510, 906, 910, and 911c as input, and may filter out notes that don't start on the downbeat, and may modify note pitches to harmonize with the final chord, resulting in processed Note Event 911d data. This may return data 510, 906, 910, and 911d.

After completing subprocess Final Bar Modification 6610 or if it is determined at subprocess 6609 that final bar modifications are not needed, then a subprocess Calculate Swells 6611 may initiate. Subprocess Calculate Swells 6611 may receive data 510, 906, and 910, and either data 911c or 911d as input, and may calculate gain and filter swell data based off of the Swell Duration 508mm value and Swell Pattern 508ll value, resulting in processed Note Event 911e data. This may return data 510, 906, 910, and 911e.

After completing subprocess Calculate Swells 6611, a subprocess Humanize Velocity 6612 may receive data 510, 906, 910, and 911e as input, and may apply randomization to the Note Event's Gain 911aa value based off of the Humanize Velocity 508dd value resulting in processed Note Event data 911f This may return data 510, 906, 910, and 911f.

After completing process Humanize Velocity 6612, a process Humanize Start Time 6613 may receive data 510, 906, 910, and 911f as input, and may apply randomization to the Note Event's Start Time 911bb value based off of the Humanize Time 508ee value resulting in processed Note Event data 911g. This may return data 510, 906, 910, and 911g.

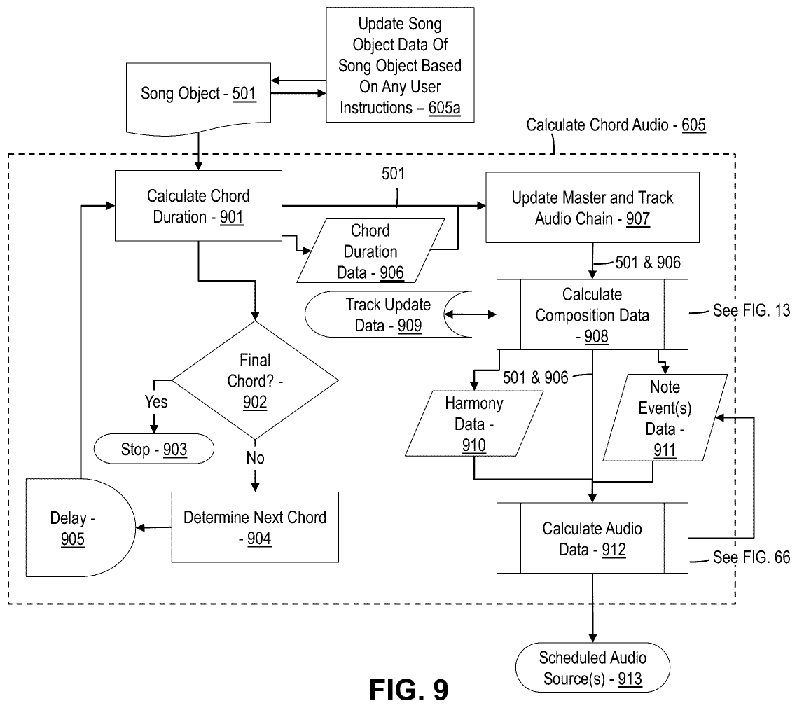

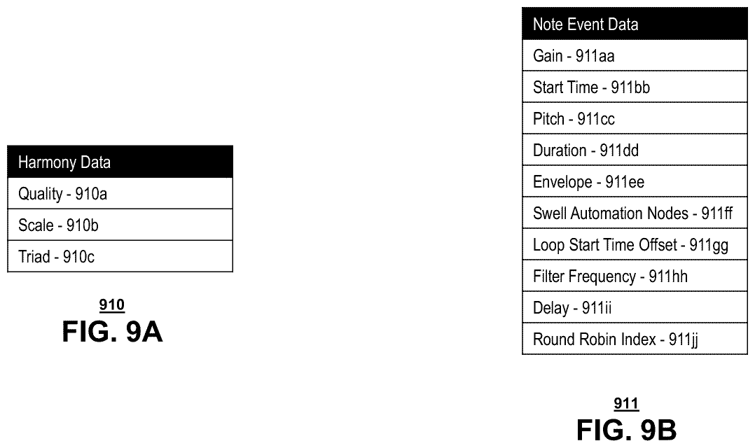

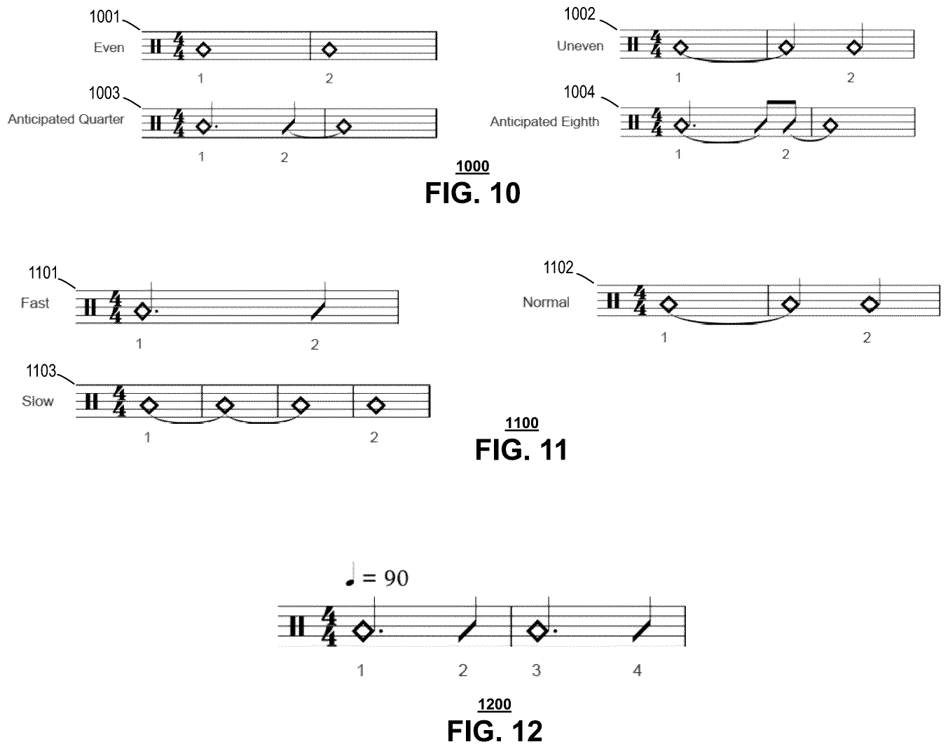

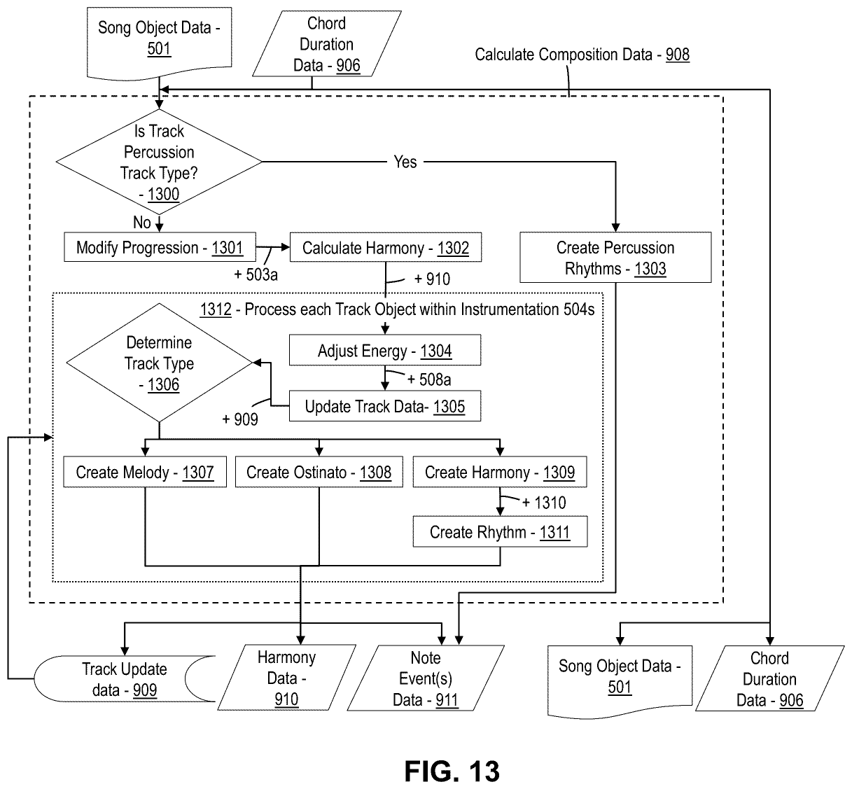

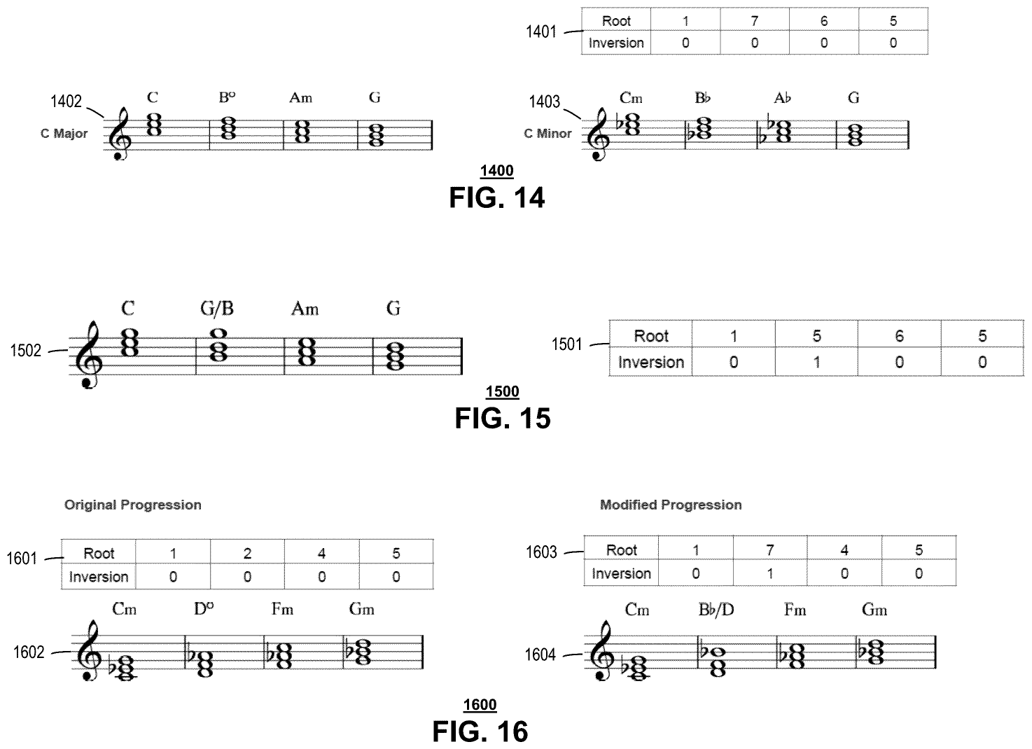

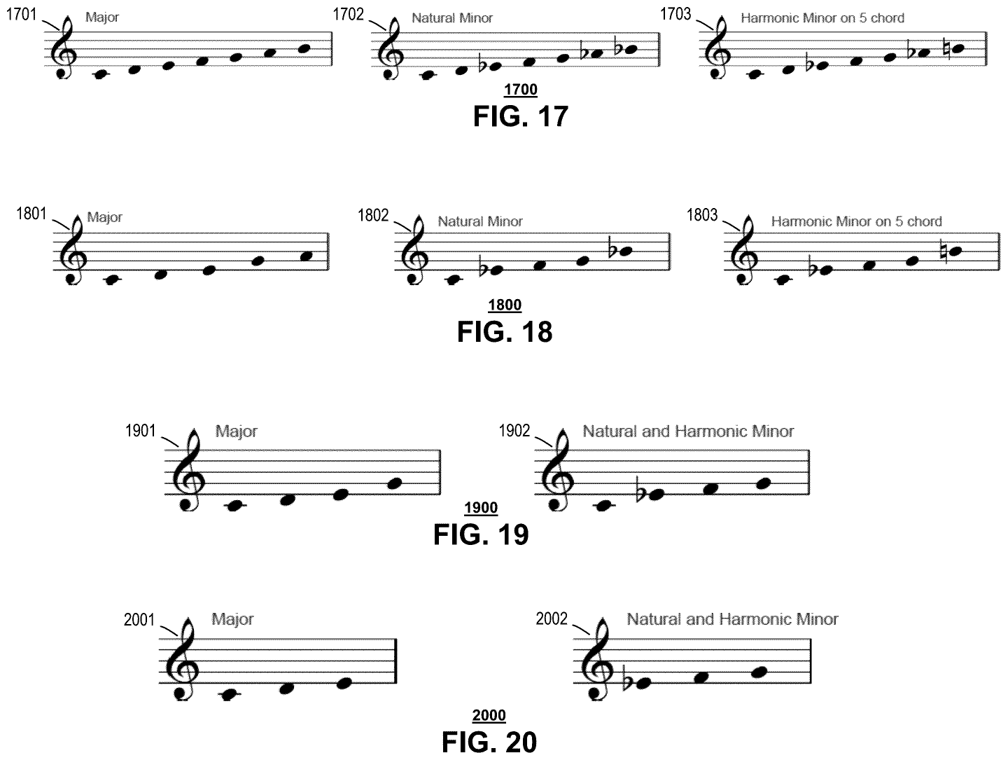

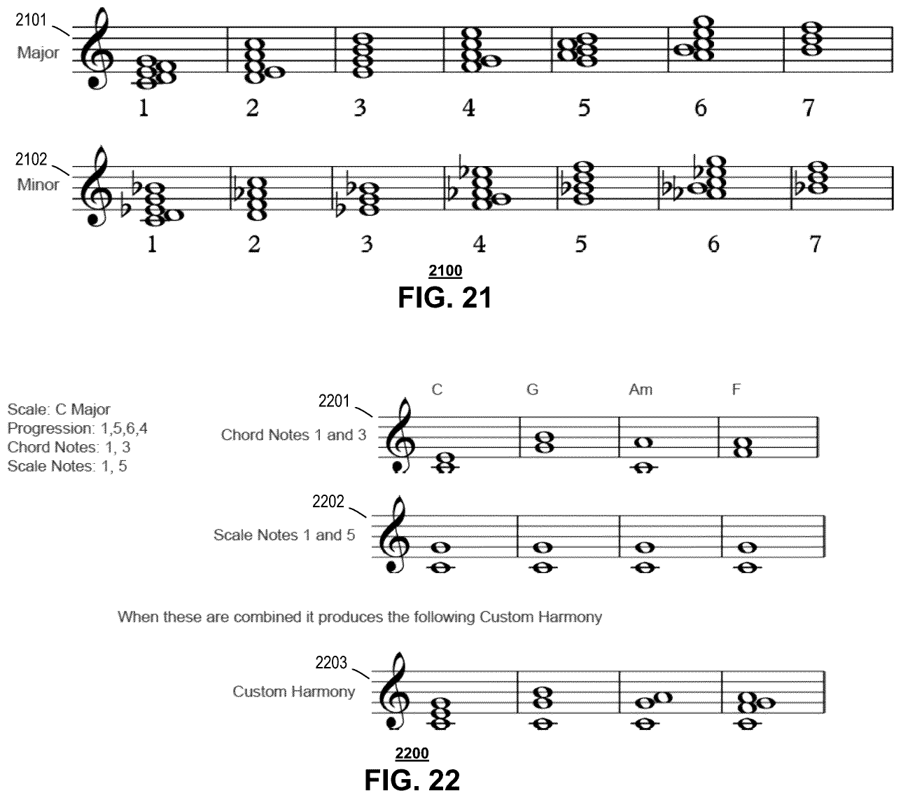

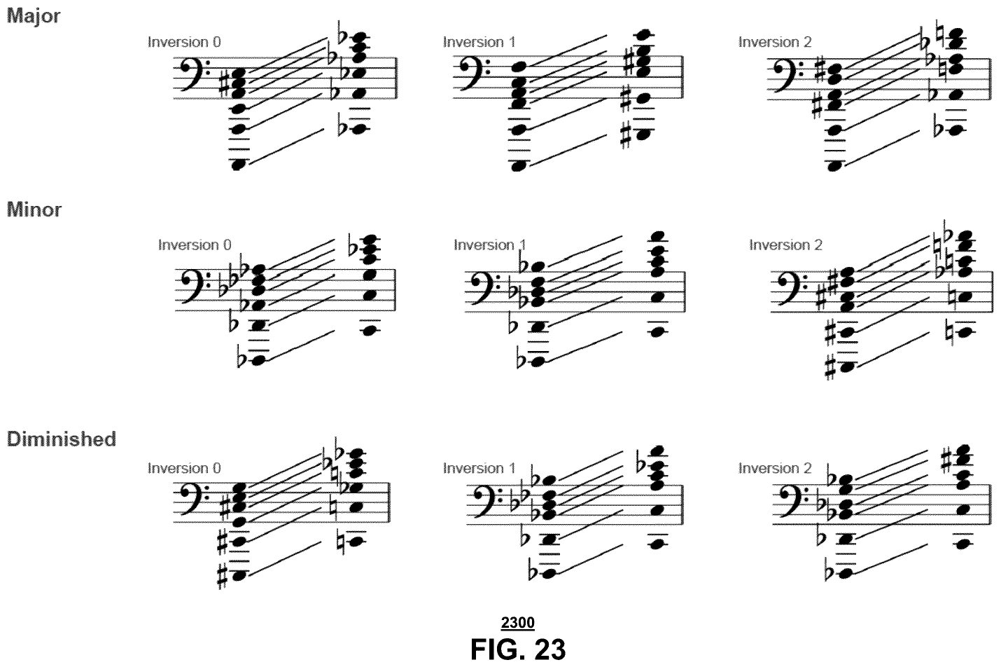

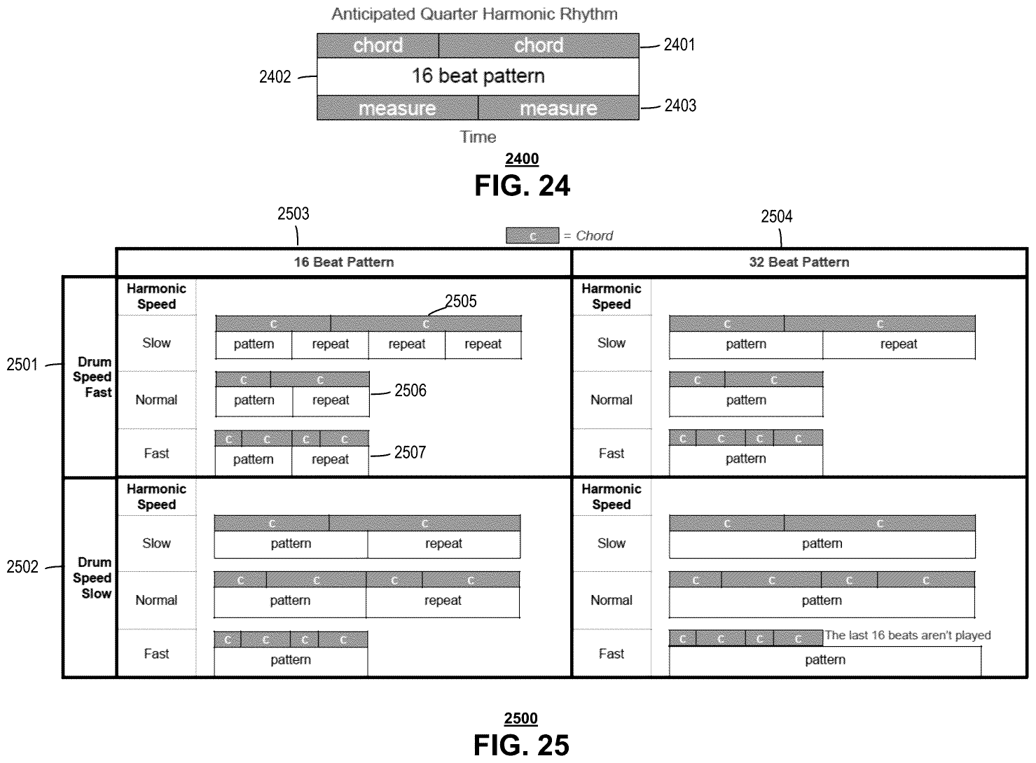

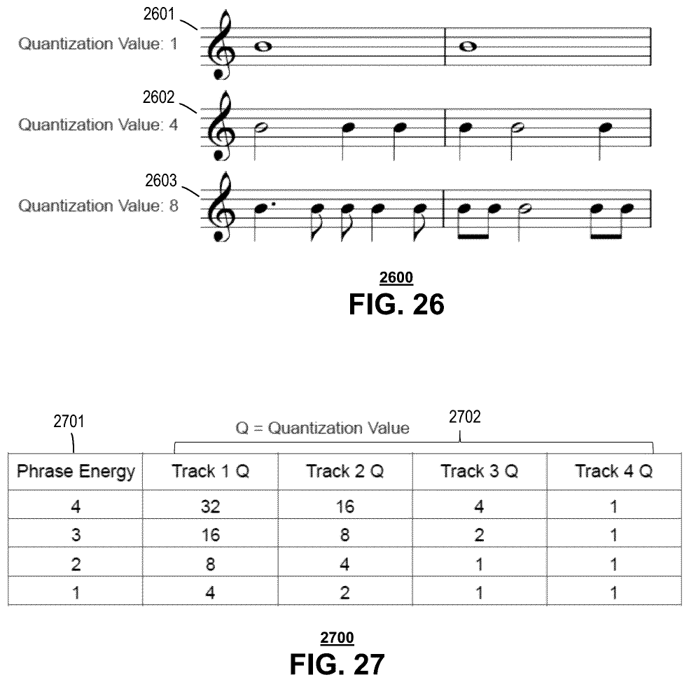

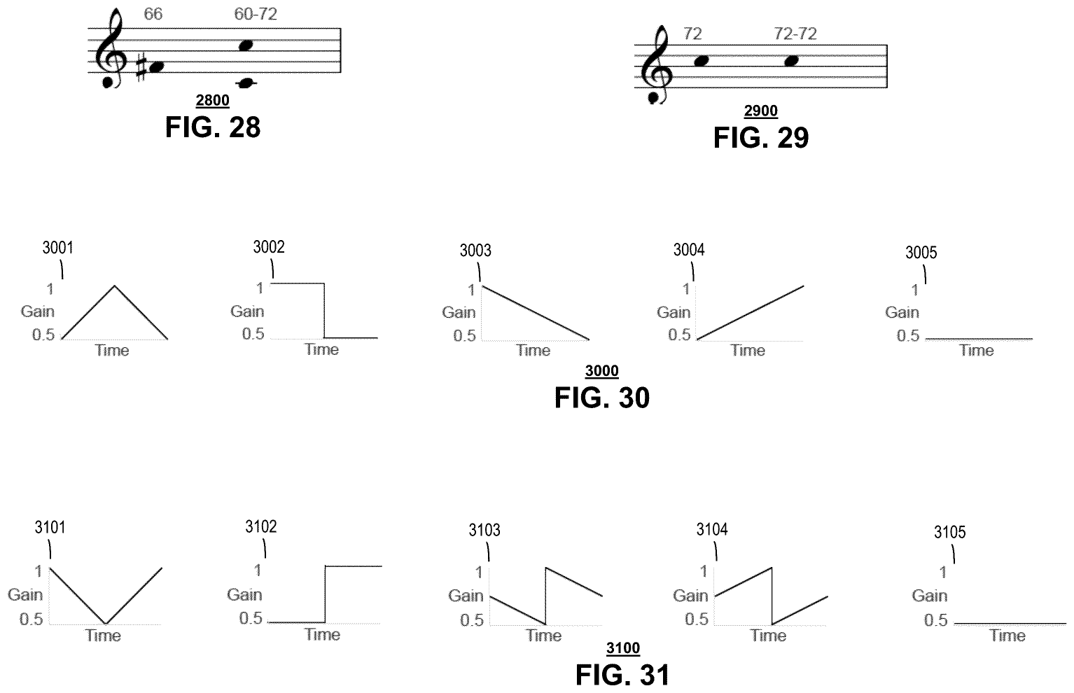

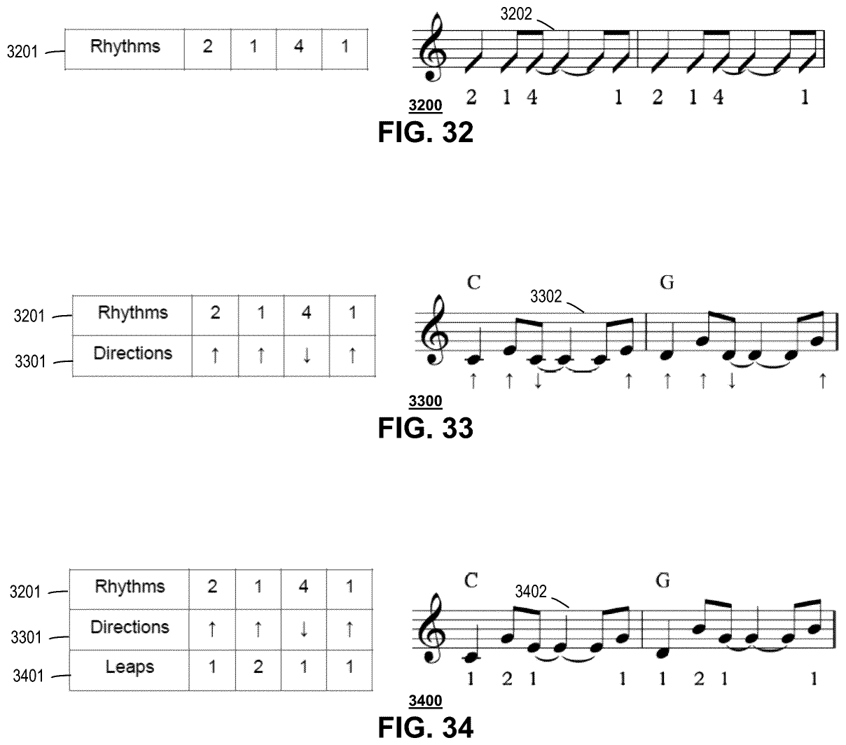

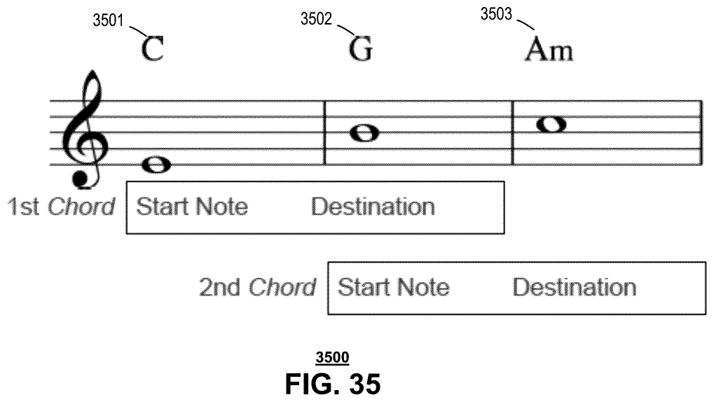

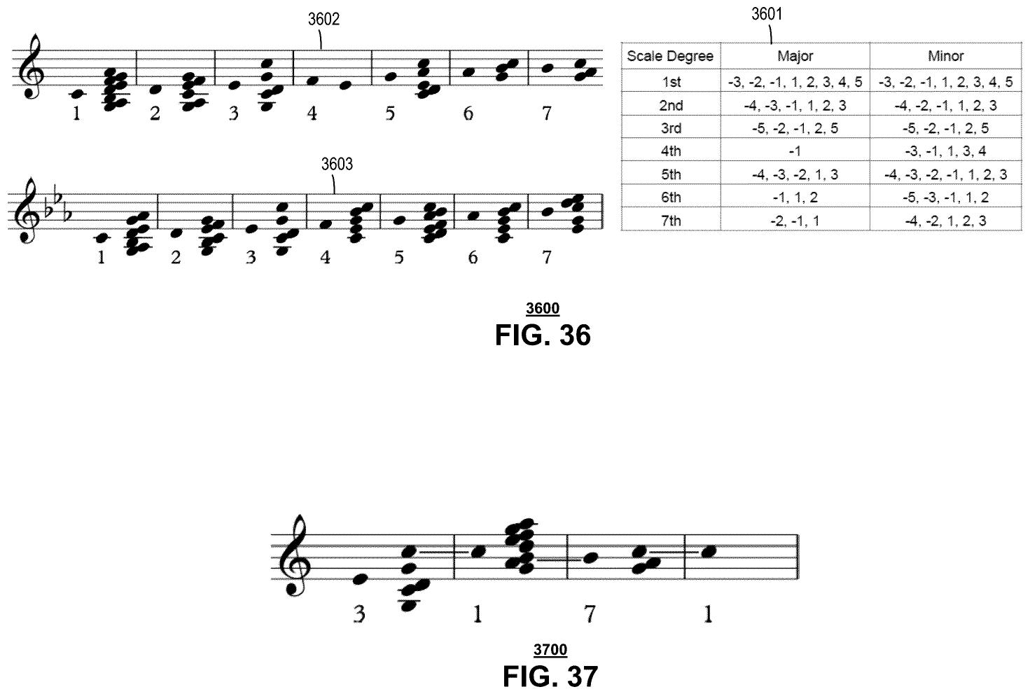

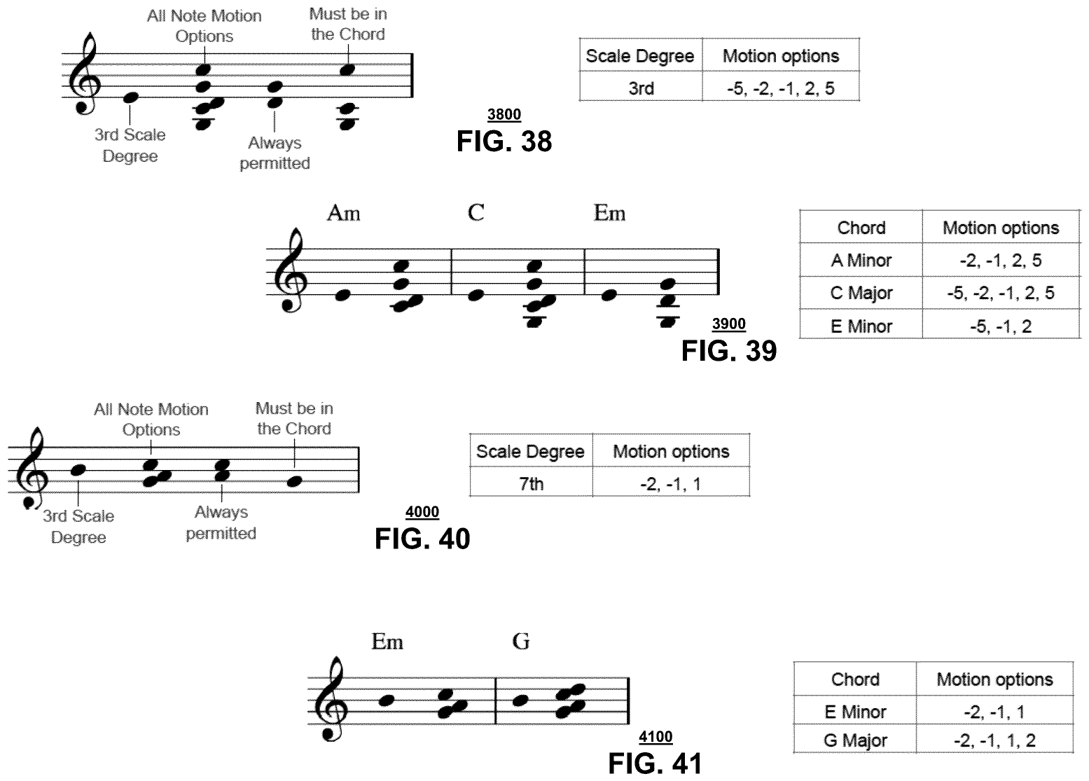

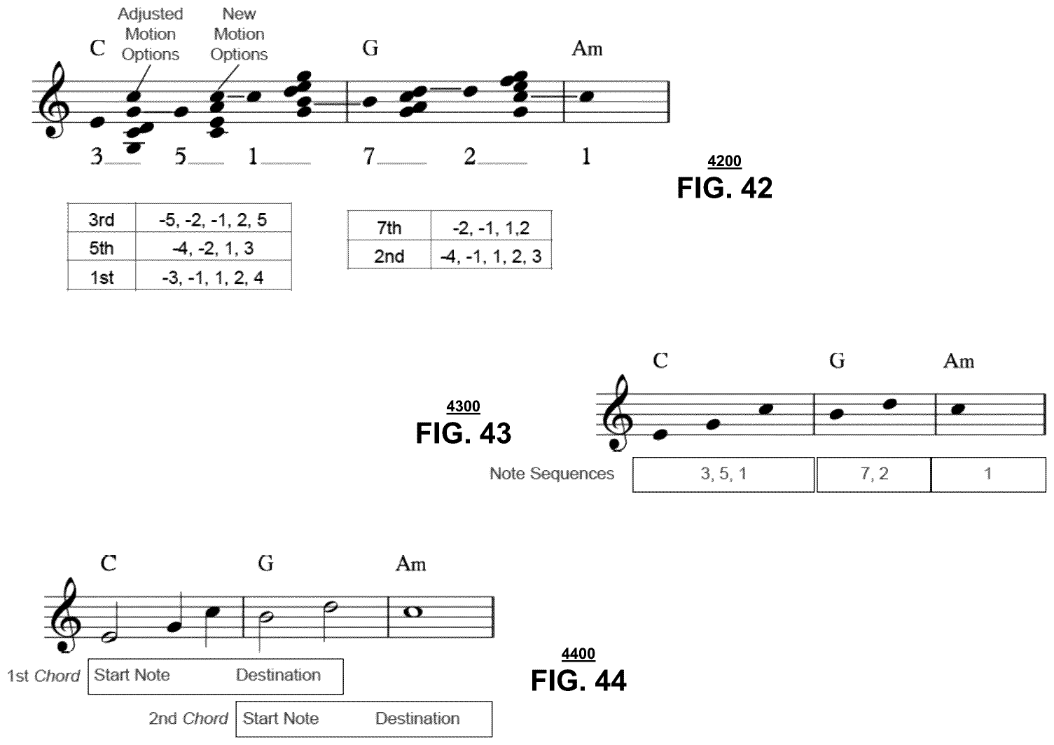

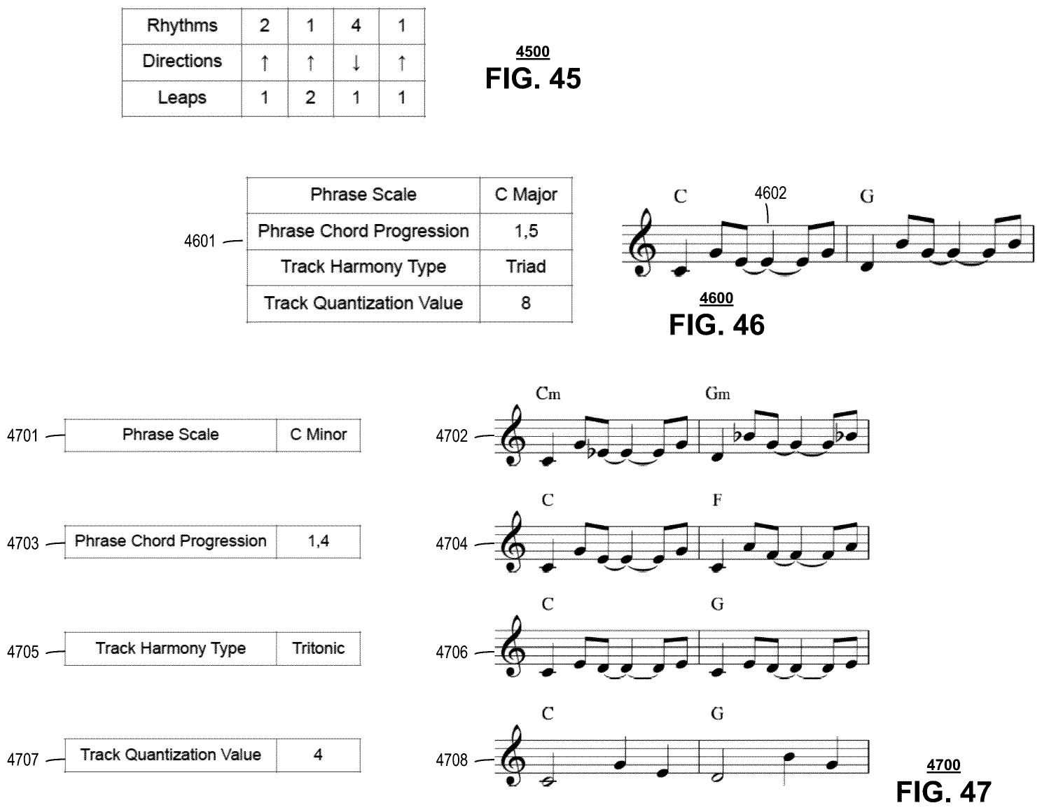

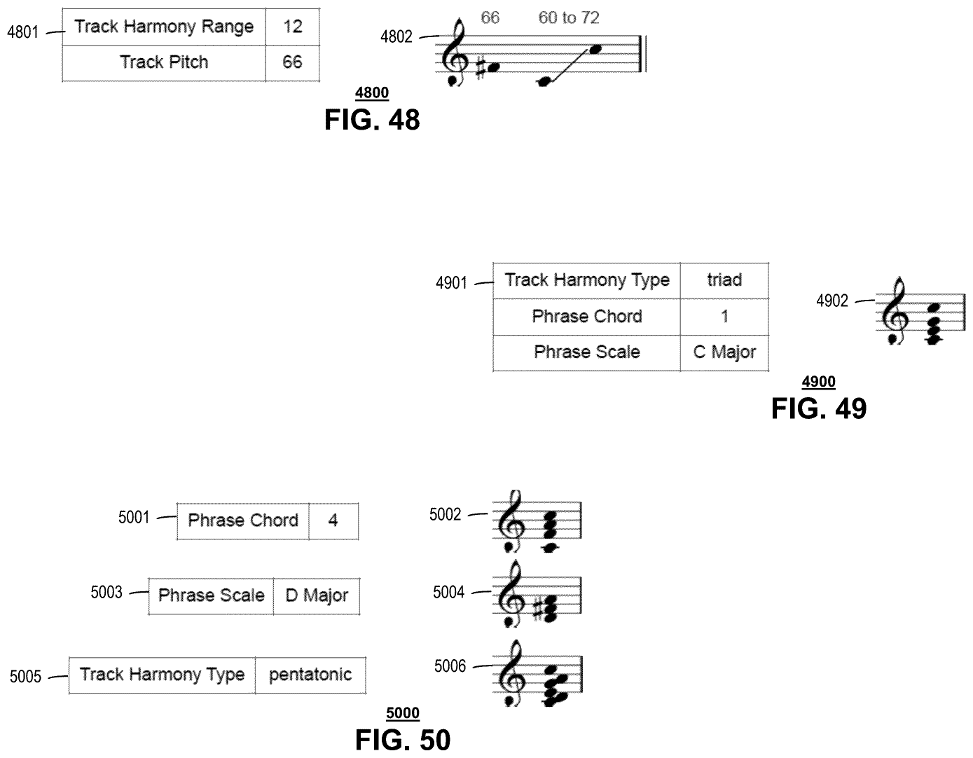

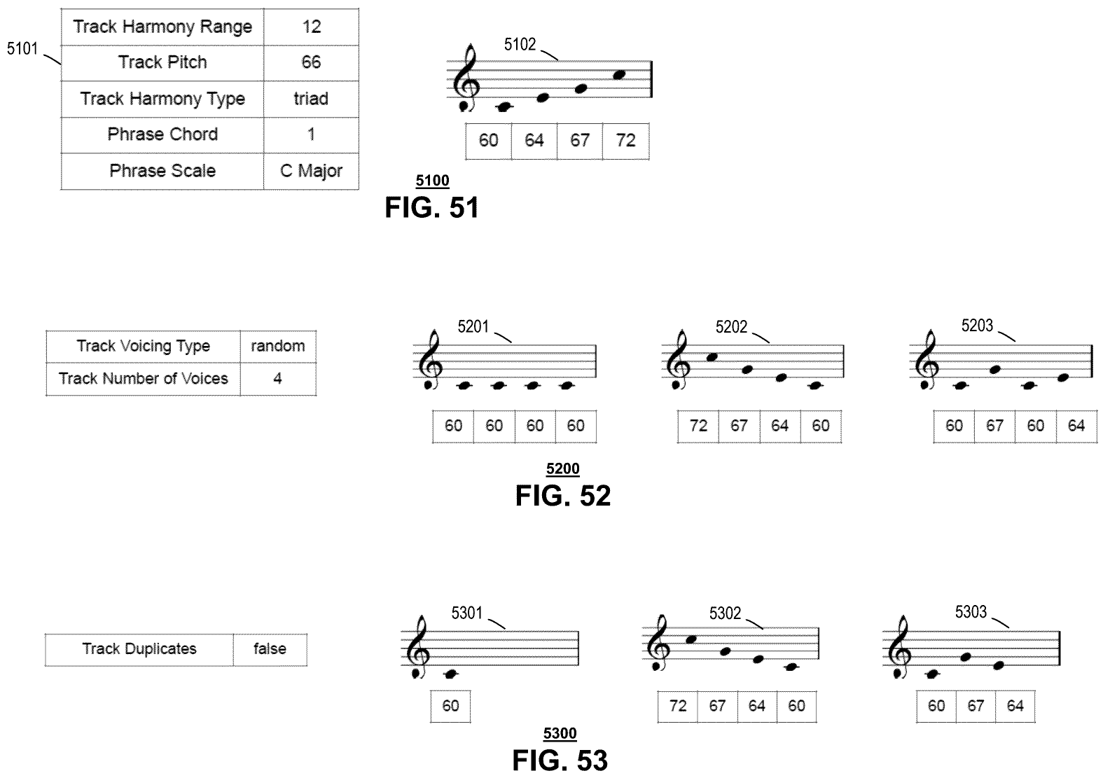

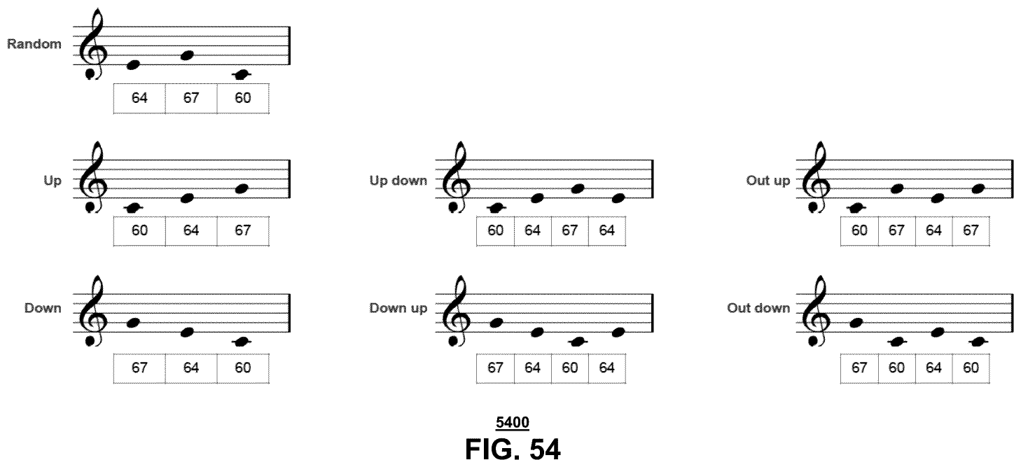

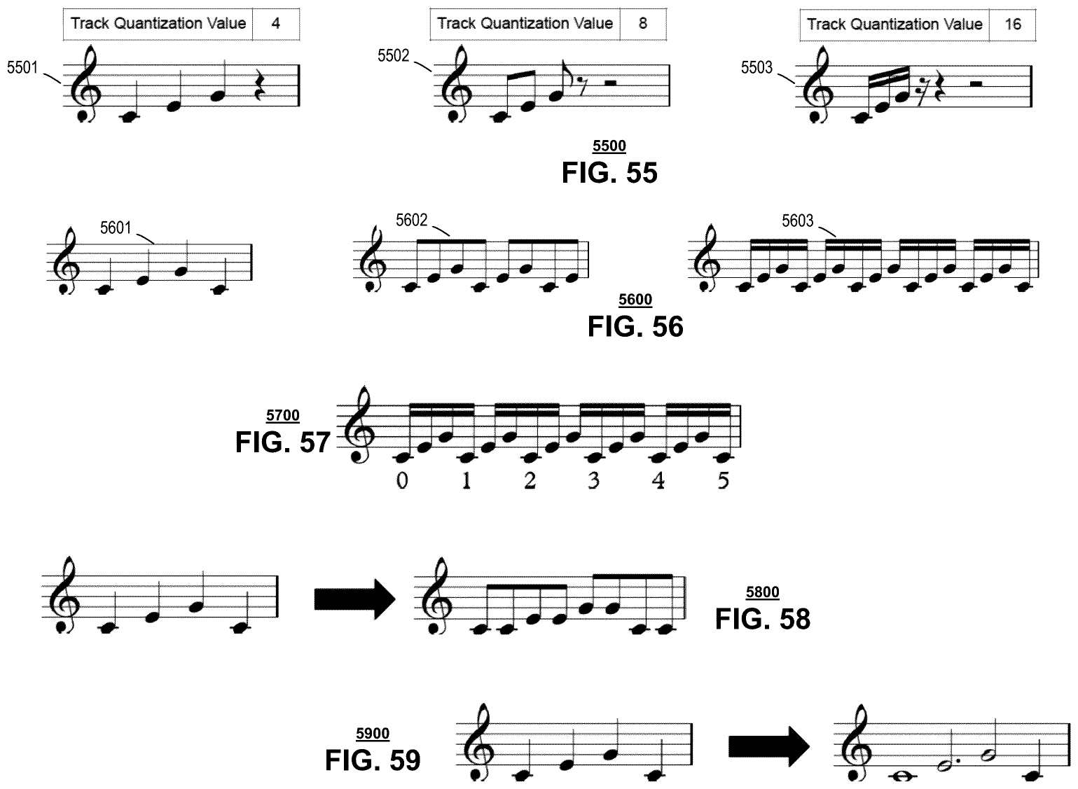

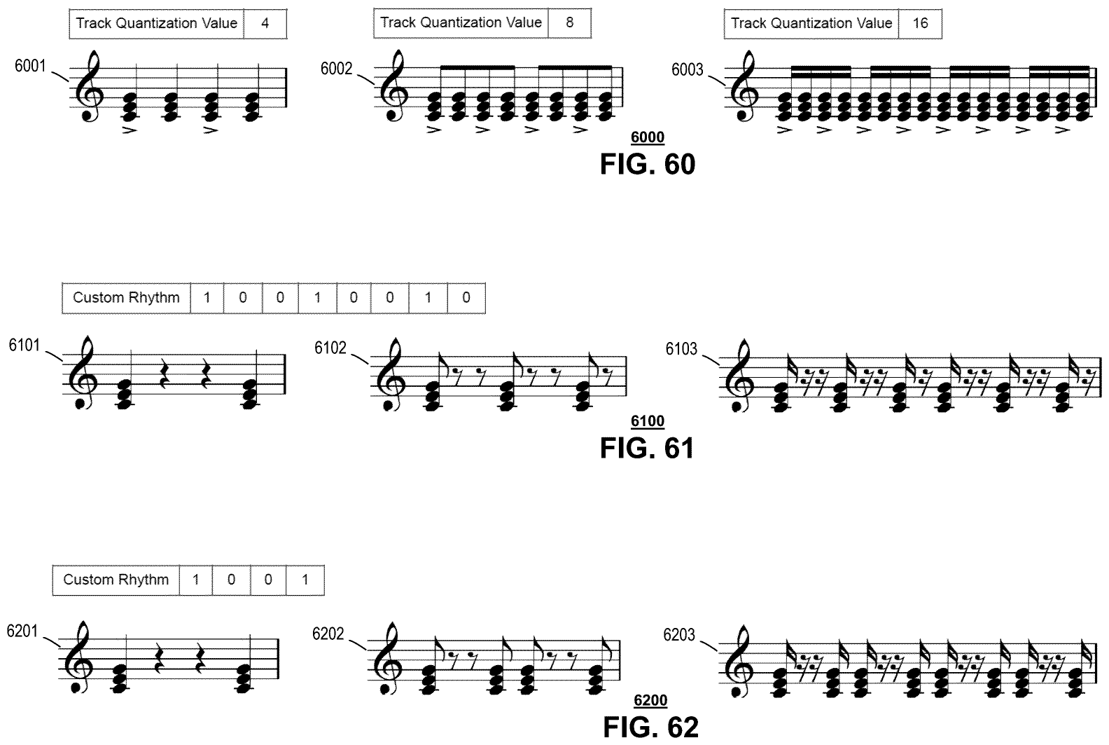

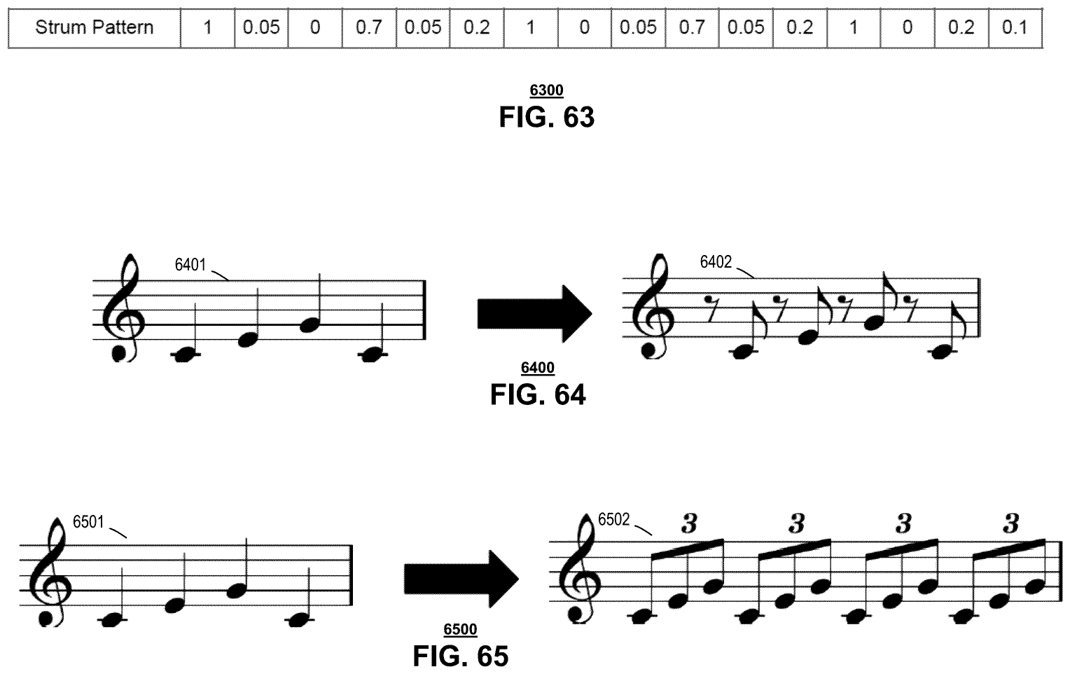

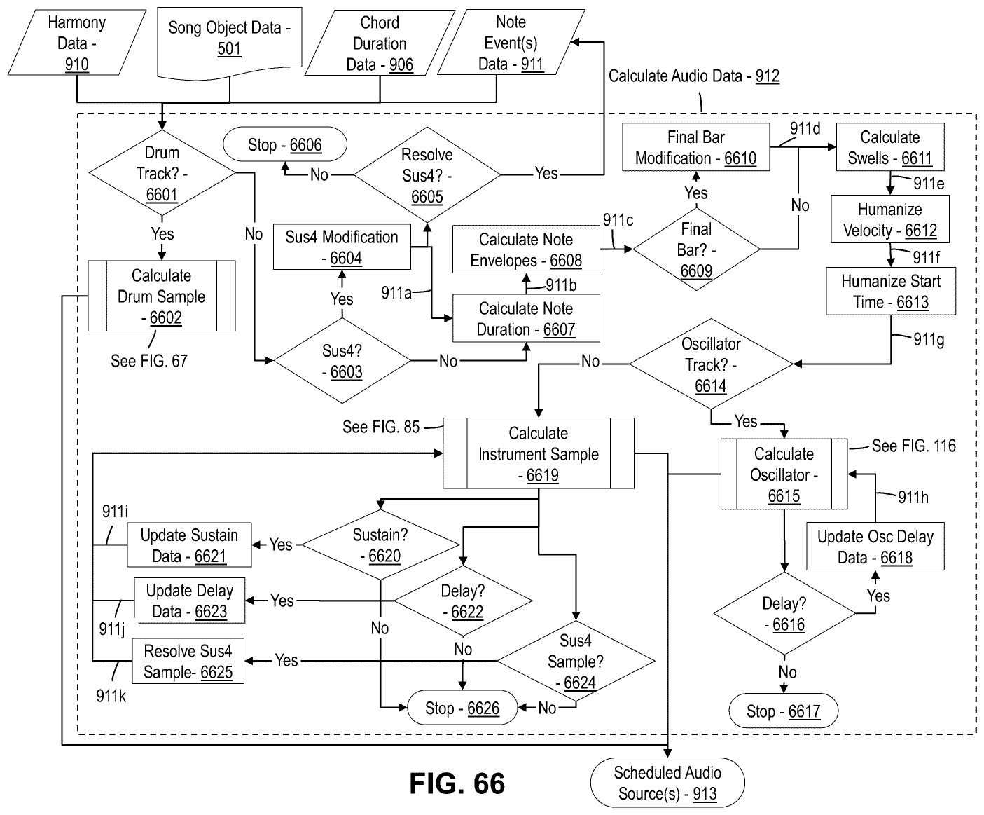

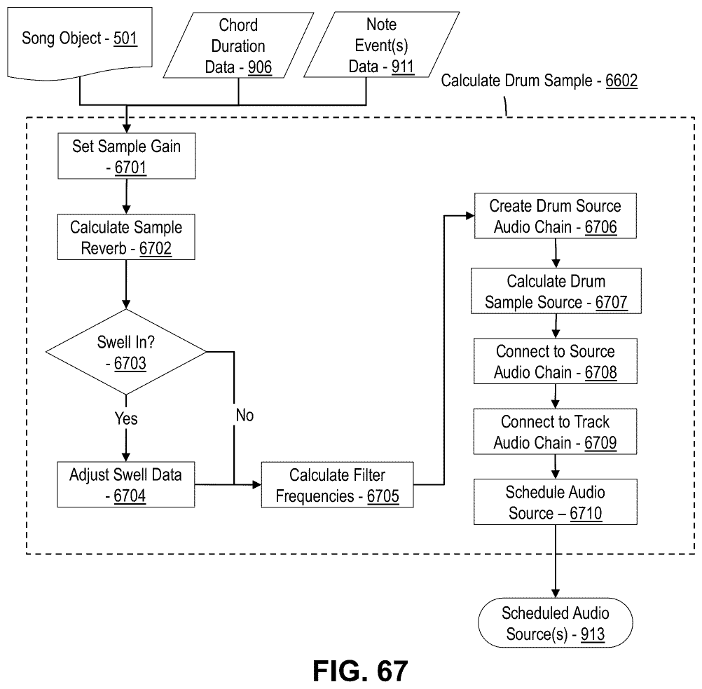

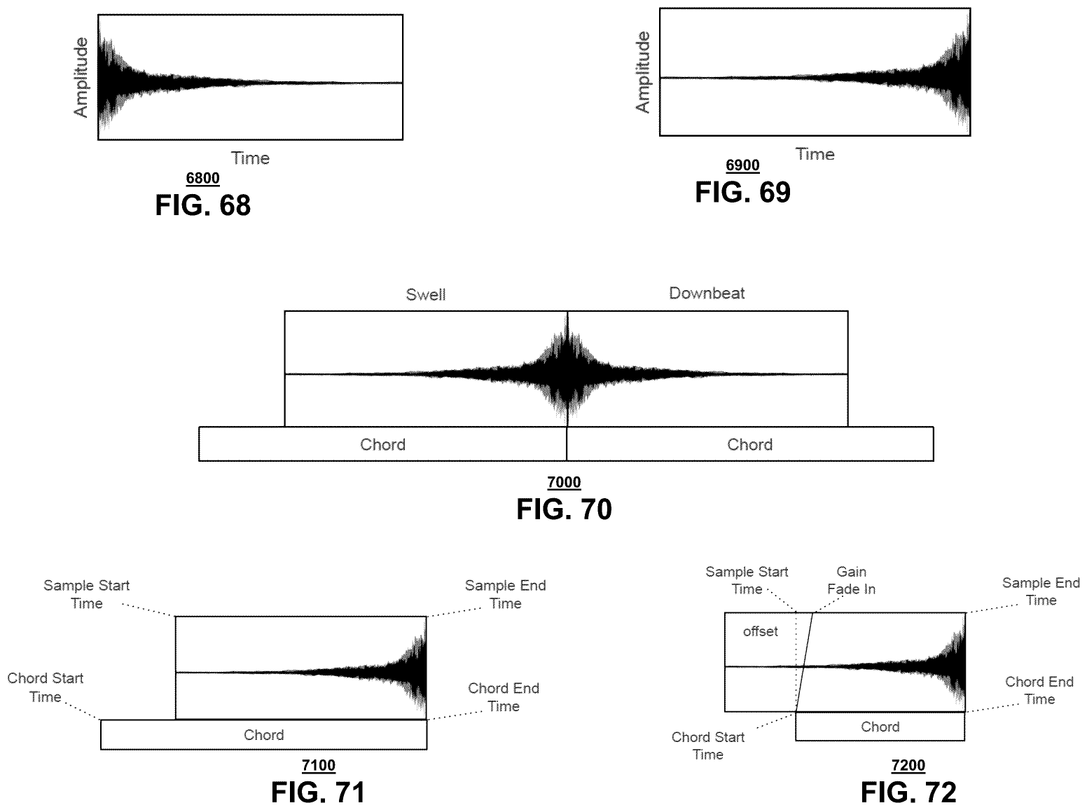

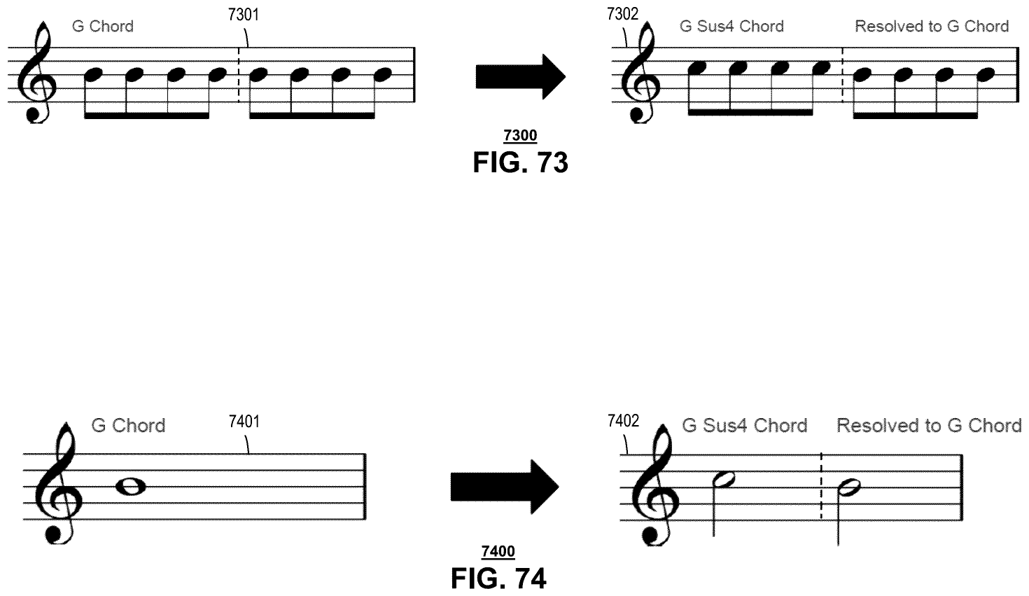

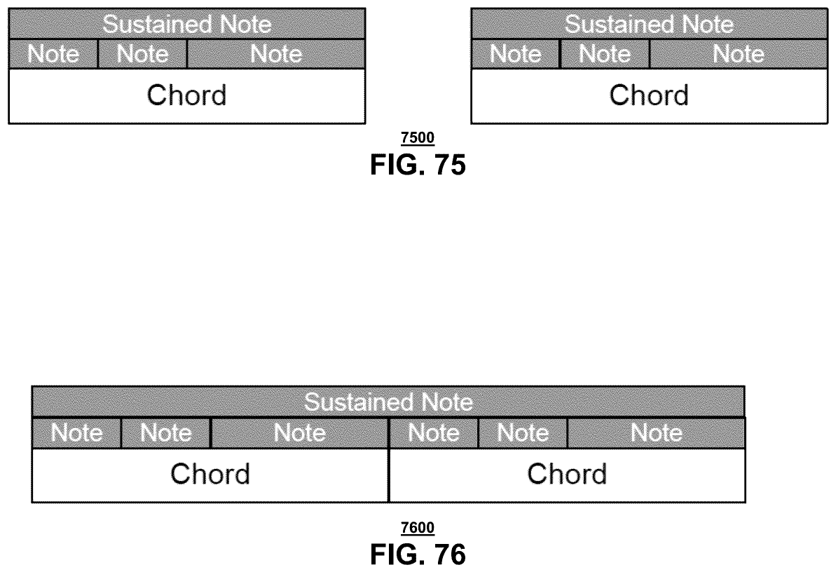

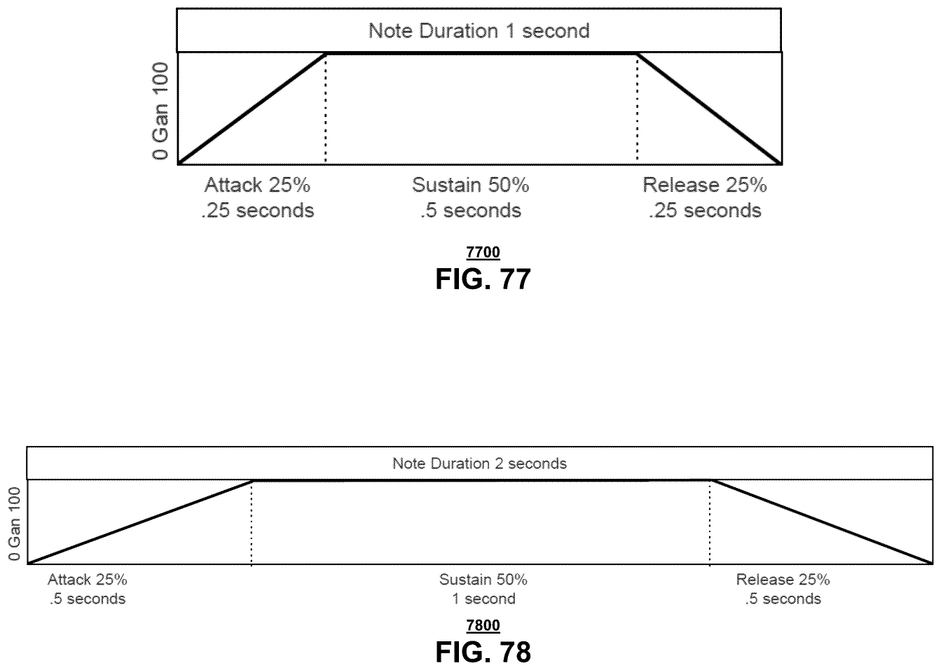

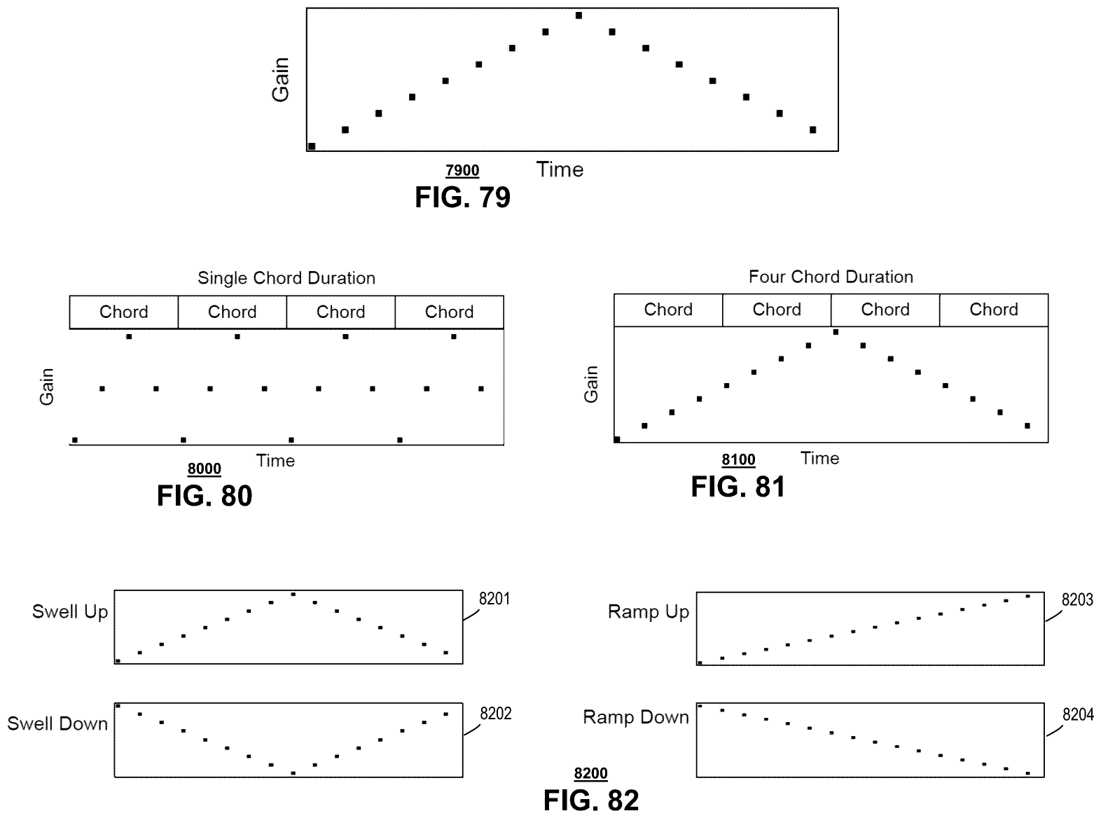

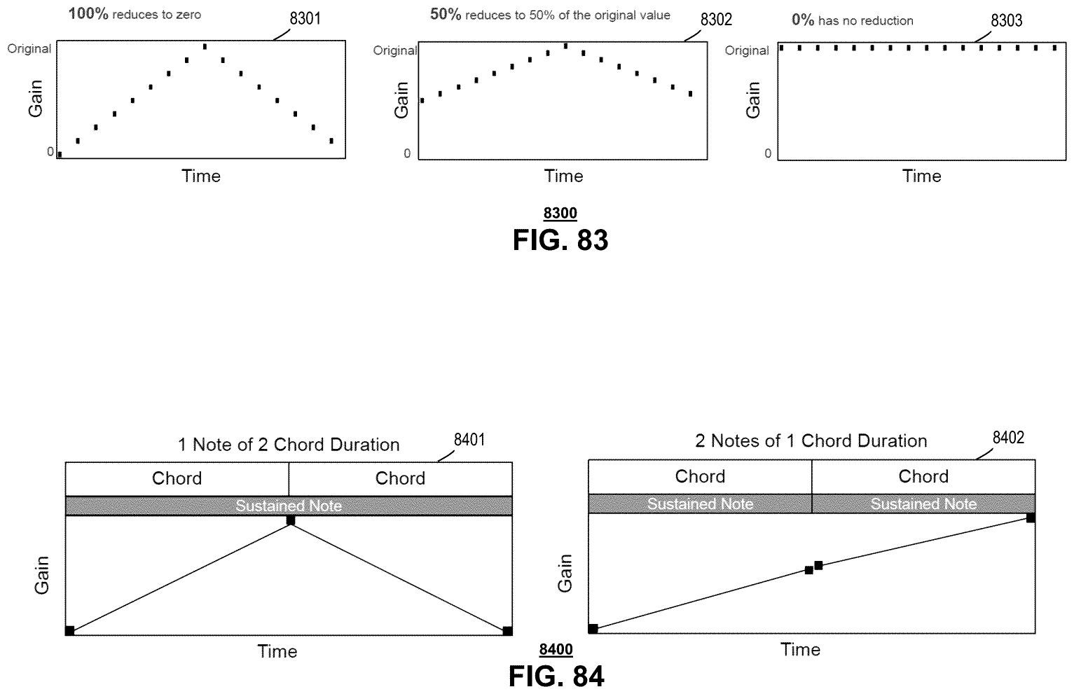

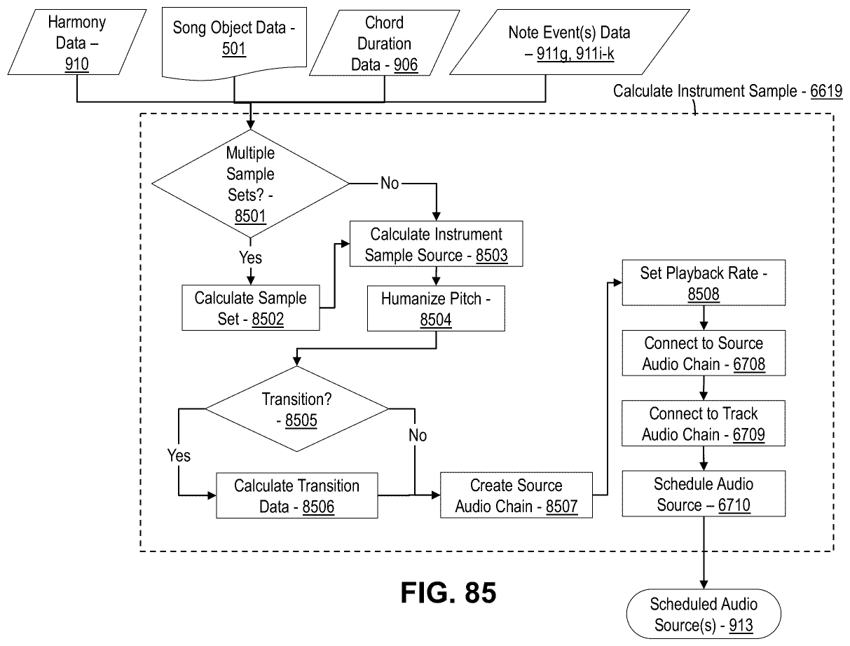

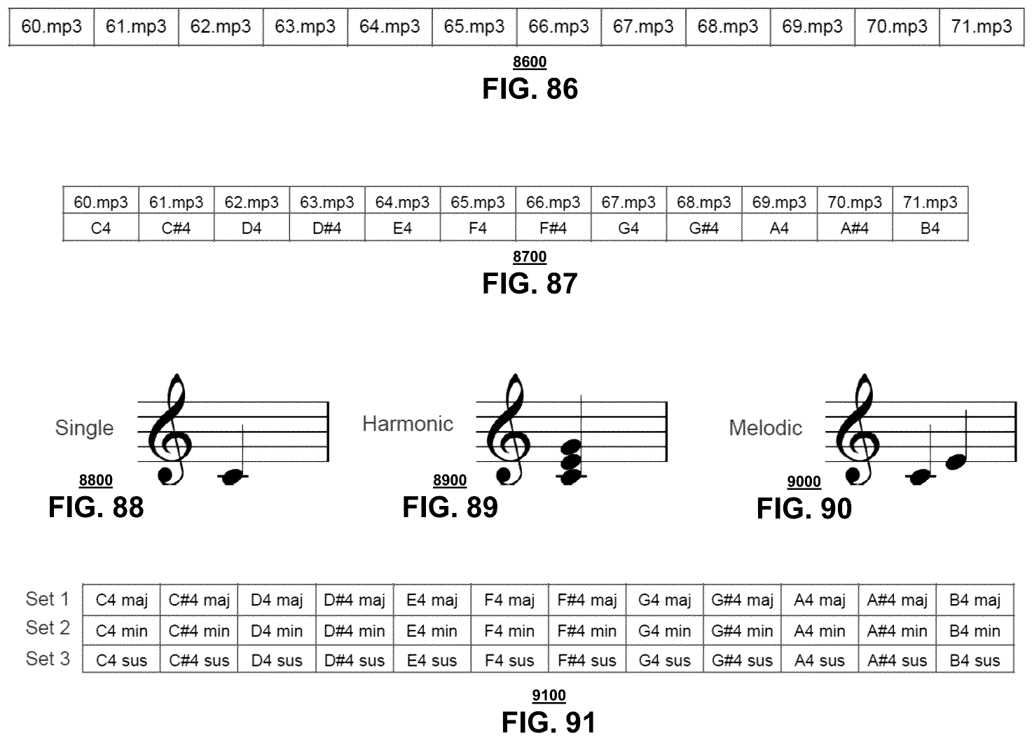

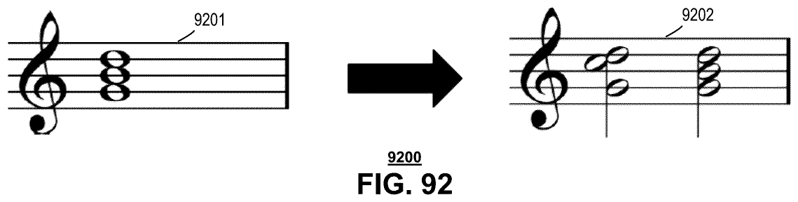

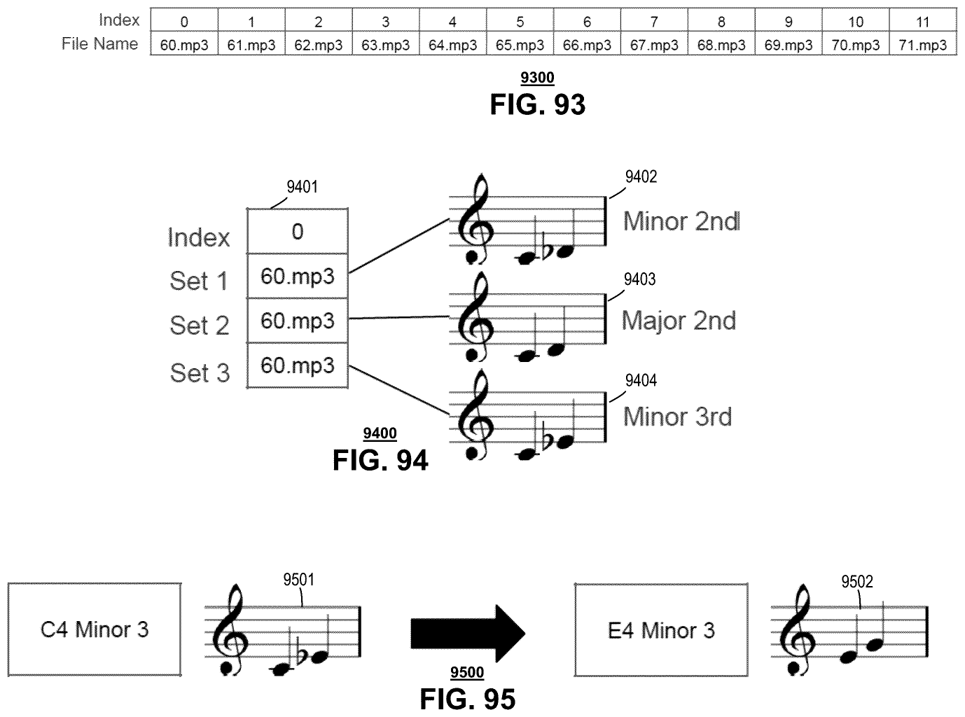

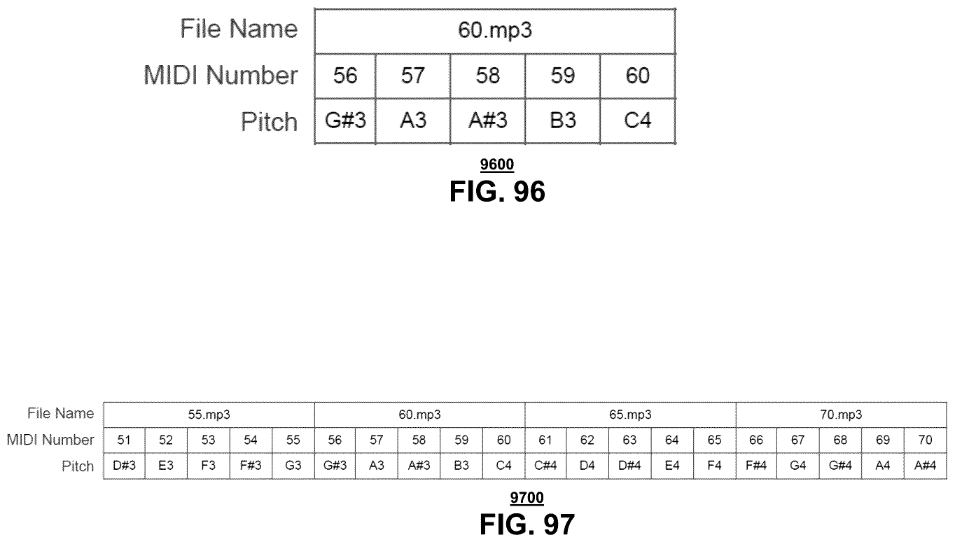

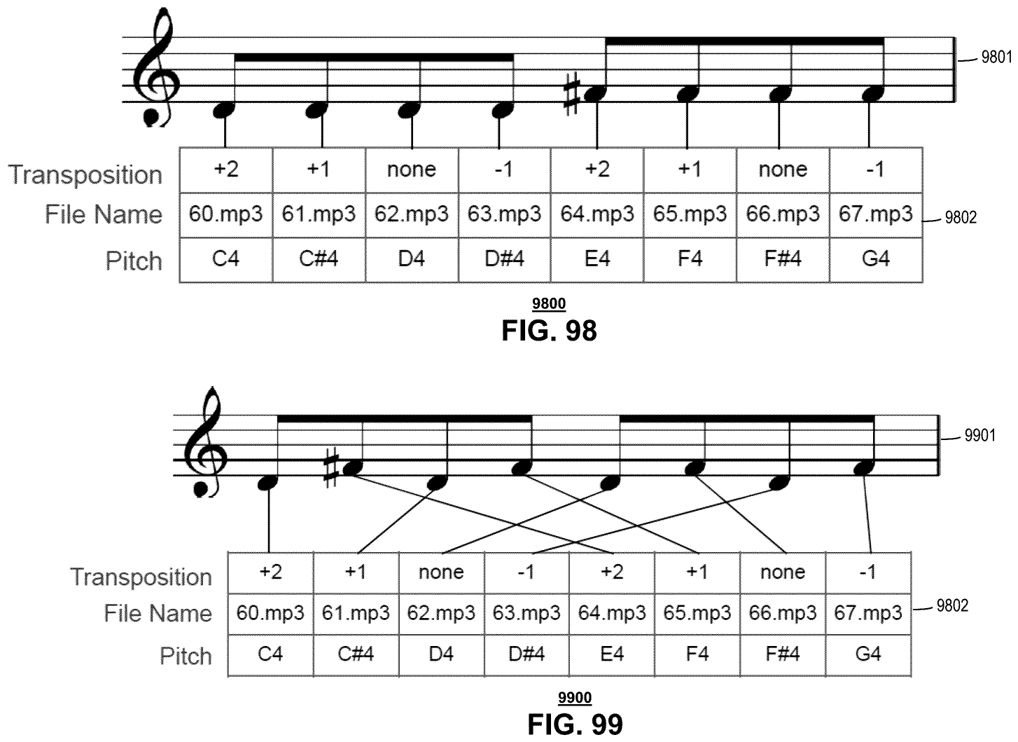

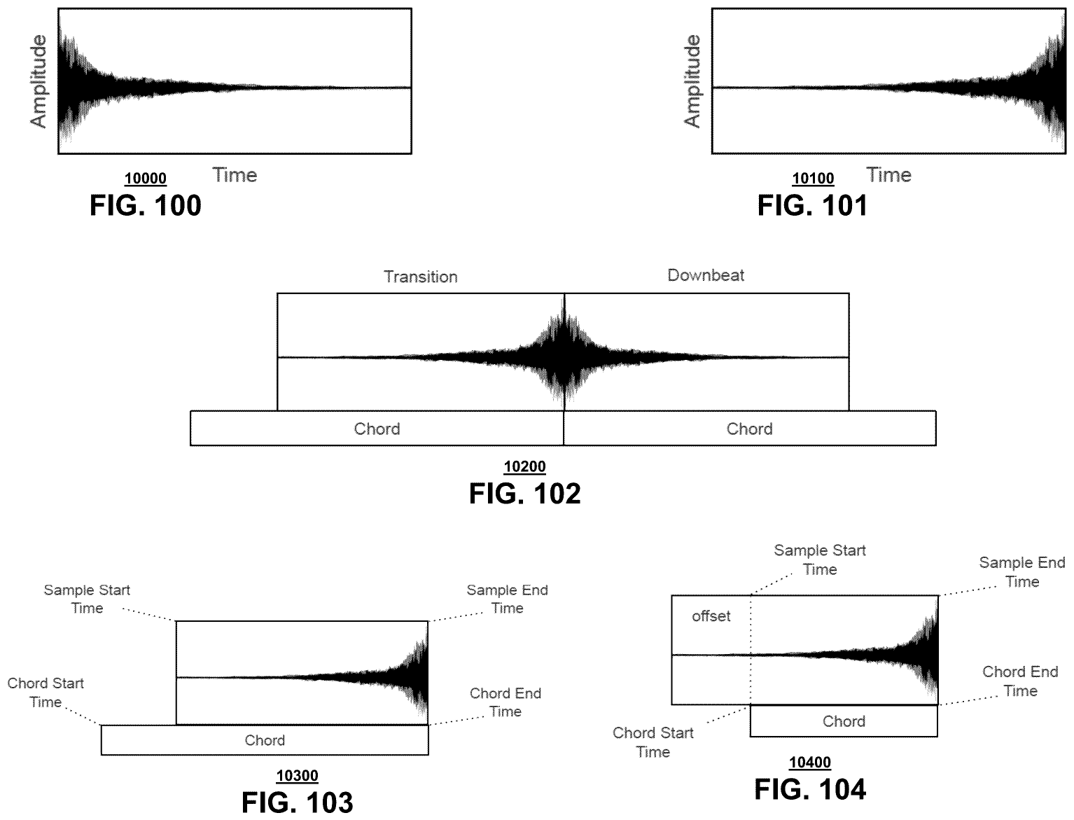

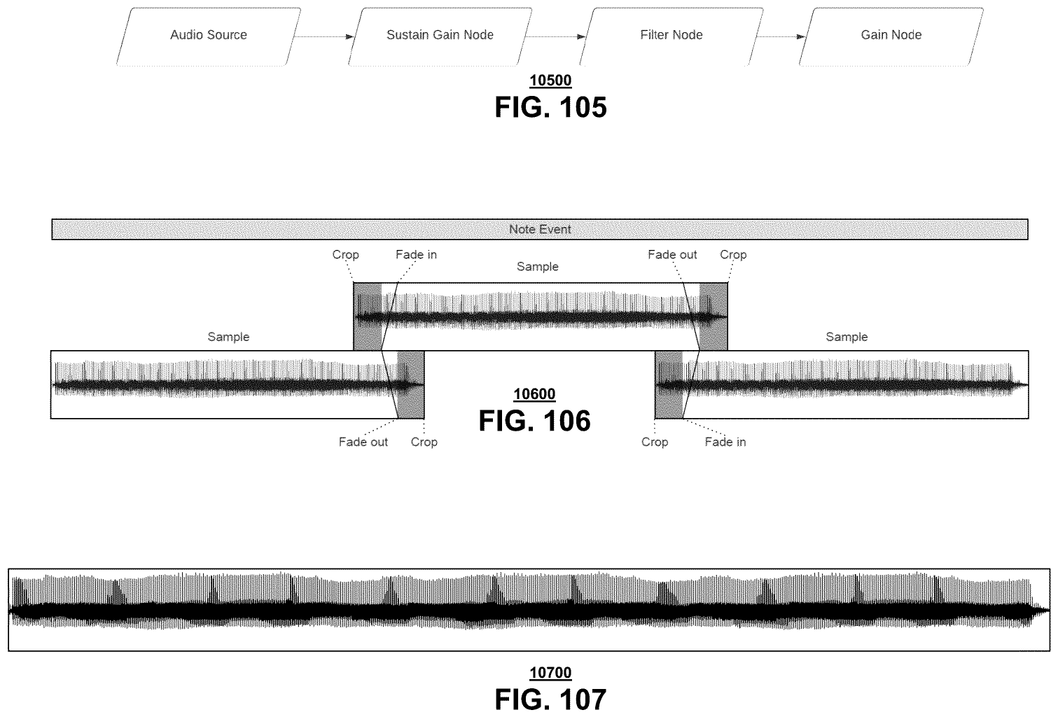

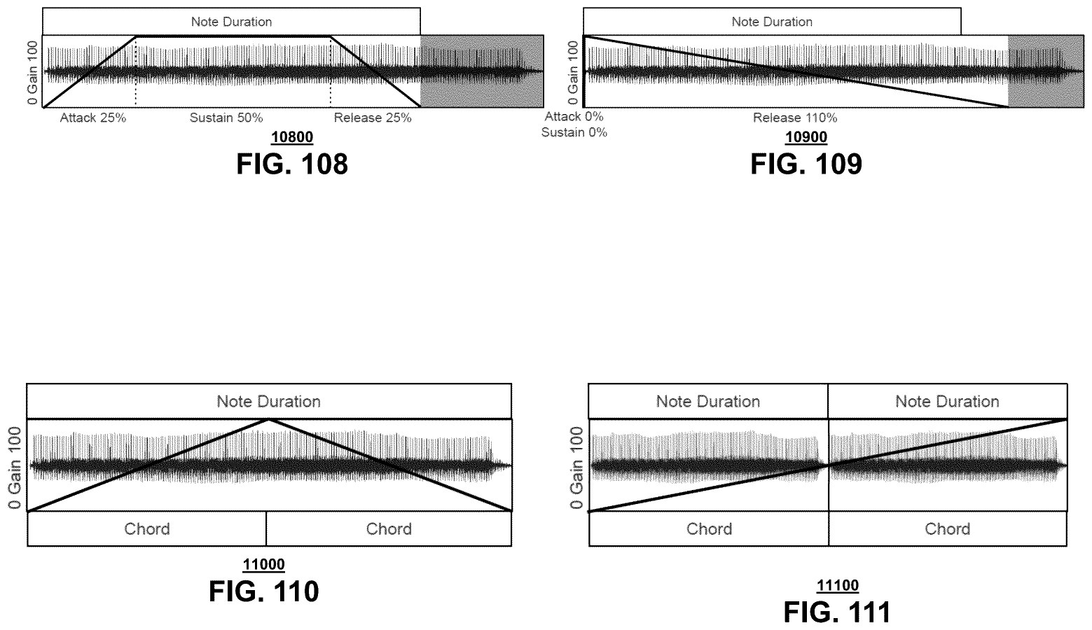

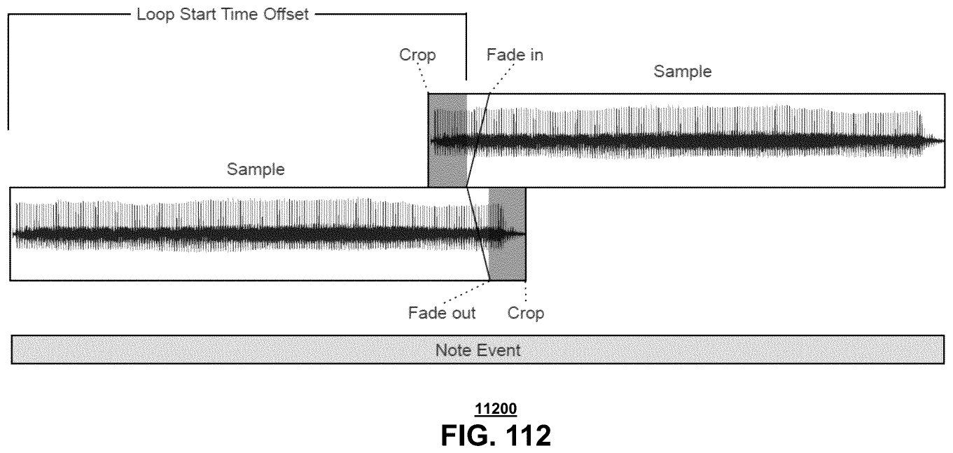

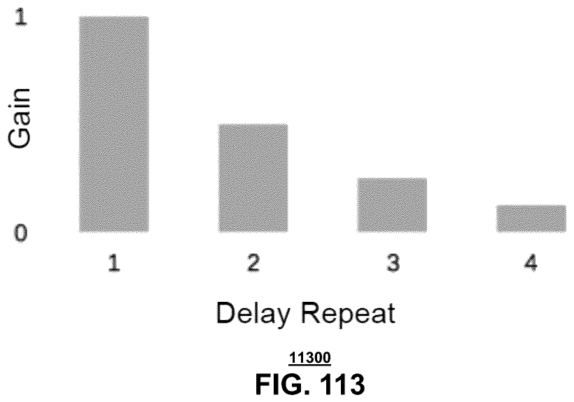

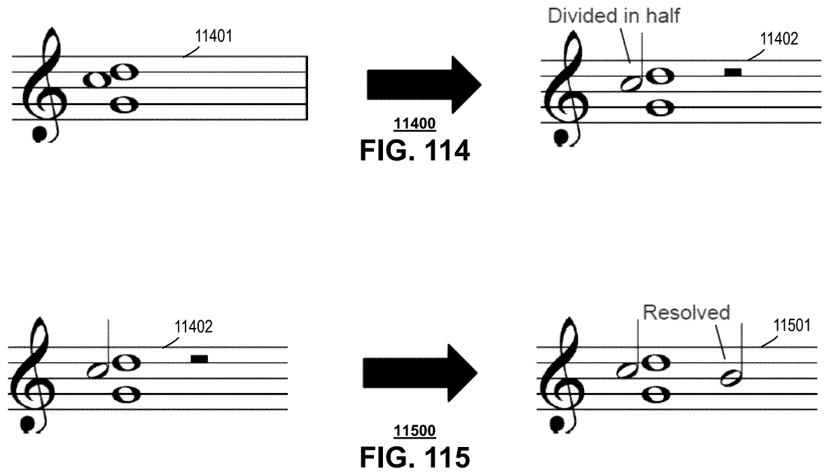

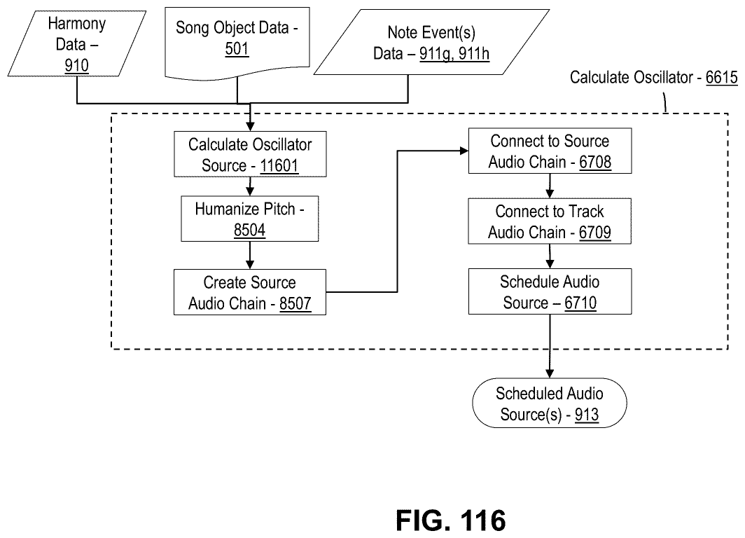

If it is determined at a subprocess 6614 that the Note Event 911g is associated with a Track Object 507 whose Instrument Object's Sample Type 510d is an Oscillator, then a subprocess Calculate Oscillator 6615 may initiate. As shown in FIG. 116, subprocess Calculate Oscillator 6615 may receive data 510, 906, 910, and 911g as input, and may create the Oscillator Audio Source 801a, and Source Audio Chain 802, and may connect the Audio Source 801 to the Source Audio Chain 802, and may connect the Source Audio Chain 802 to its corresponding Track Audio Chain 803 and schedule it to play resulting in a Scheduled Audio Source 913.

After completing Calculate Oscillator 6615 subprocess, if it is determined at a subprocess 6616 that the Note Event 911g should be delayed (e.g., this may be if the Note Event 911g is associated with a Track Object 507 that has a Delay Repeat 508tt value that is greater than the number of times it has already been delayed), then a subprocess Update Osc Delay Data 6618 may initiate. Subprocess Update Osc Delay Data 6618 may receive data 510, 906, and 910, and either data 911g or 911h as input (e.g., data 911h may be the newly created Note Event that may result from subprocess 6618, while data 911g may be a Note Event that may be passed to subprocess 6615 for the first time (e.g., subprocess 6618 may receive both data 911g and data 911h Note Events and may process whatever Note Events it receives)), and may duplicate the Note Event 911g and modify its Delay 911ii data resulting in Note Event 911h data, which will be passed to subprocess Calculate Oscillator 6615. If it is determined at subprocess 6616 that the Note Event 911g should not be delayed, then no duplicates are created and subprocess 912 may end at operation 6617.

If it is determined at subprocess 6614 that the Note Event 911g is not associated with a Track Object 507 whose Instrument Object's Sample Type 510d is an Oscillator, then a subprocess Calculate Instrument Sample 6619 may initiate. As shown in FIG. 85, subprocess Calculate Instrument Sample 6619 may receive data 510, 906, and 910, and either data 911g, 911i, 911j, or 911k as input, and may create the instrument Audio Sample 512 Audio Source 801a, and Source Audio Chain 802, and may connect the Audio Source 801 to the Source Audio Chain 802, and may connect the Source Audio Chain 802 to its corresponding Track Audio Chain 803 and schedule it to play resulting in a Scheduled Audio Source 913.

After completing subprocess Calculate Instrument Sample 6619, if it is determined at a subprocess 6620 that the Note Event 911g should be sustained, then a subprocess Update Sustain Data 6621 may initiate. Subprocess Update Sustain Data 6621 may receive data 510, 906, 910, and 911g as input, and may duplicate the Note Event 911g and modify its Sustain data resulting in Note Event 911i data, which may be passed to subprocess Calculate Instrument Sample 6619. If it is determined at subprocess 6620 that the Note Event 911g should not be sustained, then no duplicates may be created and subprocess 912 may stop at operation 6626.

After completing subprocess Calculate Instrument Sample 6619 subprocess, if it is determined at a subprocess 6622 that the Note Event 911g should be delayed, then a subprocess Update Delay Data 6623 may initiate. Subprocess Update Delay Data 6623 may receive data 510, 906, 910, and 911g as input, and may duplicate the Note Event 911g and modify its Delay 911ii data resulting in Note Event 911j data, which may be passed to subprocess Calculate Instrument Sample 6619. If it is determined at subprocess 6622 that the Note Event 911g should not be delayed, then no duplicates may be created and subprocess 912 may stop at operation 6626.

After completing subprocess Calculate Instrument Sample 6619, if the Sample Pitch Type 510a is determined at a subprocess 6624 to be harmonic and the harmony is a suspended 4^{th} chord (e.g., a single sample of an instrument playing a suspended 4^{th} chord), then a subprocess Resolve Sus4 Sample 6625 may initiate. Subprocess Resolve Sus4 Sample 6625 may receive data 510, 906, 910, and 911g as input, and may duplicate the Note Event 911g and modify its Suspended 4^{th} data resulting in Note Event 911k data, which may be passed to subprocess Calculate Instrument Sample 6619. If the Sample Pitch Type 510a is not harmonic or it is determined at subprocess 6624 that the harmony is not a suspended 4^{th}, then no duplicates may be created and subprocess 912 may stop at operation 6626.

It is understood that the operations (e.g., subprocesses) shown in process 912 of FIG. 66 are only illustrative and that existing operations may be modified or omitted, additional operations may be added, and the order of certain operations may be altered.

### FIG. 67—Calculate Drum Sample 6602

Process Calculate Drum Sample 6602 may use Phrase Data 504 and Track Data 508 from the Song Object 501, Chord Duration Data 906, and Note Event 911 data, and may create an Audio Source 801a, a corresponding Source Audio Chain 802, and may connect the Audio Source 801 to the Source Audio Chain 802, and may connect the Source Audio Chain 802 to a Track Audio Chain 803. It may result in a Scheduled Audio Source 913. As shown in FIG. 67, a series of subprocesses may run within process Calculate Drum Sample 6602.

The Song Object 501, Chord Duration Data 906, and Note Event(s) 911 may be received as input from process Calculate Audio Data 912.

A subprocess Set Sample Gain 6701 may set the Audio Source 801 gain from the Note Event's Gain 911aa value, Track Gain 508d value, and Phrase Object's Drum Gain 504t value. Such data may be modified by a user through a GUI, such as GUI screen 11800 as shown in FIG. 118, where the “Drum Gain” slider may modify the Phrase Object's Drum Gain 504t value, and in screen GUI 12300 of FIG. 123, where the “Gain” slider may modify the Track Gain 508d value.

A subprocess Calculate Sample Reverb 6702 may set the Reverb Ratio from the Track Reverb 508gg value, and the Drum Reverb 504g. These values may be modified by a user through a GUI, such as GUI screen 11900 as shown in FIG. 119, where the “Reverb Diff” slider may modify the Reverb value of the Track Object 507 of Track Type 508b “drums”, and in GUI screen 11800 of FIG. 118, where the “Drum Reverb” slider may modify the Drum Reverb 504g. The Reverb Ratio may determine how much Gain is passed into the Wet and Dry audio paths in the corresponding Track Audio Chain 803.

If it is determined at a subprocess 6703 that a swell in adjustment is needed, then a subprocess Adjust Swell Data 6704 may initiate. Subprocess Adjust Swell Data 6704 may adjust the Audio Source Sample Offset and Start Time for a Swell In Sample, and may calculate the gain fade in from the Sample Offset.

If it is determined at subprocess 6703 that a swell in adjustment is not needed or subprocess Adjust Swell Data 6704 has completed, a subprocess Calculate Filter Frequencies 6705 may initiate. Subprocess Calculate Filter Frequencies 6705 may calculate Filter Frequencies for the Source Audio Chain 802 from the Track Filters 508jj data and the Drum Filter 504h data. Such data may be modified by a user through a GUI, such as GUI screen 12300 as shown in FIG. 123, where the “Filter” slider may modify the Track Filters 508jj data of Track Type 508b “drums”, and in GUI screen 11800 of FIG. 118, where the “Drum Filter” slider may modify the Drum Filter 504h.

After completing subprocess Calculate Filter Frequencies 6705, a subprocess Create Drum Source Audio Chain 6706 may initiate. Subprocess Create Drum Source Audio Chain 6706 may create a Source Audio Chain 802, which may include a chain of audio processes, which may include, but is not limited to, wet and dry audio paths for reverb, panning, filters, equalization (“EQ”), and/or the like.

After completing subprocess 6706, a subprocess Calculate Drum Sample Source 6707 may initiate. Subprocess 6707 may assign an Audio Sample 512 as an Audio Source 801a.

After completing subprocess 6707, a subprocess Connect to Source Audio Chain 6708 may connect the Audio Source 801 to the Source Audio Chain 802.

After completing subprocess 6708, a subprocess Connect to Track Audio Chain 6709 may connect the Source Audio Chain 802 to the Track Audio Chain 803.

After completing subprocess 6709, a subprocess Schedule Audio Source 6710 may schedule the Audio Sample 512 to play based off of the Note Event's Start Time 911bb.

It is understood that the operations (e.g., subprocesses) shown in process 6602 of FIG. 67 are only illustrative and that existing operations may be modified or omitted, additional operations may be added, and the order of certain operations may be altered.

### Adjust Swell Data 6704

A percussion Crash Audio Sample 512 may start with an initial attack, and continue as the amplitude of the sound decreases over time. For example, example 6800 of FIG. 68 illustrates the waveform of a percussion Crash Audio Sample 512 where the amplitude decreases over time. A percussion Swell Audio Sample 512 may start with a gentle tone, increase in amplitude, then finally come to a sudden stop. For example, example 6900 of FIG. 69 shows a waveform of a percussion Swell sample, where the amplitude increases over time. If the Swell 504k value is “true”, a percussion Swell Audio Sample 512 may be played to transition into the downbeat of the next Chord 604. If the Crash 504l value is “true”, a percussion Crash Audio Sample 512 may be played at the beginning of a Chord 604. These two Audio Samples 512 may be used or played contiguously to transition from one Chord 604 to the next Chord 604 as illustrated in example 7000 of FIG. 70. The Swell 504k and Crash 504l values may be modified by a user through a GUI, such as highlighted in GUI screen 11800 of FIG. 118 by controls 11805.

Subprocess Adjust Swell Data 6704 may calculate when the Swell Audio Sample 512 may start based on the Audio Sample 512 duration and the duration of the Chord 604 so that the end of the swell Audio Sample 512 synchronizes with the end of the Chord 604. For example, example 7100 of FIG. 71 illustrates a Swell Audio Sample 512 waveform over time compared with the duration of a Chord 604, where the Audio Sample 512 Start Time begins after the Chord 604 Start Time so that the Audio Sample 512 and the Chord 604 end at the same time. When the Audio Sample 512 duration is greater than the Chord 604 duration, subprocess Adjust Swell Data 6704 may apply an offset to the Audio Sample 512 so that the Audio Sample 512 will begin playing from the offset instead of the beginning of the sample. In this case, a Gain Fade In may also be added to the Source Audio Chain 802. For example, example 7200 of FIG. 72 illustrates a Swell Audio Sample 512 waveform over time compared with a Chord 604 of a shorter duration, where an offset is applied to the Swell Audio Sample 512 and a Gain Fade In is added to the Source Audio Chain 802.

### Sus4 Modification 6604

Subprocess Sus4 Modification 6604 may enable harmonic modifications to Note Event 911 data. These modifications may create suspended fourths and their resolutions to thirds. This may be based on the Sus4 504m value. This data may be modified by a user through a GUI, such as GUI screen 11800 as shown in FIG. 118, where the “Sus4” button may modify the Sus4 504m value.

In subprocess Sus4 Modification 6604, if a note's pitch is the third of a triad and it will play during the first half of a Chord 604's duration, then it may be transposed up to the fourth. If a note's pitch is the suspended fourth of a triad and it will play during the second half of a Chord 604's duration, then it may be transposed down to the third. For example, suppose in the key of C Major, the Chord is a G Major, and there are eight eighth notes on the B. If the Sus4 504m value is “true”, it may modify the first four notes so that the first half of the Chord may create a suspended fourth and the second half may be resolved. This is illustrated in example 7300 of FIG. 73, where notation 7301 shows the notes prior to being modified and where notation 7302 shows the notes after being modified.

In subprocess Sus4 Modification 6604, if a note's pitch is the third of a triad and the note is supposed to play for the duration of the entire Chord 604, then it's duration may be reduced by half, it may be transposed up to the fourth, and it may create a new Note Event 911 that is passed to subprocess Calculate Audio Data 912 to resolve the suspension. For example, suppose in the key of C Major, the Chord is a G Major, and there is a whole note on the B. If the Sus4 504m value is “true”, it may result in a half note on the C (the suspended fourth) and another half note resolved on the B (the third). This is illustrated in example 7400 of FIG. 74, where notation 7401 shows the note prior to being modified and where notation 7402 shows the notes after being modified.

### Calculate Note Duration 6607

A Note Event's Duration 911dd data may be calculated in subprocess Calculate Composition Data 908 within the context of a single Chord 604. Example 7500 of FIG. 75 is an illustrated representation of two Chords 604, where the horizontal distance represents time, and the duration of a single Chord 604 is compared with the duration of three notes which occur within the time of that Chord 604, also a single Sustained Note for each Chord 604 whose duration is equal to the duration of that Chord 604. In order to add cohesion and continuity between Chords 604, sustained notes may overlap from one Chord 604 to another. This is illustrated by example 7600 of FIG. 76 as compared with 7500, where the two Chords 604 are contiguous and the duration of Sustained Note is equal to the sum of the durations of both Chords 604. This may occur when the Overlap Chord 508hh value is “true”. This value may be modified by a user through a GUI, such as GUI screen 11900 as shown in FIG. 119, where the “Overlap” button may modify the Overlap Chord 508hh value.

Subprocess Calculate Note Duration 6607 may determine whether certain harmonic conditions are met, whereby an overlapping note will yield pleasing results. These harmonic conditions may include, but are not limited to, the following; 1) Harmony Type 508c is Chord Scale and the Note Event's Pitch 911cc value is found in the next Chord Scale, 2) Harmony Type 508c is not Chord Scale & the Note Event's Pitch 911cc value is found in the next Chord Triad, and 3) Harmony Type 508c is Pedal or Pedal Fifth. If the harmonic conditions are met and the Overlap Chord 508hh value is “true”, then subprocess Calculate Note Duration 6607 may extend the note duration to the end of the next Chord 604.

### Calculate Note Envelopes 6608

The Relative Envelope 508ii data may contain information regarding how an audio process automation may occur over time. A Relative Envelope 508ii may have multiple points, which may include, but are not limited to, Attack, Sustain, and Release. The Envelope 911ee Attack may be the amount of time that occurs for the first automation to complete from the minimum value to arrive at the maximum value. The Envelope 911ee Sustain may be the amount of time the maximum value stays constant. The Envelope 911ee Release may be the amount of time that occurs for the last automation from the maximum value to return to the minimum value. The Track Gain 508d, the Track Filters 508jj, and other Track Data 508 may have associated Relative Envelope 508ii data, which may be input as percentages. This data may be modified by a user through a GUI, such as GUI screen 11900 as shown in FIG. 119. Because this data may be based on percentages and not a fixed time, it may enable a Style Producer to craft the envelope behavior of a Track Object 507, but still allow note durations to vary depending on the Tempo 504a, the Quantization 508a, and other modifications of time. For example, compare example 7700 of FIG. 77 and example 7800 of FIG. 78, where the same Relative Envelope 508ii percentages are applied to notes with different durations, thereby yielding different absolute values for the Envelope's 508ii Attack, Sustain, and Release durations. Subprocess Calculate Note Envelopes 6608 may calculate the absolute durations of the Note Event's Envelope 911ee based on the Note Event's Duration 911cc data and the relative percentages of the Relative Envelope 508ii data. This may result in Note Event Envelope 911ee data for each parameter (e.g., Note Event Gain 911aa, Note Event Filter Frequency 911hh, and the like) as absolute durations of time. This data may be used later in a subprocess Create Source Audio Chain 8507 and this data may be modified by a subprocess Calculate Sample Set 8502 of FIG. 85.

### Calculate Swells 6611

Subprocess Calculate Swells 6611 may use the Track Object's Swell data (508kk, 508ll, 508mm) to modify Note Event 911d data, such as Gain 911aa, or Filter Frequency 911hh, and/or the like. The modification may gradually change the Note Event 911d data in a Track Object 507 over time forming a Swell in that parameter (e.g., a swell in the gain or a swell in filter frequency. For example, example 7900 of FIG. 79 shows a representation of the modification of the Note Event's Gain 911aa data over time, where each point may represent the Note Event's Gain 911aa value of an individual note within a Swell. A Swell may occur within the duration of a single Chord 604 or extend for the duration of multiple Chords 604. For example, example 8000 of FIG. 80 shows the swell of a Note Event's Gain 911aa data over a progression of four Chords 604, where the duration of the swell is equal to the duration of each Chord 604, and example 8100 of FIG. 81 shows the swell of a Note Event's Gain 911aa data over a progression of four Chords 604, where the duration of the swell spans the duration of four Chords 604. A Swell may have one of several Swell Pattern 508ll values. These patterns may include, but are not limited to, those illustrated in example 8200 of FIG. 82, where pattern 8201 illustrates a Swell Up pattern, pattern 8202 illustrates a Swell Down pattern, pattern 8203 illustrates a Ramp Up pattern, and pattern 8204 illustrates a Ramp Down pattern.

The effect of a Swell, or the amount of modification of a Swell, may be adjusted by the Swell Amount 508kk value. The swells may be calculated by subtracting from the original value of the parameter (e.g., Note Event's Gain 911aa or Note Event's Filter Frequency 911hh). A Swell Amount 508kk value of “100%” may reduce the Note Event's Gain 911aa value to zero or may reduce the Note Event's Filter Frequency 911hh value to the Filter Frequency Minimum 508nn value. Example 8300 of FIG. 83 shows three examples using the same Swell Pattern 508ll values and differing Swell Amount 508kk values, where pattern 8301 has a Swell Amount 508kk value of 100%, pattern 8302 has a Swell Amount 508kk value of 50%, and pattern 8303 has a Swell Amount 508kk value of 0%.

For Audio Samples 512 of Sample Type 510d “sustained”, where a single note plays for the duration of an entire Chord 604 or two Chords 604, a set of Swell Automation Nodes 911ff may be calculated for that Note Event 911. This data may be used later to set audio process automations, such as linearly increasing the gain in a Source Audio Chain 802. For example, example 8400 of FIG. 84 illustrates how Swell Automation Nodes 911ff could be related to a Sustained Note. The points represent the Swell Automation Nodes 911ff. The lines represent the continuous change in Gain 911aa value that results from audio process automations. Because Swell Automation Nodes 911ff may be part of the Note Event 911e data, Nodes may be calculated for multiple Note Events 911e to create a seamless continuation of a Swell that spans over multiple Chords 604 as shown in subexample 8402. Additionally, multiple Swell Automation Nodes 911ff may be calculated for a single Note Event 911e as illustrated in subexample 8401, where a single Sustained Note spans two Chords 604.

The Track Object's Swell data (508kk, 508ll, 508mm) and the Filter Frequency Minimum 508nn value may be modified by a user through a GUI, such as GUI screen 11900 of FIG. 119 where the “minimum” slider may modify the Filter Frequency Minimum 508nn value, and the highlighted section may modify the Track Object's Swell data (508kk, 508ll, 508mm).

### FIG. 85—Calculate Instrument Sample 6619

Subprocess Calculate Instrument Sample 6619 may use Phrase Data 504 and Track Data 508 from the Song Object 501, Chord Duration Data 906, Harmony Data 910, and Note Event data (911g, 911i, 911j, or 911k) and may create an Audio Source 801a, a corresponding Source Audio Chain 802, and may connect the Audio Source 801 to the Source Audio Chain 802, and may connect the Source Audio Chain 802 to a Track Audio Chain 803. It may result in a Scheduled Audio Source 913. FIG. 85 shows a series of subprocesses that may run within subprocess Calculate Instrument Sample 6619.

Harmony Data 910, Note Event data 911, and Song Object 501 data may be received as input from subprocess Calculate Audio Data 912.

If it is determined at a subprocess 8501 that the Instrument Object 509 has multiple Sample Sets 511, a subprocess Calculate Sample Set 8502 may initiate. Subprocess Calculate Sample Set 8502 may calculate the Sample Set 511 based on the Harmony Data 910. Therefore, if there are multiple sample sets, all that may change is subprocess 8502 may be executed during subprocess 6619. Sample Sets may be like sub-directories/sub-folders. Subprocess 6619 may have no self-repeating loops within an iteration of subprocess 6619, which may result in only one audio source. However, within the context of subprocess 912, subprocess 6619 may be repeated, and subprocess 912 may be run for every note event 911.

If it is determined at subprocess 8501 that the Instrument Object 509 does not have multiple Sample Sets 511, or subprocess Calculate Sample Set 8502 has completed, a subprocess Calculate Instrument Sample Source 8503 may initiate. Subprocess Calculate Instrument Sample Source 8503 may create and calculate the Audio Source 801 and its pitch tuning based on the Round Robin 508oo value and Sample Pitch Type 510a value.

After completing subprocess Calculate Instrument Sample Source 8503, a subprocess Humanize Pitch 8504 may apply randomization to the Audio Source 801 tuning based on the Humanize Pitch 508ff value. This data may be modified by a user through a GUI, such as GUI screen 11900 as shown in FIG. 119, where under the “Humanize” section the “Pitch” slider may modify the Humanize Pitch 508ff value.

If the Transition 508pp value is determined to be true at a subprocess 8505, a subprocess Calculate Transition Data 8506 may initiate. Subprocess Calculate Transition Data 8506 may calculate the Audio Source Sample Offset, Start Time, and Envelopes for the Transition Sample.

If the Transition 508pp value is determined not to be true at subprocess 8505, or subprocess Calculate Transition Data 8506 has completed, a subprocess Create Source Audio Chain 8507 may initiate. Subprocess Create Source Audio Chain 8507 may create the Source Audio Chain 802 and may calculate the audio processes in that chain.

After completing subprocess Create Source Audio Chain 8507, a subprocess Set Playback Rate 8508 may set the Audio Source playback rate based on the Playback Rate 508qq value. This data may be modified by a user through a GUI, such as GUI screen 11900 as shown in FIG. 119, where the “Playback Rate” input may modify the Playback Rate 508qq value.

After completing subprocess Set Playback Rate 8508, subprocess Connect to Source Audio Chain 6708 may connect the Audio Source 801 to the Source Audio Chain 802.

After completing subprocess Connect to Source Audio Chain 6708, subprocess Connect to Track Audio Chain 6709 may connect the Source Audio Chain 802 to the Track Audio Chain 803.

After completing subprocess Connect to Track Audio Chain 6709, subprocess Schedule Audio Source 6710 may schedule the Audio Sample 512 to play based off of the Note Event's Start Time 911bb.

It is understood that the operations (e.g., subprocesses) shown in process 6619 of FIG. 85 are only illustrative and that existing operations may be modified or omitted, additional operations may be added, and the order of certain operations may be altered.

### Calculate Sample Set 8502

Subprocess Calculate Sample Set 8502 may use Note Event data 911g, 911i, 911j, or 911k data, the Instrument Object's Sample Conditions 510b data, and Harmony Data 910 to calculate the Sample Set 511 for the Note Event (911g, 911i, 911j, or 911k) Audio Source 801a.

The Instrument Object's Sample Set 511 data may reference a Sample Set 511, which may be a set of Audio Sample(s) 512 that correspond with a range of pitches. An Audio Sample 512 in the Sample Set 511 may be selected as the Audio Source 801 for a Note Event 911. The Audio Sample 512 files may be named by MIDI Note Numbers. For example, FIG. 86 shows a table 8600 that illustrates a Sample Set 511 as the files are named.

The Audio Sample 512 with the Sample Set 511 may be determined based on the Note Event's Pitch 911cc data. For example, FIG. 87 shows a table 8700 that illustrates the corresponding pitches of a Sample Set 511, which may be compared with table 8600.

An Instrument Object 509 may have Sample Pitch Type 510a data that describes the pitch characteristics of the Audio Sample 512. For example, an Audio Sample 512 may represent a single pitch (e.g., see example 8800 of FIG. 88), a harmonic combination of pitches (e.g., see example 8900 of FIG. 89, or a melodic combination of pitches (e.g., example 9000 of FIG. 90). The Sample Pitch Type 510a values may include, but are not limited to, those heretofore described. The Sample Pitch Type 510a data may be modified by a user through a GUI, such as GUI screen 12000 as shown in FIG. 120 with “harmType” 12003 field.

An Instrument Object 509 whose Sample Pitch Type 510a value is “Single” may contain one Sample Set 511. When an Instrument Object 509 has a Sample Pitch Type 510a with multiple pitches, that instrument may have multiple Sample Sets 511, each Sample Set 511 may correspond with specified pitch combinations. For example, a strummed guitar instrument could have three Sample Sets 511 based on pitch combinations of chords; one for major chords, another for minor chords, and another for suspended 4 chords. This example is illustrated by the table 9100 in FIG. 91 where Set 1 is major, Set 2 is minor, and Set 3 is suspended. The note pitch (table columns) may correspond with the root of the chord, and the Sample Set 511 (table rows) may correspond with the pitch combination for either major, minor, or suspended 4 chords.

Instrument Objects 509 with multiple Sample Sets 511 may have Sample Set Conditions 510b data that describe the harmonic conditions in which each Sample Set 511 should be used. The Sample Set Conditions 510b along with the current Harmony Data 910 may be used to determine which Sample Set 511 to use. The following is an example of Sample Set Conditions 510b for an Instrument Object 509 with Audio Samples 512 of guitar chord strums: Condition for Sample Set 1: Play when the Harmony Data's Quality 910a value is Major; Condition for Sample Set 2: Play when the Harmony Data's Quality 910a value is Minor; and Condition for Sample Set 3: Play when Harmony Data's Quality 910a value is Suspended 4.

The following is an example of a Sample Set Conditions 510b for an Instrument Object 509 with Audio Samples 512 of a melodic voice singing: Condition for Sample Set 1: Play when the Harmony Data's Scale 910b contains a minor 2nd above the Note Event's Pitch 911cc; Condition for Sample Set 2: Play when the Harmony Data's Scale 910b contains a Major 2nd above the Note Event's Pitch 911cc; Condition for Sample Set 3: Play when the Harmony Data's Triad 910c contains a minor 3rd above the Note Event's Pitch 911cc. The Sample Set Conditions 510b data may be modified by a user through a GUI, such as GUI screen 12000 as shown in FIG. 120 with the “sampleConfig” field 12004. In the case of an Audio Sample 512 containing a melodic combination of pitches, there is also the time between the changes in pitch that may be factored into the processing. For example, an Audio Sample 512 of a voice singing two quarter notes of different pitches in sequence may be originally recorded at a tempo of 120 bpm. This information may be stored in the Instrument Data 510, which may be used as a reference for stretching the playback speed of the Audio Sample 512 to match tempos other than the original of the recording. One-shot Audio Samples 512, such as percussive, struck, and plucked instruments, typically sound natural and can be programmed to reproduce convincingly the sound of the instrument. However, using traditional Audio Sample players, it may be more difficult to reproduce the dynamic sound of instruments that move between pitches, such as a can be done with many instruments (e.g., voice, and many wind, and sting instruments). Achieving a good sound with multipitch melodic samples may typically require a lot of manual effort for finding and placing each sample. As a sample playback method, the combination of Sample Set Conditions 510b data, Harmony Data 910, and Tempo 504a may give users a way to use multipitch samples, which opens up new possibilities for workflow, usage, and creativity.

### Audio Samples 512

When a suspended 4 chord Audio Sample 512 is used that sustains for the duration of the chord (e.g., an Audio Sample 512 of an orchestra sustaining a suspended 4 chord), then the Note Event Envelope 911ee values may be divided in half so that it may only play the Audio Sample 512 for the first half of the chord. Then subprocess Calculate Instrument Sample 6619 may be called again with another Note Event 911k and instructions to resolve the Suspended 4 chord with either a major or minor chord, depending on the harmonic context. For example, suppose in the key of C Major, the Chord is a G Major, and there is a sustained G Major triad Audio Sample 512 as a whole note. If the Sus4 504m value were “true”, it would result in a half note of the G Sus4 Audio Sample 512 and another half note that resolved on the G Major sample. The first Audio Sample 512 would come from one Sample Set 511 and the second Audio Sample 512 would come from another Sample Set 511. The notation of this example is illustrated in example 9200 of FIG. 92 ref. 9200, where notation 9201 represents the notation of the Audio Sample 512 if the Sus4 504m value were “false”, and notation 9202 represents the notation of the sus4 Audio Sample 512 followed by the resolved Audio Sample 512 if the Sus4 504m value were “true”.

When diminished chords are allowed in harmonic minor scales, harmonic Audio Samples 512 that contain fifths may be transposed down. A ii° chord may become a bVII chord. This may allow the MMSP to avoid bloating the Audio Sample 512 library with Audio Samples 512 that are rarely used.

### Calculate Instrument Sample Source 8503

After the Sample Set 511 is selected in subprocess Calculate Sample Set 8502, subprocess Calculate Instrument Sample Source 8503 may calculate which Audio Sample 512 within that set may become the Audio Source 801 for the Note Event 911. When the Audio Samples 512 are first loaded into an Instrument Object 509, they may be organized as an array of Audio Buffers within the Instrument Object 509. The Audio Buffers in this array may be accessed by index, starting with 0. For example, FIG. 93 shows a table 9300 of the Indices and File Names of the Audio Samples 512 within a Sample Set 511 of an Instrument Object 509 with a Pitch Range 510c from 60 to 71 and indices from 0 to 11. Subprocess Calculate Instrument Sample Source 8503 may determine the desired Audio Buffer by calculating the index in the Instrument's audio buffer array based on the Pitch Range 510c data and the Note Event's Pitch 911cc data. For example, a Note Pitch 911cc of E4, MIDI Note Number 64, may be index 4 of an Instrument Object whose Pitch Range 510c is from 60 to 71. It may be index 14 of an Instrument Object whose Pitch Range c is from 50-71.

Some Instruments Objects 509 may have Transposing Sample Sets, which may be Sample Sets 511 that contain only one Audio Sample 512 each, which Audio Sample 512 may be transposed to represent different pitches. The playback rate of the Audio Sample 512 may be changed so that it is tuned up or down from the original pitch to match the desired pitch. This technique may be used to create a specific stylistic sound in certain music production styles, such as electronic music. For example, example 9400 of FIG. 94 shows a table 9401 representing the Sample Sets 511 of an Instrument Object 509. There are three different Transposing Sample Sets, each Sample Set 511 having a Melodic combination of two pitches with different intervals and also showing the notation and interval of each sample: Minor 2^{nd} 9402, major 2^{nd} 9403, and minor 3^{rd} 9404. When the Audio Source 801 is calculated for an Instrument Object 509 with a Transposing Sample Set, the playback rate may also be calculated to transpose the Audio Sample 512 to the desired pitch. The original pitch data for a Transposing Sample Set 511 may be modified by a user through a GUI, such as GUI screen 12000 as shown in FIG. 120 with the “singlePitch” field 12008.

For example: suppose the instrument example 9400 in FIG. 94 has these Sample Set Conditions 510b: Condition for Sample Set 1: Play when the Harmony Data's Scale 910b contains a minor 2nd above the Note Event's Pitch 911cc; Condition for Sample Set 2: Play when the Harmony Data's Scale 910b contains a major 2nd above the Note Event's Pitch 911cc; Condition for Sample Set 3: Play when the Harmony Data's Triad 910b contains a minor 3rd above the Note Event's Pitch 911cc. Suppose also that the current Harmony Data 910 has a Triad of C Major, and that the Note Event's Pitch 911cc is E4. The condition for Sample Set 3 would be met because the C Major Triad contains G4, which is a minor 3rd above the Note Event's Pitch 911cc, E4. Sample Set 3 would be selected in subprocess Calculate Sample Set 8502. The single C4 Audio Sample 512 in the Transposing Sample Set would be selected and transposed up to E4. This is illustrated in example 9500 of FIG. 95, where notation 9501 shows the notation of the original Audio Sample 512 and notation 9502 shows the notation of the transposed sample.

Information about device memory and device processing speed may be gathered when a user first runs the MMSP. This may be stored as Quality Settings data. The Quality Settings data may inform the MMSP about how much processing and memory can be used on the device. All of the Audio Samples 512 used in the MMSP may be available in various data compression configurations. Greater compression may reduce file size and decrease audio quality. Lower quality Audio Samples 512 may be used for devices with less processing power and less memory. Using less computing power may enable the audio to play more smoothly on devices with limited processing power. Additionally, the number of Audio Samples 512 may be decreased to reduce the computational needs of the MMSP on a particular device. Changing the playback rate of an Audio Sample 512 may enable it to be used for pitches other than its original pitch. The Quality Settings data may contain a Tuning Range value that represents the number of pitches for which each Audio Sample 512 can be used. For example, with a Tuning Range value of “5”, and an Audio Sample 512 of C4, MIDI Note Number 60 could be used for the following pitches [56, 57, 58, 59, 60]. This example is illustrated in the table 9600 shown in FIG. 96, where the File Name of “60.mp3” represents a single Audio Sample 512, which may be used for five different pitches and their corresponding MIDI numbers. Using this method, the MMSP may reduce the number of Audio Samples 512 that are loaded onto a device. For example, with a Tuning Range value of 5, and an Instrument Object's Pitch Range 510c from 51 to 70, instead of using all 20 Audio Samples 512, the following 4 Audio Samples 512 may only be needed [55, 60, 65,70]. This example is illustrated in the table 9700 shown in FIG. 97. With a greater Tuning Range, less Audio Samples 512 may be used. Devices with less computing power may use a higher Tuning Range, while devices with more computing power may use a Tuning Range value of 1, meaning they may load every sample. These Tuning Ranges may only be used for live playback. When an audio file is exported for download, it may use the highest quality Audio Samples 512, and it may load every sample.

Round-robin is an audio sampling technique that may avoid using the same Audio Sample 512 for repeated notes. Alternating Audio Samples 512 for repeated notes may help avoid an unnatural machine-gun-like sound, and may add more realism to the sound. In order to optimize the MMSP for devices with varying levels of computing capacity, the MMSP may use transposition to create the round-robin effect without the need for multiplying the number of Audio Samples 512. The Audio Samples 512 that are nearest in pitch may be transposed to be used as Round Robin Audio Samples 512. Each Track Object 507 may have a Round Robin 508oo value. If a Track Object 507 has a Round Robin 508oo value of “4”, then a maximum of 4 different Audio Samples 512 may be used for repeated Notes Events 911 with the same Pitch 911cc value. For example, example 9800 of FIG. 98 shows musical notation 9801 of four repeated D notes followed by four repeated F # notes within the same Chord 604, while a table 9802 shows the File Name of the Audio Sample 512 that would be used for each note, the pitch of that Sample, and the transposition that would be needed to produce the pitch notated above. This example shows how a Round Robin 508oo value of 4 could transpose Audio Samples 512 for repeated notes. As long as Note Events (911g, 911i, 911j, or 911k) with the same pitch occur within the same Chord 604, the Round Robin may take effect regardless of whether the pitches are repeated contiguously or not. For example, example 9900 of FIG. 99 shows the same Audio Sample 512 table 9802 information found in FIG. 98, however the four D notes and the four F # notes shown in the musical notation 9901 do not contiguously repeat. The lines connecting the notes to the table columns show which Audio Sample 512 would be used for each note. This Round Robin 508oo value may be modified by a user through a GUI, such as GUI screen 11900 as shown in FIG. 119, where the “Round Robin” slider may modify the Round Robin 508oo value. This method of using Round Robin Audio Samples 512 may be used when the Audio Samples 512 aren't being reduced as described previously.

### Calculate Transition Data 8506

Rhythm may be experienced and understood as sounds as they correspond with time. For many Audio Samples 512, the rhythm may be based on the start time of a sample. For example, example 10000 of FIG. 100 shows an illustration of the waveform of a piano sample. It begins when the piano hammer strikes the string, and continues as the string's vibration decreases over time. In order to determine when this Audio Sample 512 should be played to create a certain rhythm, the start time of the Audio Sample 512 may be the rhythmic sync point. If this Audio Sample 512 was reversed, it may start with a gentle tone, increase in loudness, then finally come to a sudden stop. A waveform of this is shown in example 10100 of FIG. 101. For this sample, its rhythmic application may be determined by its end time, rather than its start time. In many cases, sounds that swell in loudness may be used to transition into the next downbeat.

If the Downbeat 508rr value is “true”, subprocess Create Rhythm 1311 sets the beginning of the Audio Sample 512 to synchronize with the beginning of the Chord 604. If the Transition 508pp value is “true”, subprocess Calculate Transition Data 8506 may modify the Note Event's Start Time 911bb so that the end of the Audio Sample 512 may synchronize with the end of the Chord 604. For example, example 10200 of FIG. 102 shows a representation of an Audio Sample 512 waveform leading into a downbeat Audio Sample 512 waveform in relation to two contiguous Chords. The Downbeat 508rr value and Transition 508pp value may be modified by a user through a GUI, such as GUI screen 11900 as shown in FIG. 119, where the “Downbeat” button may modify the Downbeat 508rr value, and the “Transition” button may modify the Transition 508pp value.

Subprocess Calculate Transition Data 8506 may calculate when an Audio Sample 512 should start based on the Audio Sample 512 duration and the duration of the Chord 604 so that the end of the swell Audio Sample 512 synchronizes with the end of the Chord 604. For example, example 10300 of FIG. 103 illustrates an Audio Sample 512 waveform over time compared with the duration of a Chord 604, where the Audio Sample 512 Start Time begins after the Chord 604 Start Time so that the Audio Sample 512 and the Chord 604 end at the same time.

When the Audio Sample 512 duration is greater than the Chord 604 duration, subprocess Calculate Transition Data 8506 may apply an offset to the Audio Sample 512 so that the Audio Sample 512 may begin playing from the offset instead of the beginning of the sample. In this case, a Gain Fade In may also be added to the Source Audio Chain 802. For example, example 10400 of FIG. 104 illustrates a Swell Audio Sample 512 waveform over time compared with a Chord 604 of a shorter duration.

### Create Source Audio Chain 8507

Each Audio Source 801 may have multiple audio processes applied to it, which may include, but are not limited to, gain adjustments for Sustain Loops, Filter envelopes and swells, Gain envelopes and swells, and/or the like. Each audio process may receive audio data, may apply an audio process, and may then output modified audio data. The Source Audio Chain 802 may include a chain of one or more audio processes called nodes. For example, example 10500 of FIG. 105 shows a chain of audio processes or nodes in sequence. Subprocess Create Source Audio Chain 8507 may use Sustain Loop data. Subprocess Calculate Instrument Sample 6619 may calculate all automations and values for all nodes within a Source Audio Chain 802. When an Audio Sample 512 of Sample Type 510d “sustained” is less than the Duration 911cc of the Note Event (911g, 911i, 911j, or 911k) to which it belongs, then the Audio Sample 512 may be looped. In order to ensure a smooth loop, a dedicated Gain Audio process may be added to the Source Audio Chain 802. This may be the Sustain Gain Node. When an Audio Sample 512 is looped, a portion of the beginning and ending may be cropped off, as those may be more likely to contain starting or ending sounds different from the sustained sound in the middle. The cropping may be calculated in subprocess Calculate Instrument Sample 6619. Then, in subprocess Create Source Audio Chain 8507, a Gain automation may be applied to the Audio Sample 512 to create a smooth crossfade as the Audio Sample 512 loops. This is illustrated in example 10600 pf FIG. 106, where a single Note Event (911g, 911i, 911j, or 911k) has a Duration 911cc which is longer than the Audio Samples 512 used to create it. With these gain automations applied to each Source Audio Chain 802, it may produce the effect of a single continuous Audio Sample 512 as illustrated in example 10700 of FIG. 107 as compared with example 10600 of FIG. 106. An Instrument Object 509 may also contain Sample Type 510d data, which may indicate whether the Audio Sample 512 may be looped. For example, an Instrument Object 509 with a Sample Type 510d value of “sustained” may be looped. This data may be modified by a user through a GUI, such as GUI screen 12000 as shown in FIG. 120, where the field in “sampleType” field 12009 may modify the Sample Type 510d data.

Each Audio Source 801 may have gain and filter automation based on the Note Event's Envelope 911ee data. This data may be calculated in subprocess Calculate Note Envelopes 6608. The envelope data may describe how an audio process automation may occur over time. An Envelope 911ee may have multiple points, which may include, but are not limited to, attack, sustain, and release. The attack may be the amount of time that occurs for the first automation to complete from the minimum value to arrive at the maximum value. The sustain may be the amount of time the maximum value stays constant. The release may be the amount of time that occurs for the last automation from the maximum value to return to the minimum value. For example, FIGS. 108 and 109 show illustrations of a note Duration 911cc that is less than the Audio Sample 512 duration. Example 10800 of FIG. 108 shows a Relative Envelope 508ii applied to Gain with Attack, Sustain, and Release values that total to 100%, and therefore equal the total Duration 911cc of the Note Event (911g, 911i, 911j, or 911k). Example 10900 of FIG. 109 shows a Relative Envelope 508ii applied to Gain with Attack, Sustain, and Release values that total to 110%, and therefore exceed the total Duration 911cc of the Note Event (911g, 911i, 911j, or 911k) and use more of the Audio Sample. These illustrations include Relative Envelope 508ii data. If the total percent of the envelope is less than 100, then the Audio Source 801 may play shorter than the Note Event's Duration 911cc. If it is greater than 100, the Audio Source 801 may play longer than the Note Event's Duration 911cc. Relative Envelopes 508ii applied to Gain may always have a minimum value of 0, and the maximum value may be the normal Note Event's Gain 911aa value. Relative Envelopes 508ii applied to filters may have minimum and maximum values that are set by the Track Filters 508jj data (maximum value) and the Track Object's Filter Frequency Minimum 508nn data (minimum value).

Each Audio Source 801 may have gain and filter automation based on the Track Object's Swell data (508kk, 508ll, and 508mm) applied to the Track Gain 508d value and/or the Track Filters 508jj data. This data may be calculated in subprocess Calculate Swells 6611. Below are two examples of how these audio process automations may occur. Example 11000 of FIG. 110 shows a Note Event (911g, 911i, 911j, or 911k) that sustains over two Chords 604 and whose Gain 911aa swells for the duration of those two Chords 604. Example 11100 of FIG. 111 shows two notes that sustain for 1 Chord 604 each and whose Gain ramps up for the duration of two Chords 604.

### Update Sustain Data 6621

When an Audio Sample 512 of Sample Type 510d “sustained” is less than the Duration 911cc of the Note Event 911g to which it belongs, then the Audio Sample 512 may be looped. When an Audio Sample 512 is looped, a portion of the beginning and ending may be cropped, and a fade may be added to blend each loop. A Loop Start Time Offset 911gg may be calculated based on the Audio Sample 512 duration. This is illustrated in example 11200 of FIG. 112. Subprocess Update Sustain Data 6621 may update the Note Event's Loop Start Time Offset 911gg value, then may run subprocess Calculate Instrument Sample 6619 with the updated data to calculate the next Audio Sample 512 in the loop.

### Update Delay Data 6623

Subprocess Update Delay Data 6623 may use the Delay Time 508ss data and Delay Repeat 508tt data, and may modify the Note Event's Start Time 911bb value, Note Event's Gain 911aa data, and Note Event's Filter Frequency 911hh data. It may then pass this data back into subprocess Calculate Instrument Sample 6619 as a new Note Event 911j to calculate the next delay. With each repeat of the delay, the Note Event's Filter Frequency 911hh may decrease and the Note Event's Gain 911aa value may decrease as shown in example 11300 of FIG. 113. The Delay Time 508ss value and Delay Repeat 508tt value of the Track Object 507 may be modified by a user through a GUI, such as GUI screen 11900 of FIG. 119, where the “Delay Time” input may modify the Delay Time 508ss value, and the “Repeats” slider may modify the Track Object's Delay Repeat 508tt value.

### Resolve Sus4 Sample 6625

When a suspended 4 Note Event 911g sustains for the duration of the Chord 604 and the Sample Pitch Type 510a is harmonic, then the Note Event's Envelope 911ee values may be divided in half so that it may only play the Audio Sample 512 for the first half of the Chord 604 as illustrated in musical notation in example 11400 of FIG. 114, where notation 11401 illustrates the original Duration 911cc, and notation 11402 illustrates the modified Duration 911cc. Subprocess Resolve Sus4 Sample 6625 may create a new Note Event 911k with a Start Time 911bb that begins halfway through the Chord 604, and may modify the Note Event's Pitch 911cc data to resolve the Suspended 4 as shown in example 11500 of FIG. 115, where notation 11402 illustrates the modified duration and notation 11501 illustrates the resolved Suspended 4. It may then pass this new Note Event 911k back into subprocess Calculate Instrument Sample 6619.

### FIG. 116—Calculate Oscillator 6615

Subprocess Calculate Oscillator 6615 of process Calculate Audio Data 912 may use Phrase Data 504 and Track Data 508 from the Song Object 501, and Note Event (911g or 911h) data, and may create an Audio Source 801a, a corresponding Source Audio Chain 802, and may connect the Audio Source 801 to the Source Audio Chain 802, and may connect the Source Audio Chain 802 to a Track Audio Chain 803. It may result in a Scheduled Audio Source 913. As shown in FIG. 116, subprocesses may run within process Calculate Oscillator 6615.

Harmony Data 910, Note Event (911g or 911h) data, and Song Object 501 data may be received as input from process Calculate Audio Data 912 to subprocess 6615.

A subprocess Calculate Oscillator Source 11601 may create an Oscillator (as the Audio Source 801a) and may calculate the frequency based on the Note Event's Pitch 911cc and the Oscillator Type 508uu data. This data may be modified by a user through a GUI, such as GUI screen 12200 as shown in FIG. 122, where the “Set Oscillator Type” select may modify the Oscillator Type 508uu data.

After completing subprocess Calculate Oscillator Source 11601, subprocess Humanize Pitch 8504 may apply randomization to the Audio Source 801 tuning based on the Humanize Pitch 508ff value. This data may be modified by a user through a GUI, such as GUI screen 11900 as shown in FIG. 119, where under the “Humanize” section the “Pitch” slider may modify the Humanize Pitch 508ff value.

After completing subprocess Humanize Pitch 8504, subprocess Create Source Audio Chain 8507 may create the Source Audio Chain 802 and may calculate the audio processes in that chain.

After completing subprocess Create Source Audio Chain 8507, subprocess Connect to Source Audio Chain 6708 may connect the Audio Source 801 to the Source Audio Chain 802.

After completing subprocess Connect to Source Audio Chain 6708, subprocess Connect to Track Audio Chain 6709 may connect the Source Audio Chain 802 to the Track Audio Chain 803.

After completing subprocess Connect to Track Audio Chain 6709, subprocess Schedule Audio Source 6710 may schedule the Audio Source 801 to play based off of the Note Event's Start Time 911bb.

It is understood that the operations (e.g., subprocesses) shown in process 6615 of FIG. 116 are only illustrative and that existing operations may be modified or omitted, additional operations may be added, and the order of certain operations may be altered.

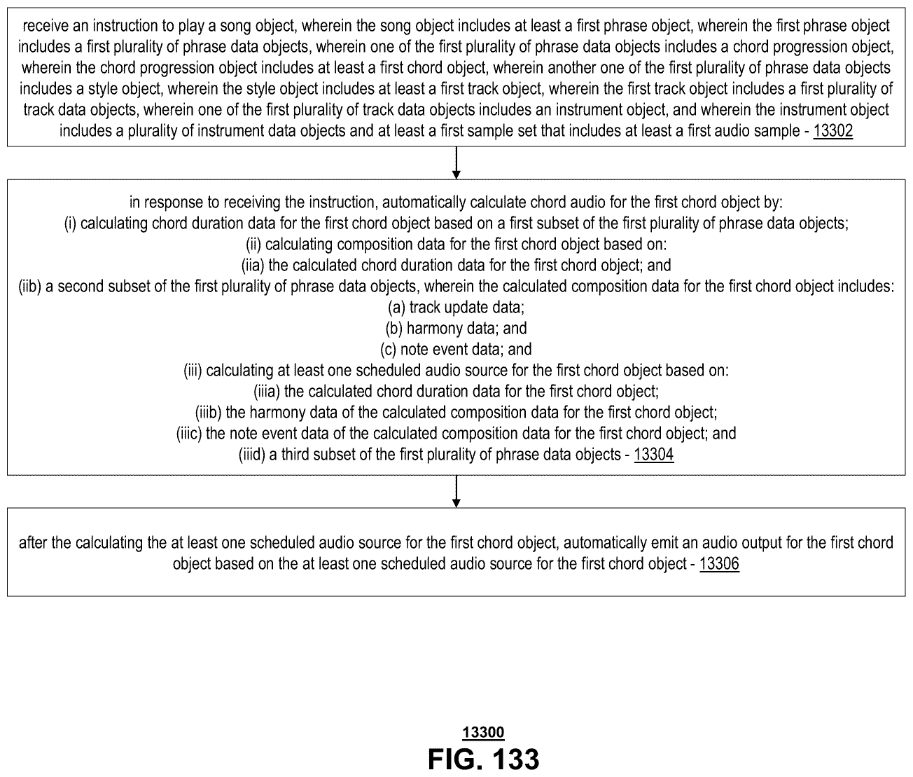

### FIG. 133—Song Object Processing 13300

FIG. 133 is a flowchart of an illustrative process 13300 for processing a song object. For example, process 13300 may be a computer-implemented method (e.g., process 605) for processing a song object (e.g., song object 501, song 601) using an electronic device (e.g., a subsystem 100), wherein the song object may include at least a first phrase object (e.g., phrase object 503, phrase 603), wherein the first phrase object may include a first plurality of phrase data objects (e.g., phrase data objects 504), wherein one of the first plurality of phrase data objects may include a chord progression object (e.g., object 504f), wherein the chord progression object may include at least a first chord object (e.g., object 504fi), wherein another one of the first plurality of phrase data objects may include a style object (e.g., object 505, object identified by object 504u), wherein the style object may include at least a first track object (e.g., object 507), wherein the first track object may include a first plurality of track data objects (e.g., objects 508), wherein one of the first plurality of track data objects may include an instrument object (e.g., object 509, object identified by object 508vv), and wherein the instrument object may include a plurality of instrument data objects (e.g., objects 510) and at least a first sample set (e.g., sample set 511) that may include at least a first audio sample (e.g., sample 512). Process 13300 may include an operation 13302, where the electronic device may receive (e.g., subprocess 601a) an instruction to play the song object (e.g., from a user via any suitable UI). Next, process 13300 may also include an operation 13304, where, in response to receiving the instruction, the electronic device may automatically calculate (e.g., process 605) chord audio (e.g., audio source(s) 913) for the first chord object by: (i) calculating (e.g., subprocess 901) chord duration data (e.g., data 906) for the first chord object based on a first subset of the first plurality of phrase data objects; (ii) calculating (e.g., subprocess 908) composition data for the first chord object based on: (iia) the calculated chord duration data for the first chord object; and (iib) a second subset of the first plurality of phrase data objects, wherein the calculated composition data for the first chord object includes: (a) track update data (e.g., data 909); (b) harmony data (e.g., data 910); and (c) note event data (e.g., data 911); and (iii) calculating (e.g., subprocess 912) at least one scheduled audio source (e.g., source 913) for the first chord object based on: (iiia) the calculated chord duration data for the first chord object; (iiib) the harmony data of the calculated composition data for the first chord object; (iiic) the note event data of the calculated composition data for the first chord object; and (iiid) a third subset of the first plurality of phrase data objects. Next, process 13300 may include an operation 13306, where, after the calculating the at least one scheduled audio source for the first chord object, the electronic device may automatically emit (e.g., subprocess 601a, audio destination 805) an audio output for the first chord object based on the at least one scheduled audio source for the first chord object. In some embodiments, the first subset of the first plurality of phrase data objects may include a tempo data object (e.g., data 504a), a harmonic speed data object (e.g., data 504b), and a harmonic rhythm data object (e.g., data 504c), and/or wherein the calculating the chord duration data for the first chord object may include calculating the number of beats in the first chord object and calculating the duration of a beat in the first chord object. In some embodiments, process 13300 may further include an operation where the electronic device may store the track update data of the calculated composition data for the first chord object for later use in automatically calculating (e.g., in process 605) chord audio (e.g., audio source(s) 913) for another chord object (e.g., object 504fi+1) of the song object. In some embodiments, the style object may include the first track object and a second track object, and the note event data of the calculated composition data for the first chord object may include at least a first note event associated with the first track object and at least a second note event associated with the second track object. In some embodiments, at least one scheduled audio source for the first chord object may include an instruction indicative of the first audio sample, an instruction indicative of a start time for playing back the first audio sample, an instruction indicative of a duration for playing back the first audio sample, and an instruction indicative of a pitch for playing back the first audio sample. In some embodiments, process 13300 may further include an operation where the electronic device may, during the calculating the chord audio for the first chord object, receive (e.g., at subprocess 605a) an instruction to modify at least a first phrase data object (e.g., at least one of data 504a-504w) of the first plurality of phrase data objects of the song object, and, in response to the receiving the instruction to modify, automatically modifying (e.g., at subprocess 605a) at least one value of the first phrase data object, wherein a portion of the calculating the chord audio for the first chord object is based on the modified first phrase data object.

It is understood that the operations (e.g., subprocesses) shown in process 13300 of FIG. 133 are only illustrative and that existing operations may be modified or omitted, additional operations may be added, and the order of certain operations may be altered.

### Further Discussion

Therefore, the MMSP may be configured to automate any suitable changes desired by any suitable user to any suitable portion(s) of a song. Various data types may be more likely to change or remain the same depending on the time unit. For example, tempo 504a, scale root 504e, scale quality 504d, pitch 504v, sus4 504m, swing 504w, and/or style object type 504u may be more likely to remain consistent throughout any given Song 601, and to change on a per Song 601 basis. Therefore, the MMSP may be configured to provide a song producer and/or a song modifier with any suitable controls to change one, some, or each of those phrase data types globally for an entire Song 601 (i.e., for every phrase within a song object 501). Harmonic speed 504b, harmonic rhythm 504c, chord progression 504f, drum reverb 504g, drum filter 504h, instrument reverb 504i, instrument filter 504j, drum rhythm speed 504o, drum extension 504p, drum set 504q, energy 504r, and/or drum gain 504t may be more likely to remain consistent throughout any given Section 602, and to change on a per Section 602 basis within a Song 601. Therefore, the MMSP may be configured to provide a song producer and/or a song modifier with any suitable controls to change one, some, or each of those phrase data types globally for an entire Section 602 within a Song 601 (i.e., for every phrase within a grouping of one or more phrases 603 in a section 602 of a song object 501). Drum rhythm data 504n, instrumentation 504s, swell 504k, and/or crash 504l may be more likely to remain consistent throughout any given Phrase 603, and to change on a per Phrase 603 basis within a Song 601. Therefore, the MMSP may be configured to provide a song producer and/or a song modifier with any suitable controls to change one, some, or each of those phrase data types globally for an entire Phrase 603 within a Song 601. In some embodiments, the MMSP may be configured to enable very particular changes to a single track of a completed song by a style producer or any other suitable user. For example, the MMSP may be configured to provide a style producer and/or any other suitable user with any suitable controls to change an instrument of a track (e.g., from a violin sound to an accordion sound) while retaining all other musical characteristics that may have been programmed for that track. Additionally or alternatively, the MMSP may be configured to provide a style producer and/or any other suitable user with any suitable controls to change any other track data parameters of a given track within a song. This may enable any variety of changes to a track's musical characteristics (e.g., to modify very specific thing(s) that may be more advanced features that a song modifier could use even if considered more appropriate for a style producer). The MMSP may be configured to enable a user to change very specific things about a song (e.g., anything in a complete song may be modified on a phrase level or chord level or globally for whatever reason (e.g., based on user reaction feedback)). This may provide particular utility with the MMSP for automatically manipulating part(s) or an entirety of a song. Particular examples of the MMSP may be found, for example, at https://soundsculpt.app/and/or https://producer.soundsculpt.app/songs.

One, some, or all of the processes described with respect to FIGS. 1-133 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., one or more memories and/or one or more data structures of one or more subsystems, devices, servers, computers, machines, or the like of FIGS. 1 and 2 (e.g., memory 113 of a subsystem)). In other embodiments, the computer-readable medium may be a transitory computer-readable medium. In such embodiments, the transitory computer-readable medium can be distributed over network-coupled computer systems so that the computer-readable code may be stored and executed in a distributed fashion. For example, such a computer-readable medium may be communicated from one subsystem to another directly or via any suitable network or bus or the like, such as from any one of the subsystems, devices, servers, computers, machines, or the like of FIGS. 1 and 2 to any other one of the subsystems, devices, servers, computers, machines, or the like of FIGS. 1 and 2 using any suitable communications protocol(s). Such a computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal. It is understood that the operations shown or described herein with respect to one, some, or all of the processes are only illustrative and that existing operations may be modified or omitted, additional operations may be added, and the order of certain operations may be altered with respect to a process.

It is to be understood that any, each, or at least one module or component or subsystem of the disclosure may be provided as a software construct, firmware construct, one or more hardware components, or a combination thereof. For example, any, each, or at least one module or component or subsystem of any one or more of the subsystems, devices, servers, computers, machines, or the like of FIGS. 1 and 2 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of any one or more of the subsystems, devices, servers, computers, machines, or the like of FIGS. 1 and 2 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

As used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” may mean displaying on or with an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein may refer to and encompass any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, processes, elements, and/or components, but do not preclude the presence or addition of one or more other features, integers, steps, operations, processes, elements, components, and/or groups thereof. When used in the claims, the term “or” is used as an inclusive or and not as an exclusive or. For example, the phrase “at least one of x, y, or z” means any one of x, y, and z, as well as any combination thereof.

The term “if” may, optionally, be construed to mean “when” or “upon” or “in response to determining” or “in response to detecting,” depending on the context. Similarly, the phrase “if it is determined” or “if [a stated condition or event] is detected” may, optionally, be construed to mean “upon determining” or “in response to determining” or “upon detecting [the stated condition or event]” or “in response to detecting [the stated condition or event],” depending on the context.

As used herein, the terms “computer,” “personal computer,” “device,” “computing device,” “router device,” and “controller device” may refer to any programmable computer system that is known or that will be developed in the future. In certain embodiments, a computer may be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As used herein, the terms “component,” “module,” and “system” may be intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

While there have been described systems, methods, and computer-readable media for a music management service, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Many alterations and modifications of the preferred embodiments will no doubt become apparent to a person of ordinary skill in the art after having read the foregoing description, it is to be understood that the particular embodiments shown and described by way of illustration are in no way intended to be considered limiting. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” and/or the like, may be used herein only for convenience, and that no fixed or absolute directional or orientational limitations are intended by the use of these terms. For example, components may have any desired orientation. If reoriented, different directional or orientational terms may need to be used in their description, but that will not alter their fundamental nature as within the scope and spirit of the disclosure. It is also to be understood that various types of musical notations used herein, such as modern staff notation, are used herein only for convenience, and that no specific limitations are intended by the use of these notations, as others, such as cipher notation, modified stave notation, and/or the like, including other notations now known or later devised, are possible (e.g., there are other forms of notation and the examples presented herein would not affect the functionality of the MMSP if presented with other notation forms).

Therefore, those skilled in the art will appreciate that the concepts can be practiced by other than the described embodiments, which are presented for purposes of illustration rather than of limitation.

What is claimed is:

1. A computer-implemented method for processing a song object using an electronic device, wherein the song object comprises at least a first phrase object, wherein the first phrase object comprises a first plurality of phrase data objects, wherein one of the first plurality of phrase data objects comprises a chord progression object, wherein the chord progression object comprises at least a first chord object, wherein another one of the first plurality of phrase data objects comprises a style object, wherein the style object comprises at least a first track object, wherein the first track object comprises a first plurality of track data objects, wherein one of the first plurality of track data objects comprises an instrument object, and wherein the instrument object comprises a plurality of instrument data objects and at least a first sample set that comprises at least a first audio sample, the method comprising:
receiving, with the electronic device, an instruction to play the song object;
in response to the receiving, automatically calculating, with the electronic device, chord audio for the first chord object, wherein the calculating the chord audio for the first chord object comprises:
calculating, with the electronic device, chord duration data for the first chord object based on a first subset of the first plurality of phrase data objects;
calculating, with the electronic device, composition data for the first chord object based on:
the calculated chord duration data for the first chord object; and
a second subset of the first plurality of phrase data objects, wherein the calculated composition data for the first chord object comprises:
track update data;
harmony data; and
note event data; and
calculating, with the electronic device, at least one scheduled audio source for the first chord object based on:
the calculated chord duration data for the first chord object;
the harmony data of the calculated composition data for the first chord object;
the note event data of the calculated composition data for the first chord object; and
a third subset of the first plurality of phrase data objects; and
after the calculating the at least one scheduled audio source for the first chord object, automatically emitting, with the electronic device, an audio output for the first chord object based on the at least one scheduled audio source for the first chord object.

2. The method of claim 1, wherein the first subset of the first plurality of phrase data objects comprises:
a tempo data object;
a harmonic speed data object; and
a harmonic rhythm data object.

3. The method of claim 2, wherein the calculating the chord duration data for the first chord object comprises:
calculating the number of beats in the first chord object; and
calculating the duration of a beat in the first chord object.

4. The method of claim 1, further comprising storing the track update data of the calculated composition data for the first chord object for later use in automatically calculating, with the electronic device, chord audio for another chord object of the song object.

5. The method of claim 1, wherein:
the style object comprises the first track object and a second track object; and
the note event data of the calculated composition data for the first chord object comprises:
at least a first note event associated with the first track object; and
at least a second note event associated with the second track object.

6. The method of claim 1, wherein the at least one scheduled audio source for the first chord object comprises:
an instruction indicative of the first audio sample;
an instruction indicative of a start time for playing back the first audio sample;
an instruction indicative of a duration for playing back the first audio sample; and
an instruction indicative of a pitch for playing back the first audio sample.

7. The method of claim 1, further comprising:
during the calculating the chord audio for the first chord object, receiving, with the electronic device, an instruction to modify at least a first phrase data object of the first plurality of phrase data objects of the song object; and
in response to the receiving the instruction to modify, automatically modifying, with the electronic device, at least one value of the first phrase data object, wherein:
a portion of the calculating the chord audio for the first chord object is based on the modified first phrase data object.

8. A non-transitory computer-readable storage medium storing at least one program comprising instructions, which, when executed in an electronic device, causes the electronic device to perform a method for processing a song object, wherein the song object comprises at least a first phrase object, wherein the first phrase object comprises a first plurality of phrase data objects, wherein one of the first plurality of phrase data objects comprises a chord progression object, wherein the chord progression object comprises at least a first chord object, wherein another one of the first plurality of phrase data objects comprises a style object, wherein the style object comprises at least a first track object, wherein the first track object comprises a first plurality of track data objects, wherein one of the first plurality of track data objects comprises an instrument object, and wherein the instrument object comprises a plurality of instrument data objects and at least a first sample set that comprises at least a first audio sample, the method comprising:
receiving an instruction to play the song object;
in response to the receiving, automatically calculating chord audio for the first chord object, wherein the calculating the chord audio for the first chord object comprises:
calculating chord duration data for the first chord object based on a first subset of the first plurality of phrase data objects;
calculating composition data for the first chord object based on:
the calculated chord duration data for the first chord object; and
a second subset of the first plurality of phrase data objects, wherein the calculated composition data for the first chord object comprises:
track update data;
harmony data; and
note event data; and
calculating at least one scheduled audio source for the first chord object based on:
the calculated chord duration data for the first chord object;
the harmony data of the calculated composition data for the first chord object;
the note event data of the calculated composition data for the first chord object; and
a third subset of the first plurality of phrase data objects; and
after the calculating the at least one scheduled audio source for the first chord object, automatically emitting an audio output for the first chord object based on the at least one scheduled audio source for the first chord object.

9. An electronic device comprising:
an input component;
an output component; and
a processor coupled to the input component and the output component, wherein the processor is operative to:
receive, via the input component, an instruction to play a song object, wherein:
the song object comprises at least a first phrase object;
the first phrase object comprises a first plurality of phrase data objects;
one of the first plurality of phrase data objects comprises a chord progression object;
the chord progression object comprises at least a first chord object;
another one of the first plurality of phrase data objects comprises a style object;
the style object comprises at least a first track object;
the first track object comprises a first plurality of track data objects;
one of the first plurality of track data objects comprises an instrument object; and
the instrument object comprises:
a plurality of instrument data objects; and
at least a first sample set that comprises at least a first audio sample;
automatically calculate, in response to receipt of the instruction to play the song object, chord audio for the first chord object by:
calculating chord duration data for the first chord object based on a first subset of the first plurality of phrase data objects;
calculating composition data for the first chord object based on:
the calculated chord duration data for the first chord object; and
a second subset of the first plurality of phrase data objects, wherein the calculated composition data for the first chord object comprises:
track update data;
harmony data; and
note event data; and
calculating at least one scheduled audio source for the first chord object based on:
the calculated chord duration data for the first chord object;
the harmony data of the calculated composition data for the first chord object;
the note event data of the calculated composition data for the first chord object; and
a third subset of the first plurality of phrase data objects; and
automatically emit, via the output component, an audio output for the first chord object based on the at least one scheduled audio source for the first chord object.
